(19) United States
(12) Patent Application Publication
(10) Pub. No.: US 2024/0284528 A1
(43) Pub. Date: Aug. 22, 2024

(54) SYSTEMS AND METHODS FOR A SIDELINK POSITIONING PROTOCOL

(71) Applicant: QUALCOMM Incorporated, San Diego, CA (US)

(72) Inventors: Sven FISCHER, Nuremberg (DE); Stephen William EDGE, Escondido, CA (US); Dan VASSILOVSKI, Del Mar, CA (US)

(21) Appl. No.: 18/442,608

(22) Filed: Feb. 15, 2024

Related U.S. Application Data
(60) Provisional application No. 63/485,378, filed on Feb. 16, 2023.
(60) Provisional application No. 63/494,721, filed on Apr. 6, 2023.
(60) Provisional application No. 63/501,664, filed on May 11, 2023.

(51) Int. Cl. H04W 76/11; H04L 5/00

(52) U.S. Cl. CPC H04W 76/11; H04L 5/0051

(57) ABSTRACT

Disclosed are techniques for sidelink positioning. In an aspect, an initiator user equipment (UE) transmits a first request to create a sidelink positioning protocol (SLPP) session to each recipient UE among a set of one or more recipient UEs, and receives first responses from the set of one or more recipient UEs that each indicate an acceptance or rejection of the SLPP session by the recipient. A group of one or more UEs for participation in the SLPP session is determined by the initiator UE from among recipient UEs from which a respective first response that indicates the acceptance of the SLPP session is received. In another aspect, a UE transmitting an SLPP message may indicate a first casting mode (e.g., unicast, groupcast, broadcast, etc.) of the SLPP message and may optionally indicate a second casting mode (e.g., unicast, groupcast, broadcast, etc.) for response(s) to the SLPP message.

### CROSS-REFERENCE TO RELATED APPLICATIONS

The present Application for Patent claims the benefit of U.S. Provisional Application No. 63/485,378, entitled “SIGNALING ASSOCIATED WITH SIDELINK POSITIONING PROTOCOL SESSION,” filed Feb. 16, 2023, U.S. Provisional Application No. 63/494,721, entitled “SIGNALING ASSOCIATED WITH SIDELINK POSITIONING PROTOCOL SESSION,” filed Apr. 6, 2023, U.S. Provisional Application No. 63/501,664, entitled “SIGNALING ASSOCIATED WITH SIDELINK POSITIONING PROTOCOL SESSION,” filed May 11, 2023, each of which is assigned to the assignee hereof, and expressly incorporated herein by reference in its entirety.

### BACKGROUND OF THE DISCLOSURE

### 1. Field of the Disclosure

The present disclosure relates generally to the field of wireless communications, and more specifically to determining the location of one or more User Equipments (UEs) using radio frequency (RF) signals transmitted between UEs based on sidelink (SL) communication.

### 2. Description of the Related Art

Wireless communication systems are widely deployed to provide various telecommunication services such as telephony, video, data, messaging, positioning, and broadcasts. Typical wireless communication systems may employ multiple-access technologies capable of supporting communication with multiple users by sharing available system resources (e.g., bandwidth, transmit power). Examples of such multiple-access systems include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems.

In some examples, a wireless multiple-access communication system may include a number of base stations, each simultaneously supporting communication for multiple communication devices, otherwise known as user equipment (UEs). A base station may communicate with a set of one or more UEs on downlink channels (e.g., for transmissions from a base station to a UE) and uplink channels (e.g., for transmissions from a UE to a base station). Additionally, UEs may communicate directly with each other using sidelink channels.

A location of a UE may be useful or essential to a number of applications including emergency calls, navigation, direction finding, asset tracking and Internet service. In a cellular network, for example, a base station may send downlink reference signals with which positioning measurements are obtained by a UE and/or the UE may send uplink reference signals with which positioning measurements are obtained by the base stations. The UE may compute an estimate of its own location using the positioning measurements in UE-based positioning or may send the positioning measurements to a network entity, e.g., location server, which may compute the UE location based on the positioning measurements in UE-assisted positioning.

There are a number of other applications where the location of one UE or of multiple UEs may be needed and where traditional UE-based positioning and UE-assisted positioning may be less useful. Examples of such other applications include Vehicle-to-everything (V2X) communication and coordination, Public Safety first responder scenarios and control and coordination of automated environments like factories and warehouses. In these applications, it may be more effective for UEs to communicate using sidelink signaling and for UEs to be located using sidelink related positioning measurements and/or sidelink related control signaling. Further, procedures may be established to enable two or more UEs to perform positioning (including ranging) using sidelink communications. However, many aspects of these sidelink-based procedures are not yet formalized.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating an initiator user equipment (UE) includes transmitting a first request to create a sidelink positioning protocol (SLPP) session to each recipient UE among a set of one or more recipient UEs; receiving a first response from each recipient UE of the set of one or more recipient UEs, wherein each first response indicates an acceptance or rejection of the SLPP session by the respective recipient UE; determining a group of one or more UEs for participation in the SLPP session from among recipient UEs from which a respective first response that indicates the acceptance of the SLPP session is received; transmitting a second request to start the SLPP session to the group of one or more UEs; and receiving a second response from each UE of the group of one or more UEs, wherein each second response acknowledges the second request.

In an aspect, a method of operating a recipient user equipment (UE) includes receiving a first request to create a sidelink positioning protocol (SLPP) session from an initiator UE; and transmitting a first response to the initiator UE indicates an acceptance or rejection of the SLPP session by the recipient UE.

In an aspect, a method of operating a user equipment (UE) includes determining a first casting mode associated with a sidelink positioning protocol (SLPP) message associated with a SLPP session; determining a second casting mode associated with one or more SLPP response messages to the SLPP message; and transmitting the SLPP message to a set of one or more UEs in accordance with the first casting mode, wherein the SLPP message comprises an indication of both the first casting mode and the second casting mode.

In an aspect, a method of operating a user equipment (UE) includes receiving a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and transmitting a SLPP response message in response to the SLPP message in accordance with the second casting mode.

In an aspect, an initiator user equipment (UE) includes one or more memories; one or more transceivers; and one or more processors communicatively coupled to the one or more memories and the one or more transceivers, the one or more processors, either alone or in combination, configured to: transmit, via the one or more transceivers, a first request to create a sidelink positioning protocol (SLPP) session to each recipient UE among a set of one or more recipient UEs; receive, via the one or more transceivers, a first response from each recipient UE of the set of one or more recipient UEs, wherein each first response indicates an acceptance or rejection of the SLPP session by the respective recipient UE; determine a group of one or more UEs for participation in the SLPP session from among recipient UEs from which a respective first response that indicates the acceptance of the SLPP session is received; transmit, via the one or more transceivers, a second request to start the SLPP session to the group of one or more UEs; and receive, via the one or more transceivers, a second response from each UE of the group of one or more UEs, wherein each second response acknowledges the second request.

In an aspect, a user equipment (UE) includes one or more memories; one or more transceivers; and one or more processors communicatively coupled to the one or more memories and the one or more transceivers, the one or more processors, either alone or in combination, configured to: receive, via the one or more transceivers, a first request to create a sidelink positioning protocol (SLPP) session from an initiator UE; and transmit, via the one or more transceivers, a first response to the initiator UE indicates an acceptance or rejection of the SLPP session by the recipient UE.

In an aspect, a user equipment (UE) includes one or more memories; one or more transceivers; and one or more processors communicatively coupled to the one or more memories and the one or more transceivers, the one or more processors, either alone or in combination, configured to: determine a first casting mode associated with a sidelink positioning protocol (SLPP) message associated with a SLPP session; determine a second casting mode associated with one or more SLPP response messages to the SLPP message; and transmit, via the one or more transceivers, the SLPP message to a set of one or more UEs in accordance with the first casting mode, wherein the SLPP message comprises an indication of both the first casting mode and the second casting mode.

In an aspect, a user equipment (UE) includes one or more memories; one or more transceivers; and one or more processors communicatively coupled to the one or more memories and the one or more transceivers, the one or more processors, either alone or in combination, configured to: receive, via the one or more transceivers, a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and transmit, via the one or more transceivers, a SLPP response message in response to the SLPP message in accordance with the second casting mode.

In an aspect, an initiator user equipment (UE) includes means for transmitting a first request to create a sidelink positioning protocol (SLPP) session to each recipient UE among a set of one or more recipient UEs; means for receiving a first response from each recipient UE of the set of one or more recipient UEs, wherein each first response indicates an acceptance or rejection of the SLPP session by the respective recipient UE; means for determining a group of one or more UEs for participation in the SLPP session from among recipient UEs from which a respective first response that indicates the acceptance of the SLPP session is received; means for transmitting a second request to start the SLPP session to the group of one or more UEs; and means for receiving a second response from each UE of the group of one or more UEs, wherein each second response acknowledges the second request.

In an aspect, a user equipment (UE) includes means for receiving a first request to create a sidelink positioning protocol (SLPP) session from an initiator UE; and means for transmitting a first response to the initiator UE indicates an acceptance or rejection of the SLPP session by the recipient UE.

In an aspect, a user equipment (UE) includes means for determining a first casting mode associated with a sidelink positioning protocol (SLPP) message associated with a SLPP session; means for determining a second casting mode associated with one or more SLPP response messages to the SLPP message; and means for transmitting the SLPP message to a set of one or more UEs in accordance with the first casting mode, wherein the SLPP message comprises an indication of both the first casting mode and the second casting mode.

In an aspect, a user equipment (UE) includes means for receiving a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and means for transmitting a SLPP response message in response to the SLPP message in accordance with the second casting mode.

In an aspect, a non-transitory computer-readable medium storing computer-executable instructions that, when executed by an initiator user equipment (UE), cause the initiator UE to: transmit a first request to create a sidelink positioning protocol (SLPP) session to each recipient UE among a set of one or more recipient UEs; receive a first response from each recipient UE of the set of one or more recipient UEs, wherein each first response indicates an acceptance or rejection of the SLPP session by the respective recipient UE; determine a group of one or more UEs for participation in the SLPP session from among recipient UEs from which a respective first response that indicates the acceptance of the SLPP session is received; transmit a second request to start the SLPP session to the group of one or more UEs; and receive a second response from each UE of the group of one or more UEs, wherein each second response acknowledges the second request.

In an aspect, a non-transitory computer-readable medium storing computer-executable instructions that, when executed by a user equipment (UE), cause the UE to: receive a first request to create a sidelink positioning protocol (SLPP) session from an initiator UE; and transmit a first response to the initiator UE indicates an acceptance or rejection of the SLPP session by the recipient UE.

In an aspect, a non-transitory computer-readable medium storing computer-executable instructions that, when executed by a user equipment (UE), cause the UE to: determine a first casting mode associated with a sidelink positioning protocol (SLPP) message associated with a SLPP session; determine a second casting mode associated with one or more SLPP response messages to the SLPP message; and transmit the SLPP message to a set of one or more UEs in accordance with the first casting mode, wherein the SLPP message comprises an indication of both the first casting mode and the second casting mode.

In an aspect, a non-transitory computer-readable medium storing computer-executable instructions that, when executed by a user equipment (UE), cause the UE to: receive a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and transmit a SLPP response message in response to the SLPP message in accordance with the second casting mode.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 shows an architecture of a communication system including a number of UEs, a Radio Access Network (RAN), and a 5G Core Network (5GC).

FIG. 2 shows an architecture of a communication system for network-supported sidelink positioning.

FIGS. 3A and 3B illustrate various scenarios of interest for sidelink-only or joint Uu and sidelink positioning, according to aspects of the disclosure.

FIG. 4 illustrates a reference architecture for Sidelink Positioning and Ranging-based services for non-roaming and same PLMN operation.

FIG. 5 illustrates UE Positioning Overall Architecture applicable to NG-RAN, in accordance with aspects of the disclosure.

FIG. 6 illustrates SLPP protocol layering over PC5 reference point.

FIG. 7 illustrates a SLPP Non-IP type encoding scheme.

FIGS. 8A-8C illustrate Sidelink Positioning/Ranging example scenarios, in accordance with aspects of the disclosure.

FIG. 9 illustrates a SLPP Session establishment procedure, in accordance with aspects of the disclosure.

FIG. 10 illustrates a SLPP Session modification Procedure, in accordance with aspects of the disclosure.

FIG. 11 illustrates Sidelink Positioning Session-less operation, in accordance with aspects of the disclosure.

FIG. 12 illustrates SLPP session-less operation, in accordance with aspects of the disclosure.

FIG. 13 illustrates Sidelink-only Positioning with UE-assisted Initiator (centralized) position calculation for multiple target UEs, in accordance with aspects of the disclosure.

FIG. 14 illustrates Sidelink-only Positioning with UE-based (distributed) position calculation by multiple target UEs, in accordance with aspects of the disclosure.

FIG. 15 illustrates a LMF-assisted Sidelink positioning (MO-LR) procedure, in accordance with aspects of the disclosure.

FIG. 16 illustrates a LMF-initiated Sidelink positioning for an MT-LR procedure, in accordance with aspects of the disclosure.

FIG. 17 illustrates a Joint Uu-Sidelink Positioning, in accordance with aspects of the disclosure.

FIG. 18 illustrates a SLPP Unicast Transaction, in accordance with aspects of the disclosure.

FIG. 19 illustrates a SLPP Group Transaction with Group Replies, in accordance with aspects of the disclosure.

FIG. 20 illustrates a SLPP Group Transaction with Unicast Replies, in accordance with aspects of the disclosure.

FIG. 21 illustrates a SLPP Broadcast Transaction, in accordance with aspects of the disclosure.

FIG. 22 illustrates a SLPP Capability Transfer Procedure, in accordance with aspects of the disclosure.

FIG. 23 illustrates a SLPP Capability Indication Procedure, in accordance with aspects of the disclosure.

FIG. 24 illustrates a SLPP Assistance Data Transfer Procedure, in accordance with aspects of the disclosure.

FIG. 25 illustrates a SLPP Assistance Data Delivery Procedure, in accordance with aspects of the disclosure.

FIG. 26 illustrates a SLPP Location Information Transfer Procedure, in accordance with aspects of the disclosure.

FIG. 27 illustrates a SLPP Location Information Delivery Procedure, in accordance with aspects of the disclosure.

FIG. 28 illustrates a SLPP Create Session Request/Accept/Reject procedure, in accordance with aspects of the disclosure.

FIG. 29 illustrates a SLPP Session Start Request/Response procedure, in accordance with aspects of the disclosure.

FIG. 30 illustrates a SLPP Session Start Request/Response procedure, in accordance with aspects of the disclosure.

FIG. 31 illustrates a SLPP Session Start Request/Response procedure, in accordance with aspects of the disclosure.

FIG. 32 illustrates a UE-assisted (centralized) Sidelink-only Positioning procedure for a Single Target UE, in accordance with aspects of the disclosure.

FIG. 33 illustrates a UE-assisted (centralized) Sidelink-only Positioning—Multiple Target UEs procedure, in accordance with aspects of the disclosure.

FIG. 34 illustrates a UE-assisted (centralized) Sidelink-only Ranging procedure for a single target UE, in accordance with aspects of the disclosure.

FIG. 35 illustrates a UE-assisted (centralized) Sidelink-only Ranging procedure for multiple target UEs, in accordance with aspects of the disclosure.

FIG. 36 illustrates a UE-based (distributed) Sidelink-only Positioning—Single Target UE procedure, in accordance with aspects of the disclosure.

FIG. 37 illustrates a UE-based (distributed) Sidelink-only Positioning—Multiple Target UEs procedure, in accordance with aspects of the disclosure.

FIG. 38 illustrates a UE-based (distributed) Sidelink-only Ranging procedure for a single target UE, in accordance with aspects of the disclosure.

FIG. 39 illustrates a UE-based (distributed) Sidelink-only Ranging procedure for multiple target UEs, in accordance with aspects of the disclosure.

FIGS. 40A, 40B, and 40C are simplified block diagrams of several sample aspects of components that may be employed in a user equipment (UE), a base station, and a network entity, respectively, and configured to support communications as taught herein.

FIG. 41 illustrates an exemplary process of communications according to an aspect of the disclosure.

FIG. 42 illustrates an exemplary process of communications according to an aspect of the disclosure.

FIG. 43 illustrates an exemplary process of communications according to an aspect of the disclosure.

FIG. 44 illustrates an exemplary process of communications according to an aspect of the disclosure.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Techniques and apparatus are discussed herein for supporting sidelink positioning (SL) between UEs. A Sidelink positioning protocol (SLPP) may be used for supporting sidelink positioning of UEs in pairwise positioning (referred to as pairwise mode), group operation (referred to as group mode), as well as network-supported SLPP.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

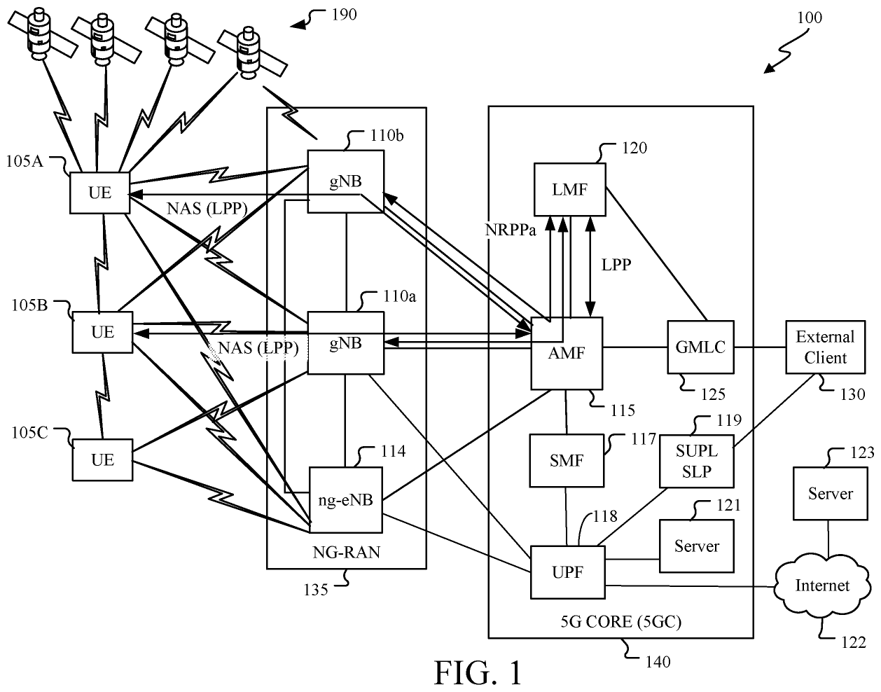

FIG. 1 shows an example of a communication system 100 that includes a first UE 105A, a second UE 105B, a third UE 105C, a Radio Access Network (RAN) 135, here a Fifth Generation (5G) Next Generation (NG) RAN (NG-RAN), and a 5G Core Network (5GC) 140. The 5GC 140, for example, may be a public land mobile network (PLMN). The UEs 105A, 105B and 105C may be sometimes referred to herein as UE 105 individually or UEs 105 collectively. The UE 105 may be, e.g., an IoT device, a location tracker device, a cellular telephone, a vehicle, an On-Board Unit (OBU), or other similar type of device. The UE 105 may additionally be considered an RSU or PRU. A 5G network may also be referred to as a New Radio (NR) network; NG-RAN 135 may be referred to as a 5G RAN or as an NR RAN; and 5GC 140 may be referred to as an NG Core network (NGC). The RAN 135 may be another type of RAN, e.g., a 3G RAN, a 4G Long Term Evolution (LTE) RAN, etc. The communication system 100 may utilize a constellation of space vehicles (SVs) 190 which may support a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). In some embodiments, a UE 105 may communicate via an SV 190 and an Earth station (not shown in FIG. 1) with a RAN node (e.g. a gNB 110) or a 5GC 140 node, in which case the UE 105 may not communicate directly with a RAN node but only via the SV 190. This may be used to increase the coverage and/or the capacity of the NG-RAN 135. Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125, a User Plane Function (UPF) 118, and a Secure User Plane Location (SUPL) Location Platform (SLP) 119. The gNBs 110a, 110b and the ng-eNB 114 are communicatively coupled to each other, are each configured wirelessly to communicate bi-directionally with the UEs 105, and are each communicatively coupled to, and configured to bi-directionally communicate with, the AMF 115 and the UPF 118. The gNBs 110a, 110b, and the ng-eNB 114 may be referred to as base stations (BSs) or RAN nodes. The AMF 115, the SMF 117, the LMF 120, and the GMLC 125 are communicatively coupled to each other, and the GMLC 125 is communicatively coupled to an external client 130. The AMF 115, the SMF 117, the UPF 118, and the SLP 119 are communicatively coupled to each other, and the SLP 119 is communicatively coupled to the external client 130. Server 121, the Internet 122, and server 123 may be communicatively coupled with the UPF 118 and may facilitate SL positioning, according to some embodiments. The SMF 117 may further serve as an initial contact point of a Service Control Function (SCF) (not shown) to create, control, and delete media sessions. The base stations 110a, 110b, 114 may be a macro cell (e.g., a high-power cellular base station), or a small cell (e.g., a low-power cellular base station), or an access point (e.g., a short-range base station configured to communicate with short-range technology such as WI-FI, WI-FI DIRECT (Wi-Fi D), BLUETOOTH, Bluetooth-Low Energy (BLE), ZIGBEE, etc. One or more of the base stations 110a, 110b, 114 may be configured to communicate with the UEs 105 via multiple carriers. Each of the base stations 110a, 110b, 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted, as necessary. Specifically, although only UEs 105 are illustrated, many UEs (e.g., hundreds, thousands, millions, etc.) may be utilized in the communication system 100. Similarly, the communication system 100 may include a larger (or smaller) number of SVs (i.e., more or fewer than the four SVs 190 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network. Similar network implementations and configurations may be used for other communication technologies, such as 3G, Long Term Evolution (LTE), future 6G, etc. Implementations described herein (be they for 5G technology and/or for one or more other communication technologies and/or protocols) may be used to transmit (or broadcast) directional synchronization signals, receive and measure directional signals at UEs (e.g., the UEs 105) or at base stations 110a, 110b, 114 and/or provide location assistance to the UEs 105 (via the LMF 120 or SLP 119 or other location server) and/or compute a location for one or both of the UEs 105 at a location-capable device such as the UEs 105, the base stations 110a, 110b, the LMF 120, or SLP 119 based on measurement quantities received at the UEs 105 or the base stations 110a, 110b, 114 for such directionally-transmitted signals. The GMLC 125, the LMF 120, the AMF 115, the SMF 117, the UPF 118, the SLP 119, the ng-eNB (eNodeB) 114 and the gNBs (gNodeBs) 110a, 110b are examples and may, in various embodiments, be replaced by or include various other entities, including location server functionality and/or base station functionality.

The communication system 100 is capable of wireless communication in that components of the system 100 can communicate with one another (at least sometimes using wireless connections) directly or indirectly, e.g., via the base stations 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UEs 105 may include multiple UEs and may be a mobile wireless communication device but may communicate wirelessly and via wired connections. The UEs 105 may be any of a variety of devices, e.g., a smartphone, a tablet computer, a vehicle-based device, etc., but these are examples only as the UEs 105 is not required to be any of these configurations, and other configurations of UEs may be used. Other UEs may include wearable devices (e.g., smart watches, smart jewelry, smart glasses, or headsets, etc.). Still other UEs may be used, whether currently existing or developed in the future. Further, other wireless devices (whether mobile or not) may be implemented within the system 100 and may communicate with each other and/or with the UEs 105, the base stations 110a, 110b, 114, the core network 140, and/or the external client 130. For example, such other devices may include IoT or IIOT devices, medical devices, home entertainment and/or automation devices, etc. The core network 140 may communicate with the external client 130, the server 123 or the server 121 (e.g., which may each be a computer system), e.g., to allow the external client 130, the server 123 or the server 121 to request and/or receive location information regarding the UEs 105 (e.g., via the GMLC 125, SLP 119 or UPF 118).

The UEs 105 or other devices may be configured to communicate in various networks and/or for various purposes and/or using various technologies (e.g., 5G, Wi-Fi (also referred to as WiFi) communication, multiple frequencies of Wi-Fi communication, satellite positioning, satellite communication, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or Wi-Fi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105 may communicate with each other through UE-to-UE sidelink (SL) communications by transmitting over one or more sidelink channels, such as a physical sidelink synchronization channel (PSSCH), a physical sidelink broadcast channel (PSBCH), a physical sidelink control channel (PSCCH), Synchronization Signal Block (SSB), sidelink channel state information reference signal (SL-CSIRS), physical sidelink feedback channel (PSFCH), sidelink positioning reference signals (SL PRS) or sidelink sounding reference signals (SL-SRS).

The UEs 105 may comprise and/or may be referred to as a device, a mobile device, a wireless device, a mobile terminal, a terminal, a mobile station (MS), a Secure User Plane Location (SUPL) Enabled Terminal (SET), or by some other name. Typically, though not necessarily, the UEs 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 Wi-Fi (also referred to as WiFi), Bluetooth (BT), Worldwide Interoperability for Microwave Access (WiMAX), 5G new radio (NR) (e.g., using the NG-RAN 135 and the 5GC 140), future 6G, etc. The UEs 105 may support wireless communication using a Wireless Local Area Network (WLAN) which may connect to other networks (e.g., the Internet) using a Digital Subscriber Line (DSL) or packet cable, for example. The use of one or more of these RATs may allow the UEs 105 to communicate with the external client 130, the server 121 and/or the server 123 (e.g., via elements of the 5GC 140 and possibly the Internet 122) and/or allow the external client 130, the server 121 and/or the server 123 to receive location related information regarding the UEs 105 (e.g., via the GMLC 125, SLP 119 or UPF 118).

Each of the UEs 105 may include a single entity or may include multiple entities such as in a personal area network where a user may employ audio, video and/or data I/O (input/output) devices and/or body sensors and a separate wireline or wireless modem. An estimate of a location of a UE, e.g., UE 105, may be referred to as a location, location estimate, location fix, fix, position, position estimate, or position fix, and may be geodetic, thus providing location coordinates for the UE (e.g., latitude and longitude) which may or may not include an altitude component (e.g., height above sea level, height above or depth below ground level, floor level, or basement level). Alternatively, a location of the UE may be expressed as a civic location (e.g., as a postal address or the designation of some point or small area in a building such as a particular room or floor). A location of the UE may be expressed as an area or volume (defined either geodetically or in civic form) within which the UE is expected to be located with some probability or confidence level (e.g., 67%, 95%, etc.). A location of the UE may be expressed as a relative location comprising, for example, a distance and direction from a known location. The relative location may be expressed as relative coordinates (e.g., X, Y (and Z) coordinates) defined relative to some origin at a known location which may be defined, e.g., geodetically, in civic terms, or by reference to a point, area, or volume, e.g., indicated on a map, floor plan, or building plan. In the description contained herein, the use of the term location may comprise any of these variants unless indicated otherwise.

When sidelink positioning is used, an absolute (e.g. global) or relative location of a UE may not always be obtained. Instead, location results may be obtained for a UE which may include a range or distance between the UE and each of one or more other UEs, a direction from the UE to each of one or more other UEs, a location of the UE relative to the location of some other UE, a location of one or more other UEs relative to the location of the UE, a velocity of the UE, and/or a velocity of each of one or more other UEs. A velocity of a UE may be absolute (e.g. relative to the Earth) or may be relative to some other UE, and may then be referred to as a “relative velocity”. A relative velocity of a UE B relative to another UE A may include a “radial velocity” component, which may be equal to a rate of change of a range from the UE A to the UE B, and a “transverse velocity” component which may be at right angles to the radial velocity component as seen by the UE A and may be equal to a rate of angular change of a direction to the UE B from the UE A multiplied by the range from the UE A to the UE B. In the description contained herein, the use of the term “location result” or “location results” for sidelink positioning of a UE or a group of one or more UEs may comprise any of these variants unless indicated otherwise.

The term “target UE” as used herein may refer to a UE for which location results are desired. When a group of two or more UEs participate in SL positioning, only some of the group of one or more UEs may be target UEs as location results may already be known or may not be needed for the other UEs. However, for generality, when discussing the techniques described herein for positioning of a group of one or more UEs, all of the UEs can be considered to be potentially target UEs, as there may be little or no difference in how the techniques described herein are used for the positioning.

The UEs 105 may be configured to communicate with other entities using one or more of a variety of technologies. The UEs 105 may be configured to communicate with one or more other UEs (e.g. other UEs 105) via one or more device-to-device (D2D) peer-to-peer (P2P) links. The D2D P2P links may be an example of (or may be supported by) sidelink signaling and be supported with any appropriate D2D radio access technology (RAT), such as LTE Direct (LTE-D), Wi-Fi Direct (Wi-Fi D), Bluetooth, and so on. One or more of a group of one or more UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of one or more UEs utilizing D2D communications may be within a geographic coverage area of a TRP. Other UEs in such a group may be outside such geographic coverage areas or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UEs 105 via wireless communication between the UEs and one or more of the gNBs 110a, 110b, which may provide wireless communications access to the 5GC 140 on behalf of the UE using 5G. In FIG. 1, the serving gNB for the UE 105A is assumed to be the gNB 110b, while the serving gNB for the UE 105B is assumed to be the gNB 110a, although another gNB may act as a serving gNB if the UEs 105 move to another location or may act as a secondary gNB to provide additional throughput and bandwidth to the UEs 105 and the UEs 105 may share the same serving gNB.

Base stations (BSs) in the NG-RAN 135 shown in FIG. 1 may include the ng-cNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UEs 105. One or more of the gNBs 110a, 110b and/or the ng-eNB 114 may be configured to function as positioning-only beacons which may transmit signals to assist with determining the position of the UEs 105 but may not receive signals from the UEs 105 or from other UEs.

The base stations 110a, 110b, 114 may transmit one or more downlink reference signals, including a positioning reference signal (PRS) transmission. The PRS transmission may be configured for a specific UEs 105 to measure and report one or more report parameters (for example, report quantities) associated with positioning and location information. The PRS transmission and report parameter feedback may support various location services (for example, navigation systems and emergency communications). In some examples, the report parameters supplement one or more additional location systems supported by the UE 105 (such as global positioning system (GPS) technology).

A base station 110a, 110b, 114 may configure a PRS transmission on one or more PRS resources of a channel. A PRS resource may span resource elements of multiple physical resource blocks (PRBs) within one or more OFDM symbols of a slot depending on a configured number of ports. For example, a PRS resource may span one symbol of a slot and contain one port for transmission. In any OFDM symbol, the PRS resources may occupy consecutive PRBs. In some examples, the PRS transmission may be mapped to consecutive OFDM symbols of the slot. In other examples, the PRS transmission may be mapped to interspersed OFDM symbols of the slot. Additionally, the PRS transmission may support frequency hopping within PRBs of the channel.

The one or more PRS resources may span a number of PRS resource sets according to a PRS resource setting of the base station 110a, 110b, 114. The structure of the one or more PRS resources, PRS resource sets, and PRS resource settings within a PRS transmission may be referred to as a multi-level resource setting. For example, multi-level PRS resource setting of the base station 110a, 110b, 114 may include multiple PRS resource sets and each PRS resource set may contain a set of PRS resources (such as a set of 4 PRS resources).

The UEs 105 may receive the PRS transmission over the one or more PRS resources of the slot. The UEs 105 may determine a report parameter for at least some PRS resources included in the transmission. The report parameter (which may include a report quantity) for each PRS resource may include one or more of a time of arrival (TOA), a reference signal time difference (RSTD), a reference signal receive power (RSRP), an angle, a PRS identification number, a reception to transmission difference (UE Rx-Tx), a signal-to-noise ratio (SNR), or a reference signal receive quality (RSRQ).

Similarly, the UEs 105 may be configured to transmit one or more additional uplink reference signals that may be received by base stations 110a, 110b, 114 and used for positioning. For example, UEs 105 may transmit sounding reference signal (SRS) for positioning. Base stations 110a, 110b, 114 that receive uplink reference signals from a UEs 105 may perform positioning measurements, such as one or more of a time of arrival (TOA), reception to transmission difference (UE Rx-Tx).

A position estimation of the UE may be determined using reference signals, such as PRS signals or SRS for positioning signals, or other reference signals, from one or more base stations 110a, 110b, 114 or the UE. Positioning methods, such as downlink (DL) Time Difference of Arrival (DL-TDOA), DL Angle of Departure (DL AOD), Enhanced Cell ID (ECID) are position methods that may be used to estimate the position of the UE using reference signals from base stations. DL-TDOA, for example, relies on measuring Reference Signal Time Differences (RSTDs) between downlink (DL) signals received from a base station for a reference cell and base station(s) for one or more neighbor cells. The DL signals for which RTSDs may be obtained comprise a Cell-specific Reference Signal (CRS) and a Positioning Reference Signal (PRS).

Other positioning methods may use reference signals transmitted by the UE including uplink-based positioning methods and downlink and uplink based positioning methods. For example, uplink-based positioning methods include, e.g., UL Time Difference of Arrival (UL-TDOA), UL Angle of Arrival (UL AOA), UL Relative Time of Arrival (UL-RTOA). Downlink and uplink based positioning methods include, e.g., multi cell Round-trip time (RTT) between a UE and one or more neighboring base stations. Additionally, sidelink based positioning may be used in which UEs transmit and/or receive sidelink positioning reference signals that are measured and used for positioning.

As noted, while FIG. 1 depicts nodes configured to communicate according to 5G communication protocols, nodes configured to communicate according to other communication protocols, such as, for example, an LTE protocol, a IEEE 802.11x protocol, or a future 6G protocol, may be used. For example, in an Evolved Packet System (EPS) providing LTE wireless access to the UEs 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UEs 105, including cell change and handover and may participate in supporting a signaling connection to the UEs 105 and possibly data and voice bearers for the UEs 105. The LMF 120 may communicate directly or indirectly with the UEs 105, e.g., through wireless communications, or directly or indirectly with the base stations 110a, 110b, 114. The LMF 120 may support positioning of the UEs 105 when the UEs 105 access the NG-RAN 135 and may support position procedures/methods such as Assisted GNSS (A-GNSS), Time Difference of Arrival (TDOA) (e.g., Downlink (DL) TDOA or Uplink (UL) TDOA), Real Time Kinematic (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UEs 105, e.g., received from the AMF 115 or from the GMLC 125. The LMF 120 may be connected to the AMF 115 and/or to the GMLC 125. A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE) may be performed at the UE (e.g., using signal measurements obtained by the UE for signals transmitted by wireless nodes such as the gNBs 110a, 110b and/or the ng-eNB 114, and/or assistance data provided to the UE, e.g., by the LMF 120). At least part of the positioning functionality (including derivation of the location of the UE) alternatively may be performed at the LMF 120 (e.g., using signal measurements obtained by the gNBs 110a, 110b and/or the ng-eNB 114. The AMF 115 may serve as a control node that processes signaling between the UEs 105 and the core network 140, and provides QoS (Quality of Service) flow and session management. The AMF 115 may support mobility of the UEs 105 including cell change and handover and may participate in supporting signaling connection to the UEs 105.

The GMLC 125 may support a location request for the UEs 105 received from the external client 130 and may forward such a location request to the AMF 115 for forwarding by the AMF 115 to the LMF 120 or may forward the location request directly to the LMF 120. A location response from the LMF 120 (e.g., containing a location estimate or sidelink location results for the UEs 105) may be returned to the GMLC 125 either directly or via the AMF 115 and the GMLC 125 may then return the location response (e.g., containing the location estimate or sidelink location results) to the external client 130. The GMLC 125 is shown connected to both the AMF 115 and LMF 120, though only one of these connections may be supported by the 5GC 140 in some implementations.

A User Plane Function (UPF) 118 may support voice and data bearers for UE 105 and may enable UE 105 voice and data access to other networks such as the Internet 122 and to servers such as server 121 and server 123. The UPF 118 may be connected to gNBs 110 and ng-cNB 114. UPF 118 functions may include: external Protocol Data Unit (PDU) session point of interconnect to a Data Network, packet (e.g. Internet Protocol (IP)) routing and forwarding, packet inspection and user plane part of policy rule enforcement, Quality of Service (QOS) handling for user plane, downlink packet buffering and downlink data notification triggering. UPF 118 may be connected to the SLP 119 to enable support of positioning of UE 105 using SUPL. SLP 119 may be further connected to or accessible from external client 130.

As illustrated, a Session Management Function (SMF) 117 connects to the AMF 115 and the UPF 118. The SMF 117 may have the capability to control both a local and a central UPF within a PDU session. SMF 117 may manage the establishment, modification, and release of PDU sessions for UE 105, perform IP address allocation and management for UE 105, act as a Dynamic Host Configuration Protocol (DHCP) server for UE 105, and select and control a UPF 118 on behalf of UE 105.

As further illustrated in FIG. 1, the LMF 120 may communicate with the gNBs 110a, 110b and/or the ng-eNB 114 using a New Radio Position Protocol A (NRPPa), which may be defined in 3GPP Technical Specification (TS) 38.455. NRPPa messages may be transferred between the gNB 110a (or the gNB 110b) and the LMF 120, and/or between the ng-eNB 114 and the LMF 120, via the AMF 115. As further illustrated in FIG. 1, the LMF 120 and the UEs 105 may communicate using an LTE Positioning Protocol (LPP), which may be defined in 3GPP TS 37.355. Here, LPP messages may be transferred between the UEs 105 and the LMF 120 via the AMF 115 and the serving gNB 110a, 110b or the serving ng-eNB 114 for the UEs 105. For example, LPP messages may be transferred between the LMF 120 and the AMF 115 using service operations based on the Hypertext Transfer Protocol (HTTP) and may be transferred between the AMF 115 and the UEs 105 using a 5G Non-Access Stratum (NAS) protocol.

The LPP protocol may be used to support positioning of the UEs 105 using UE-assisted and/or UE-based position methods such as A-GNSS, RTK, TDOA, AOA, AOD, and/or E-CID. The NRPPa protocol may be used to support positioning of the UEs 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional Synchronization Signal (SS) transmissions from the gNBs 110a, 110b, and/or the ng-eNB 114. The LMF 120 is illustrated in FIG. 1 as being located in the core network 140, but may be external to the core network 140, e.g., in an NG-RAN. For example, the LMF 120 may be co-located or integrated with a gNB, or may be disposed remote from the gNB and configured to communicate directly or indirectly with the gNB.

With a UE-assisted position method, the UE, e.g., UE 105A or UE 105B may obtain location measurements and send the measurements to a location server (e.g., the LMF 120) for computation of a location estimate for the UE. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ), AOA, AOD, for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE, e.g., UE 105A or UE 105B, may obtain location measurements (e.g., which may be the same as or similar to location measurements for a UE-assisted position method) and may compute a location of the UE (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114), may obtain location measurements (e.g., measurements of RSSI, RTT, RSRP, RSRQ, AOA, AOD, or Time of Arrival (ToA) for signals transmitted by the UE, e.g., UE 105A or UE 105B) and/or may receive measurements obtained by the UE. The one or more base stations or APs may send the measurements to a location server (e.g., the LMF 120) for computation of a location estimate for the UE.

As noted, while the communication system 100 is described in relation to 5G technology, the communication system 100 may be implemented to support other communication technologies, such as GSM, WCDMA, LTE, etc., that are used for supporting and interacting with mobile devices such as the UEs 105 (e.g., to implement voice, data, positioning, and other functionalities). For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125.

Positioning for UEs in a radio network, such as communication system 100 shown in FIG. 1, typically uses Uu interfaces, i.e., a radio interface between a UE 105 and the radio access network, for DL PRS and/or UL PRS. Positioning for UEs may also or instead use sidelink PRS (SL PRS), which may be a specific sidelink defined reference signal for positioning or may reuse Uu PRS, e.g., UL PRS, sometimes referred to as Sounding Reference Signal (SRS) for positioning (SRSPos), or other reference signals may be transmitted in the sidelink channel. Sidelink positioning may enhance UE positioning by providing additional transmission (or reception) nodes. A UE, such as UE 105B, with a known position may be used to support position determination of another target UE, such as UE 105A, where the UE 105B is sometimes referred to as an anchor node.

With a sidelink positioning method, a UE 105A for example may transmit a sidelink PRS or sidelink (SL) SRS signal which is received and measured by another UE 105B. In addition or instead, the UE 105B for example may transmit a sidelink PRS or sidelink SRS signal which is received and measured by the UE 105A. A sidelink PRS may be similar to a PRS (e.g. DL PRS) transmitted by a gNB 110, e.g. as described previously. A sidelink SRS may be similar to an SRS (e.g. uplink) SRS transmitted by a UE 105 for measurement by a gNB 110, e.g. as described previously. SL PRS may be transmitted over separate short periods (e.g. of around 1 millisecond in duration) referred at as “SL PRS occasions” or as “SL PRS positioning occasions”. Measurements of SL PRS or SL SRS signals may include a reception to transmission time difference (Rx-Tx), time of arrival (TOA), reference signal receive power (RSRP), reference signal receive quality (RSRQ), angle of arrival (AOA) and reference signal time difference (RSTD). SL position methods may include SL round trip signal propagation time (RTT) (also referred to as ranging), SL AOA and SL AOD.

In some scenarios, a group of one or more UEs 105 may support SL positioning. In this case, one UE in the group (e.g. UE 105A) may transmit an SL PRS or SL SRS signal which may be measured by some or all of the other UEs 105 in the group (e.g. UEs 105B and 105C). Some or all of the other UEs 105 in the group may also each transmit an SL PRS or SL SRS signal (e.g. with each UE 105 transmitting SL SRS or SL PRS at a different time or times than times at which other UEs 105 in the group transmit SL PRS or SL SRS) which may be measured by some or all other UEs 105 in the group different to the UE 105 transmitting the UL PRS or ULS SRS. Measurements made by UEs 105 applicable to transmission of SL PRS or SL SRS by a group of one or more UEs 105 may include Rx-Tx, TOA, RSTD, AOA, RSRP, RSRQ. Position methods supported by these measurements may include sidelink RTT (e.g. ranging), sidelink AOA, sidelink AOD, sidelink TDOA (SL-TDOA). Based on the measurements and the position methods(s), each UE 105 may determine location results for itself and/or for one or more other UEs 105 in the group. As described previously, the location results for a UE 105 may include a range or distance between the UE 105 and each of one or more other UEs 105 in the group, a direction from the UE 105 to each of one or more other UEs 105 in the group, a direction to the UE 105 from each of one or more other UEs 105 in the group, a location of the UE 105 relative to a location of some other UE 105 in the group, a location of the UE 105 relative to some other known location, an absolute location of the UE 105, a velocity of the UE 105 or a velocity of the UE 105 relative to some other UE 105.

Sidelink positioning may be used for positioning of UEs independently of a core network (e.g. 5GC 140) or a serving PLMN. One example implementation of sidelink positioning may be found in vehicular communication systems, such as V2X, which may be used for safety related applications, such as safety warnings, traffic congestion (e.g., automated traffic control), and coordinated or automated vehicle maneuvering. One aspect of sidelink positioning that may require a solution for standardization is a sidelink positioning protocol (SLPP) that can be used between UEs, including between an RSU and UEs, and location servers. The SLPP, for example, may support sidelink positioning between UEs, RSUs, and PRUs with network access independence. The SLPP may provide support for sidelink positioning for a pair of UEs (e.g., ranging), groups of UEs (V2X), and for UEs that are members of multiple different groups. By way of example, SLPP may provide support for various position techniques currently standardized for UE-based and UE-assisted support by a location server (e.g. LMF 120) such as PRS RTT, AOA, Differential AOA (DAOA), AOD, Differential AOD (DAOD), but may also enable the support of other PRS and SRS based position methods and non-PRS methods such as RTK at a later time. By enabling the addition of new capabilities and methods at a later time, the SLPP may avoid the need to define separate new positioning protocols different to SLPP. By way of example, additional position methods that may be included in SLPP at a later time may include RTK, Wi-Fi, Ultra-Wideband (UWB), BT positioning methods.

The SLPP may enable direct sidelink operation initially (where UEs communicate and coordinate positioning by exchanging SLPP messages using sidelink signaling), and may be extended later to sidelink operation via relays and operation via a network, where UEs may exchange SLPP messages via a network or via intermediate relay UEs. For example, this might be used to coordinate positioning of two vehicles on a collision course at a corner where direct SL signaling between the two vehicles is not possible. Thus, SLPP may define support for SL PRS based positioning initially in a generic manner to simplify extension to support of other position methods later. For example, SLPP may define generic SLPP messages similar to generic LPP messages defined for LPP in 3GPP TS 37.355. SLPP may support separate position methods (e.g. SL PRS RTT, SL PRS AOA, SL PRS AOD) using common procedures and common parameters where feasible. SLPP may define procedures that can be reused for multiple position methods and are not limited to just one or a few position methods. SLPP may be enabled to be transferred and used by various entities, such as UEs, RSUs, PRUs, and location servers, such as LMFs and SUPL SLPs. The location server (e.g., LMF and SUPL SLP) usage may transfer SLPP messages inside LPP messages to enable UE-assisted positioning by an LMF or SUPL SLP. Alternatively, the location server (e.g., LMF and SUPL SLP) usage may transfer SLPP messages not in association with LPP messages to enable UE-assisted positioning by an LMF or SUPL SLP. SLPP may further support relative (local) and global positioning.

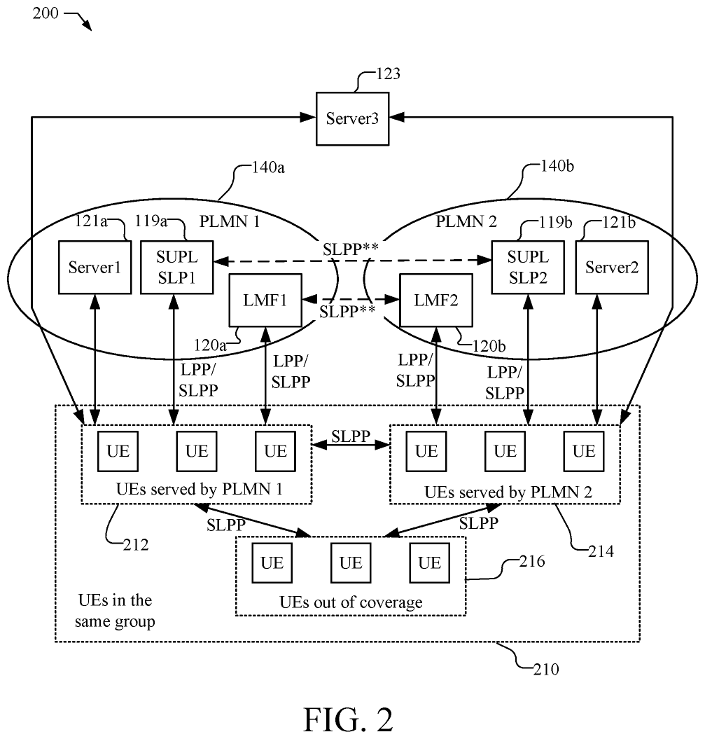

FIG. 2, by way of example, shows an architecture of a communication system 200 capable of network-supported sidelink positioning. As illustrated in FIG. 2, a number of UEs (e.g. UEs 105) may be combined within a same group 210 for sidelink positioning. Within the group 210, various subgroups of UEs may be present. For example, the group 210 of UEs may include a first subgroup 212 of UEs that is served by a first network (PLMN1 140a), while a second subgroup 214 of UEs is served by a second (different) network (PLMN2 140b), and a third subgroup 216 of UEs is out of coverage of and is not served by either network. One or more of the UEs served by a network, e.g., the UEs in subgroup 212 served by PLMN1 140a, or the UEs in subgroup 214 served by PLMN2 140b, may include RSUs.

A location server in a serving network, e.g., LMF1 120a, SUPL SLP1 119a, or Server1 121a in the serving PLMN1 140a, LMF2 120b, SUPL SLP2 119b, or Server2 121b in the serving PLMN2 140b, and Server3 123 (communicating to UEs via PLMN1 140a and/or PLMN2 140b), may assist some or all UEs in a group that are served by the network (PLMN), e.g., subgroups 212 and 214, respectively. As illustrated, the location servers may support UEs by communicating with the UEs using “LPP/SLPP,” which represents communicating using LPP, SLPP, embedding SLPP in LPP, or a combination thereof. For example, LMF1 120a and LMF2 120b may embed SLPP in LPP while supporting UEs in subgroups 212 and 214, respectively (e.g. where each SLPP message transferred between a UE and LMF1 120a or LMF2 120b is embedded in one LPP message and where one LPP message may include one or more than one embedded SLPP messages). Similarly, SUPL SLP1 119a and SUPL SLP2 119b may embed SLPP in LPP with LPP messages embedded in SUPL UserPlane Location Protocol (ULP) messages while supporting UEs in subgroups 212 and 214, respectively. Additionally or alternatively, LPP messages and/or SLPP messages may be used, where SLPP messages are not embedded in LPP messages (though LPP messages or SLPP messages may still be embedded in SUPL ULP messages). Additionally, the UEs within each subgroup, and UEs in different subgroups may exchange SLPP messages with one another to support and coordinate SL positioning.

The location server (e.g., LMF/SUPL SLP/Server1/Server2/Server3) support for a particular UE or UEs may not be visible to other UEs in the group. For example, the location server support from the PLMN1 140a for UEs in subgroup 212 may not be visible to UEs in subgroup 214 and may not be visible to the out of coverage UEs in subgroup 216. The support provided by location servers to the UEs may include determination or verification of SL PRS configurations and calculation of location results for UEs, including for UEs that are supported and for UEs that are not supported (e.g. such as calculating location results for UEs within a supported subgroup and for UEs within an unsupported subgroup, e.g. if position information for the UEs in the unsupported subgroup is provided to the location server). In some implementations, signaling between location servers in separate networks may be used to provide more complete network support. As illustrated, LMF-LMF or SUPL SLP-SUPL SLP signaling may use an extension of SLPP (referred to as SLPP** in FIG. 2) to enable more complete network support.

The SLPP message types may align with LPP message types to enable LPP messages to contain embedded SLPP messages and/or to enable SLPP procedures to align with LPP procedures which may reduce implementation and/or testing. FIG. 2 shows signaling (e.g. SLPP messages or SLPP messages embedded in LPP messages) between LMF1 120a and one or more of the UEs of subgroup 212 and signaling between LMF2 120b and one or more of the UEs of subgroup 214. FIG. 2 also shows SLPP messages, or LPP messages that contain embedded SLPP messages, and that are embedded in SUPL ULP messages that are exchanged between SUPL SLP1 119a and one or more of the UEs of subgroup 212 and between SUPL SLP2 119b and one or more of the UEs of subgroup 214. SLPP may include messages that are analogous to an LPP Request Capabilities message and an LPP Provide Capabilities message, which, for example, in SLPP may be called “Request Capabilities and Resources” and “Provide Capabilities and Resources”. The Request/Provide Capabilities and Resources in SLPP may be restricted to NR SL PRS capabilities and resources initially, but may be extended later to capabilities and resources for LTE SL PRS, RTK, Wi-Fi, BT, etc.

In another example, SLPP may include a message that is analogous to an LPP Provide Assistance Data message, which, for example, in SLPP may be called a “Provide Positioning Signal Configuration” (or just a “Provide Assistance Data”). The Provide Positioning Signal Configuration in SLPP may include one or more of, e.g., the SL PRS Configuration to be transmitted by each UE and measured by other UEs, a start time and duration of the transmission, and conditions for termination of the transmission, and the types of SL PRS measurements requested, such as Rx-Tx, AOA, RSRP, RSRD, TOA, TDOA. In some implementations, the Provide Positioning Signal Configuration in SLPP may be extended to define other types of signals, such as RTK signals to be measured, Wi-Fi signal to be transmitted and measured etc. The Provide Positioning Signal Configuration in SLPP may include additional information, for example, to assist UEs in acquiring and measuring signals (e.g. SL PRS signals) and to determine times of transmission and measurement.

In another example, SLPP may include a message such as a “Confirm Positioning Signal Configuration” (or a “Provide Assistance Data Confirm”), which does not have an analogous LPP message. The Confirm Positioning Signal Configuration in SLPP, for example, may confirm whether a Provide Positioning Signal Configuration (or a Provide Assistance Data) is agreeable. If the Provide Positioning Signal Configuration is (partly) not agreeable, a different configuration may be provided as a Provide Positioning Signal Configuration. Because LPP does not have an analogous message, a new LPP message type may be added to carry the Confirm Positioning Signal Configuration SLPP message in the case that SLPP messages are embedded in LPP messages. However, such a new LPP message type may not be needed when SLPP messages are not embedded in LPP messages.

In another example, SLPP may include a message that is analogous to an LPP Provide Location Information message, which, for example, in SLPP may be called a “Provide Location Information” message. The Provide Location Information message in SLPP may include and provide SL PRS measurements obtained by a UE for SL PRS transmitted by one or more other UEs and/or may include and provide location results obtained for the UE and/or for other UEs. The Provide Location Information in SLPP may be extended to include and provide other measurements, such as measurements of RTK, Wi-Fi, BT etc.

As illustrated in FIG. 2, UEs within each subgroup and UEs in different subgroups may signal each other using SLPP (e.g. where a UE sends an SLPP message to one or more other UEs). Additionally, location servers (e.g., LMF, SUPL SLP, or Server1-3) may support UEs using SLPP (as discussed above). As previously noted, SLPP may be embedded in LPP or embedded in both LPP and SUPL, or may be sent without embedding in LPP according to some embodiments. Accordingly, a first UE may receive a first SLPP message from a second UE and may send the first SLPP message to a location server that supports the first UE. The first UE may receive a second SLPP message from the location server in response to the first SLPP message and may send the second SLPP message to the second UE.

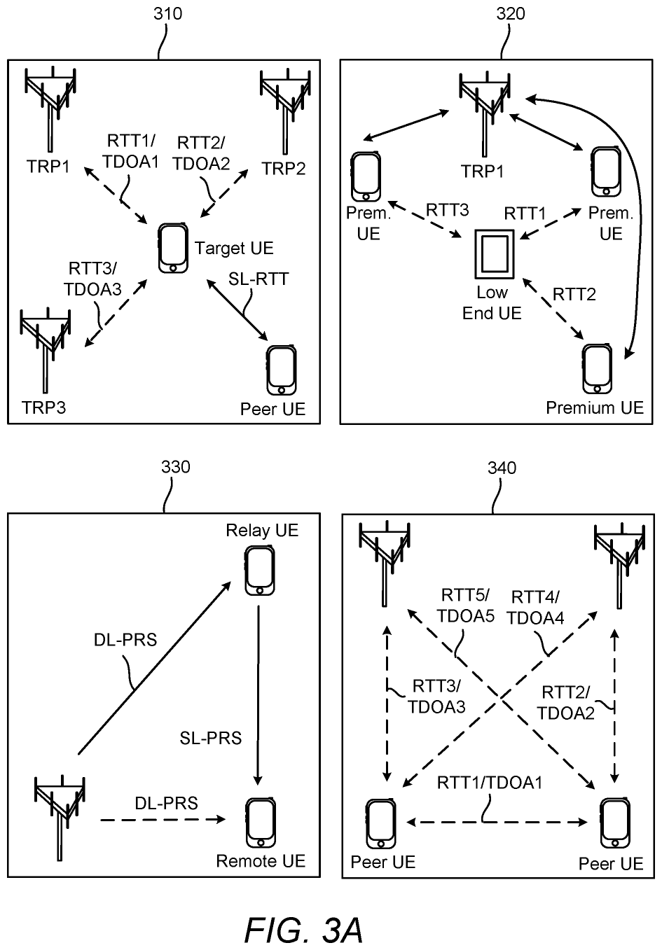

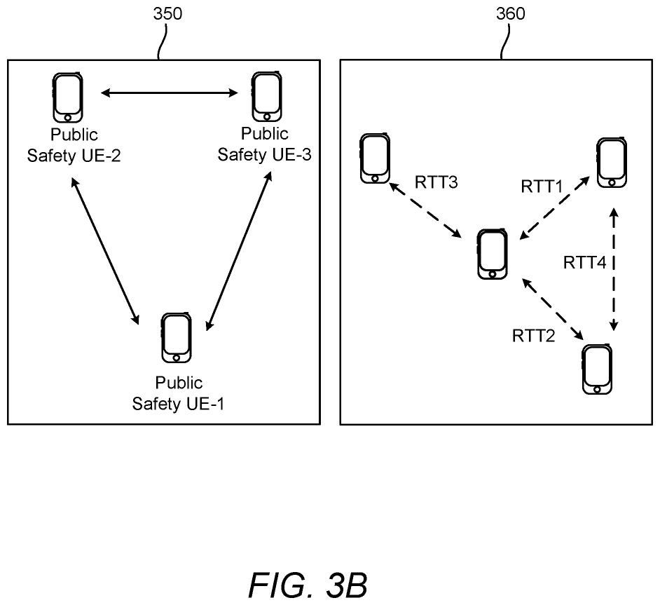

NR can support, or enable, various sidelink positioning techniques. FIG. 3A illustrates various scenarios of interest for sidelink-only or joint Uu and sidelink positioning, according to aspects of the disclosure. In scenario 310, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 320, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 330, a relay UE (e.g., with a known location) participates in the positioning estimation of a remote UE without performing uplink positioning reference signal (PRS) transmission over the Uu interface. Scenario 340 illustrates the joint positioning of multiple UEs. Specifically, in scenario 340, two UEs with unknown positions can be jointly located in non-line-of-sight (NLOS) conditions by utilizing constraints from nearby UEs.

FIG. 3B illustrates additional scenarios of interest for sidelink-only or joint Uu and sidelink positioning, according to aspects of the disclosure. In scenario 350, UEs used for public safety (e.g., by police, firefighters, and/or the like) may perform peer-to-peer (P2P) positioning and ranging for public safety and other uses. For example, in scenario 350, the public safety UEs may be out of coverage of a network and determine a location or a relative distance and a relative position among the public safety UEs using sidelink positioning techniques. Similarly, scenario 360 shows multiple UEs that are out of coverage and determine a location or a relative distance and a relative position using sidelink positioning techniques, such as SL-RTT.

With a SL positioning method (also referred as “SLPP positioning”), a first UE may transmit a SL-PRS or SL-SRS signal which is received and measured by a second UE. In addition or instead, the second UE may transmit a SL-PRS or SL-SRS signal which is received and measured by the first UE. Measurements of SL PRS or SL SRS signals may include Rx-Tx, TOA, RSRP, RSRQ, AOA. SL position methods may include SL RTT (also referred to as ranging), SL AOA and SL AOD. In some scenarios a group of one or more UEs may support SL positioning. In this case, one UE in the group may transmit an SL PRS or SL SRS signal which may be measured by some or all other UEs in the group. Some or all other UEs in the group may also transmit an SL PRS or SL SRS signal (e.g. with each UE transmitting SL SRS or SL PRS at a different time or times than times at which other UEs in the group transmit SL PRS or SL SRS) which may be measured by some or all other UEs in the group different to the UE transmitting the UL PRS or ULS SRS. Measurements made by UEs applicable to transmission of SL PRS or SL SRS by a group of one or more UEs may include Rx-Tx, TOA, RSTD, AOA, RSRP, RSRQ. Position methods supported by these measurements may include SL RTT (e.g. ranging), SL AOA, SL AOD, SL TDOA (SL-TDOA). Based on the measurements and the position methods(s), each UE may determine a relative location of itself and/or of other UEs or absolute locations. For example, a relative location of a UE may comprise a location of the UE relative to one or more other UEs in the group.

In some designs, location server (e.g., LMF/SUPL SLP) support for UEs may not be visible to other UEs in the group (e.g., out-of-coverage UEs). The support provided by location servers to the UEs may include determination or verification of PRS configurations and calculation of relative locations of UEs, including UEs within the supported subgroup as well as UEs within unsupported subgroups, e.g., if position information for UEs in unsupported subgroups is proved to the location server. For example, in some implementations, signaling between location servers in separate networks may be used to provide more complete network support.

In some designs, SLPP message types may align with LPP to enable LPP messages to contain SLPP messages. In some designs, LPP messages that contain SLPP messages may be embedded in Secure User Plane Location (SUPL) Userplane Location Protocol (ULP) messages. For example, SLPP may include messages that is analogous to LPP Request Capabilities and Provide Capabilities, which, for example, in SLPP may be called Request Capabilities and Resources and Provide Capabilities and Resources. The Request/Provide Capabilities and Resources in SLPP may be restricted to NR PRS, but may be extend to LTE PRS, Real Time Kinematics (RTK), WiFi, BT, etc.

In another example, SLPP may include a message that is analogous to LPP Provide Assistance Data, which, for example, in SLPP may be called Provide Positioning Signal Configuration. The Provide Positioning Signal Configuration in SLPP may include one or more of, e.g., the PRS Configuration to be transmitted by each UE and measured by other UEs, a start time, duration, and conditions for termination, and the types of measurements requested, such as Rx-Tx, AOA, RSRP, TDOA. In some implementations, the Provide Positioning Signal Configuration in SLPP may be extended to define other types of signals, such as RTK signals to be measured, WiFi signal to be transmitted and measured etc. The Provide Positioning Signal Configuration in SLPP may include additional information, for example, to assist UEs in acquiring and measuring signals and to determine times of transmission.

In another example, SLPP may include a message such as Confirm Positioning Signal Configuration, which does not have an analogous LPP message. The Confirm Positioning Signal Configuration in SLPP, for example, may confirm whether a Provide Positioning Signal Configuration is agreeable. If the Provide Positioning Signal Configuration is (partly) not agreeable, a different configuration may be provided as a Provide Positioning Signal Configuration. Because LPP does not have an analogous message, a new LPP message type may be added to carry the Confirm Positioning Signal Configuration SLPP message.

In another example, SLPP may include a message that is analogous to LPP Provide Location Information, which, for example, in SLPP may be called Provide Location Information. The Provide Location Information in SLPP may provide PRS measurements of other UEs and/or relative locations to other UEs. The Provide Location Information in SLPP may be extended to other measurements, such as measurements of RTK, WiFi, BT etc.

In some designs as noted above, Sidelink Positioning for relative positioning, ranging and absolute positioning may include UE discovery, session-based operation, session-less operation, capability exchange, measurement configuration, and exchange of location information resulting from performed measurements. Depending on the deployment scenario and operational use case, sidelink positioning and ranging may occur between UEs, or between UEs and an LMF, over multiple cast types.

Fundamental to sidelink positioning and ranging is UE peer-to-peer operation. As such, the current 5GS architecture, using network-based location servers (user plane location servers or control plane location servers), is not sufficient for sidelink positioning.

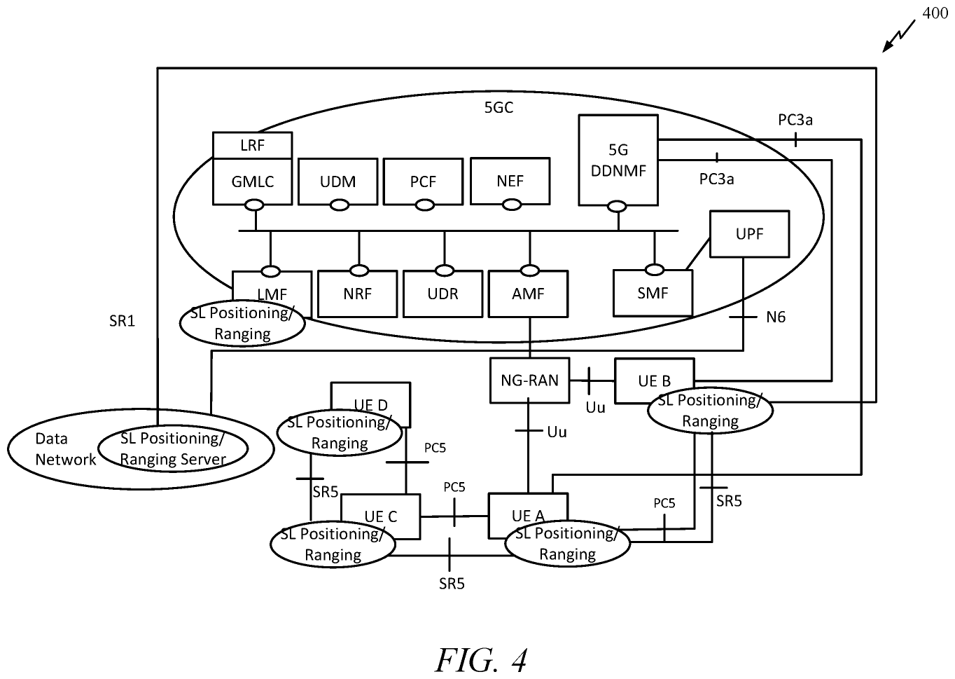

FIG. 4 illustrates a reference architecture 400 for Sidelink Positioning and Ranging-based services for non-roaming and same PLMN operation. This architecture supports sidelink positioning and ranging for in-coverage (IC), out-of-coverage (OOC), and partial-coverage (PC) operation and is suitable for both PC5-only positioning and for joint PC5-Uu positioning. A Sidelink Positioning/Ranging Function (SPRF) provides SLPP support between UEs to configure measurements and exchange measurement results. The SPRF may also provide location and range computation on behalf of other UEs. For scenarios involving an LMF, through the SPRF, the LMF may request UE capability information, configure measurements, receive measurement results, and perform location and range computation for, and/or on behalf of, participating UEs. Two or more UEs may participate in a one-to-many or many-to-one sidelink positioning and ranging session using discovery and positioning protocols over the SR5 reference point. SR5 is carried over the PC5 reference point and provides the interface for discovery and SLPP positioning protocol between UEs.

The terms Target UE and Anchor describe specific UE functions or capabilities a UE may exercise when participating in sidelink positioning (discussed more below). These roles are not entities of the architecture, but rather UE functions. The architectural entity/node is still a “UE”, and each UE in the architecture may act as a “target”, as an “anchor”, as a “server” etc., depending on its respective capabilities. In particular, a UE may support several roles simultaneously. For example, a UE may be a target of positioning while also assisting positioning of other UEs. Thus, the NG-RAN positioning architecture may be independent of “UE role” (function), with no need to define separate architecture diagrams for in-coverage, partial-coverage, or out-of-coverage UEs.

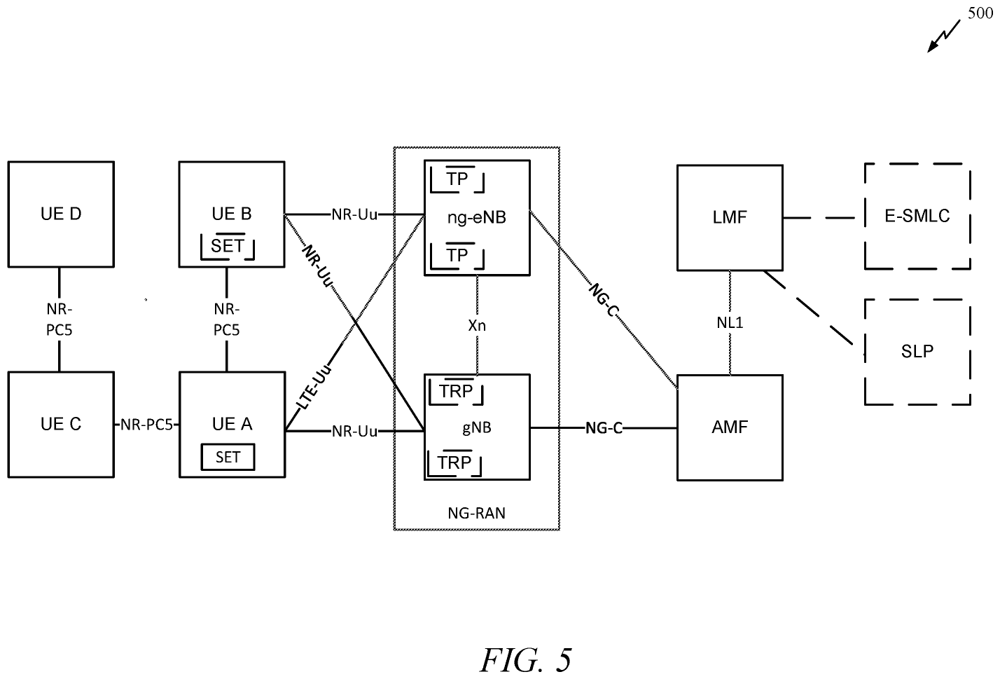

The reference architecture described in FIG. 4 can be directly mapped to an overall positioning architecture as shown in FIG. 5, which shows a UE Positioning Architecture 500 applicable to NG-RAN for all coverage scenarios (e.g., no separate architecture for in-coverage or out-of-coverage scenarios is needed). In-coverage UEs (UE A, UE B) and out-of-coverage UEs (UE C, UE D) conduct sidelink positioning and ranging over the PC5 reference point using SLPP. Network components, such as an LMF supporting SLPP, can provide UE assistance by requesting UE capabilities, configuring measurements, receiving measurement results, and computing resultant positions or relative locations, as further discussed below.

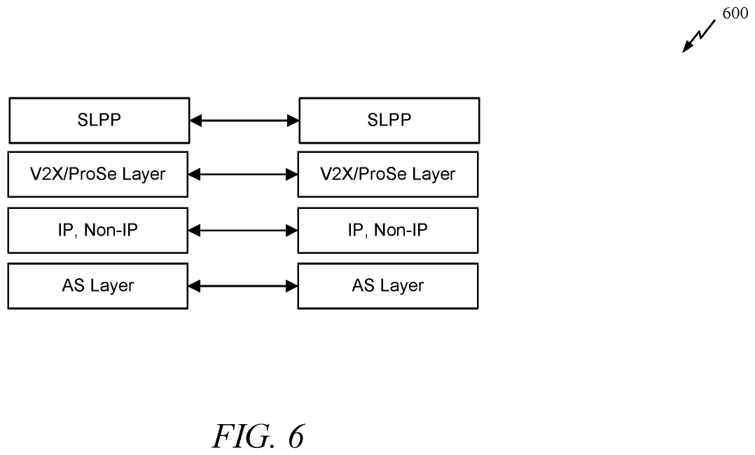

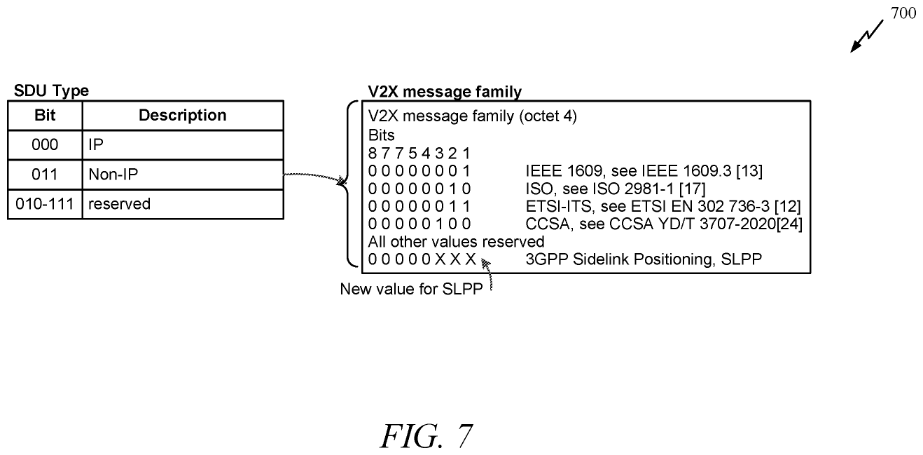

In some designs, PC5-U is used for transport of SLPP. FIG. 6 illustrates SLPP protocol layering 600 over PC5 reference point. FIG. 7 illustrates a SLPP Non-IP type encoding scheme 700. In some designs, for protocol layering, SLPP over PC5-U can reuse the existing SDU header type “non-IP”, by simply defining one additional V2X message family encoding value for the non-IP type used by SLPP (for example “SR5”), as shown in FIG. 7. This enables SLPP signaling over SR5 to be handled, as a V2X application and as payload over the V2X/ProSe layer using the PC5 user plane protocol layering illustrated in FIG. 6.

Sidelink communication may be susceptible to packet loss due to changes in UE separation/proximity, such as in the case of moving UEs, or due to occlusion between UEs. Such behavior is a characteristic of sidelink communication regardless of cast or transport type. This packet loss may lead to the loss of SLPP messages.

In the case of LPP for Uu operation, loss of LPP messages is also possible when an LPP message is not successfully forwarded by an MME or AMF. Consequently, LPP already contains a reliable transport mechanism, including acknowledgment and retransmission capability at the LPP level. Since PC5-U transport does not natively provide a reliable transport mechanism, the LPP acknowledgment and retransmission capability could also be supported by SLPP, enabling SLPP procedures to be designed with redundancy and tolerance to transport failure. With redundancy a UE can send an SLPP request message to a group of one or more UEs with each UE in the group responding to acknowledge receipt of the message, or responding to acknowledge having performed or being able to later perform the requested operation (e.g., transmission and/or measurement of sidelink reference signals). If each response also carries the original information from the SLPP request message, any UE that did not receive the SLPP request message but receives at least one response message may be able to infer and reconstruct the original SLPP request and thereby overcome the original SLPP message loss. With LPP-based reliability applied to SLPP, the sender of an SLPP request message to a group of one or more UEs can determine when the message was not received by target UEs, and subsequently take appropriate action(s), such as resending the request message at a later time, or not expecting the non-responding UEs to conduct the requested actions.

LPP-based reliability implemented in SLPP is relevant to session-based operation, where a group of one or more UEs engaged in a sidelink ranging and positioning session would benefit from reliable transport, in particular if the resulting range/position is applied to group operation. A session leader (initiator) could choose to invoke reliability if the leader determines it is appropriate for the session. In contrast, session-less operation seeks to minimize overhead and latency for ranging/positioning between UEs that have a temporally brief interaction, and as such, may not require reliable transport. Hence, the initiator of a session-based or session-less sidelink ranging and positioning transaction may have the flexibility of deciding whether or not to invoke SLPP reliable transport. LPP-based reliability implemented in SLPP provides the additional advantage that SLPP can operate reliably between a UE and an LMF, as further discussed below.

In some designs, communication over sidelink may incur packet loss due to changes in participating UE relative position and/or occlusion, potentially leading to SLPP message loss. Mechanisms may be added to support SLPP robustness such as redundancy, acknowledgement and retransmission, and/or tolerance to transport failure.

In some designs, LPP reliable transport mechanisms of duplicate detection, acknowledgement and retransmission can be applied to SLPP.

In some designs, SLPP supports at least the LPP reliable transport mechanisms for duplicate detection, acknowledgement and retransmission.

In some designs, regarding session-based and session-less operation, Sidelink positioning supports a session-based concept in SLPP, in which signaling messages within a session can be associated with one another by the involved UEs. In some designs, sessionless operation may be supported.

In some designs, regarding session-based and session-less operation, at least in the case that positioning methods are supported that do not require a mutual exchange of SLPP messages associated with one another among UEs, SLPP sessionless operation can be supported. In some designs, sessionless operation may be operated with security.

In some designs, for session-based SLPP, a SLPP session is used among UEs in PC5-only case in order to obtain location related measurements/location estimates, to transfer assistance data, or to exchange of capabilities.

In some designs, for session-based SLPP, a single SLPP session is created to support a single location request at least in case of a single target UE. In an aspect, support for sessions where there are multiple target UEs in a single location request may be provided.

In some designs, for session-based SLPP, SLPP transactions are indicated at the SLPP protocol level with a transaction ID in order to associate messages with one another (e.g., request and response)“.

In some designs, for session-based SLPP, messages within a transaction are linked by a common transaction identifier.

In some designs, group positioning may be utilized to acquire location estimates of multiple target UEs (absolute positioning) or multiple UE pairs (Ranging/relative positioning) per LCS request. In some designs, at least part of the group management for group positioning can be performed at upper/application layer.

Sidelink positioning may support numerous use cases, including V2X, public safety (PS), commercial, and Industrial Internet of Things (IIOT). These use cases may involve stationary UEs, moving UEs or a combination/group of stationary and moving UEs. An individual UE in one of these use cases may initiate a sidelink positioning session with one or more UEs in its vicinity (UEs with which it can establish sidelink communication). Those UEs may constitute all the UEs in the initiating UE's vicinity, a subset of the UEs in the initiating UE's its vicinity, or only a single UE in the initiating UE's vicinity. Group-based use cases for sidelink ranging and positioning include scenarios for V2X with RSUs and multiple vehicles, multiple vehicles in a platoon, and mission critical (MCX) service and a Museum Tour or other Tour.

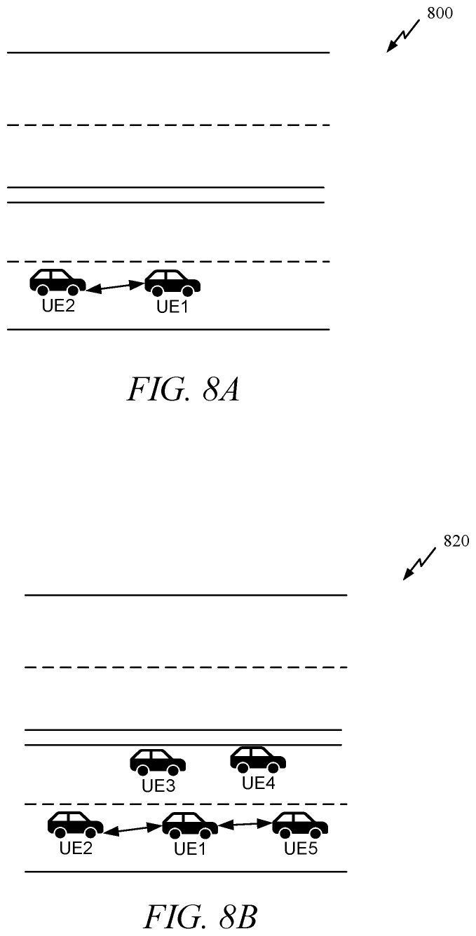

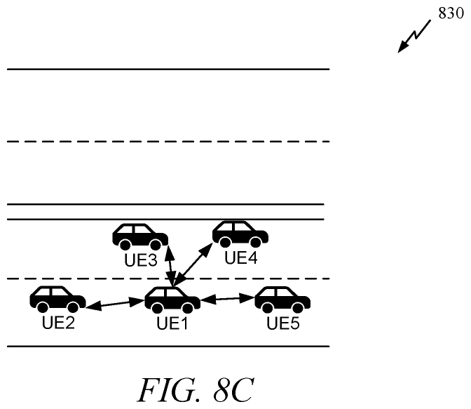

Example use cases are illustrated in FIGS. 8A-8C. FIGS. 8A-8C illustrate Sidelink Positioning/Ranging example scenarios 800, 820 and 830, respectively, in accordance with aspects of the disclosure. In this example, UE1 initiates a sidelink positioning session with the sole UE in its vicinity in FIG. 8A. In FIG. 8B, UE1 initiates a sidelink positioning session with a subset of the four UEs in its vicinity, and in FIG. 8C, UE1 initiates a sidelink positioning session with all of the UEs in its vicinity. Note that although the example in FIGS. 8A-8C is for a V2X use case, the three scenarios illustrated are equally applicable to the public safety, commercial and IIOT use cases as well. In an aspect, a UE may initiate a sidelink positioning session with one of the UEs in its vicinity, or with a group of one or more UEs in its vicinity. When initiating a sidelink positioning session with a group of one or more UEs, the group could constitute all, or a subset of the UEs in the initiating UE's vicinity.

For sidelink positioning and ranging scenarios where the participating UEs are aware of each other's presence (for example if the three participating UEs in FIG. 8B or the five participating UEs in FIG. 8C have an established awareness or association), positioning may be supported using session-based operation. For sidelink positioning and ranging scenarios that do not require mutual exchange of SLPP messages associated with one another, session-less operation may be used (for example if participating UEs do not have an established association). Determination of session-based or session-less operation could be made by the Application layer based on the specific scenario, use case and determination of participant UEs (for example position/range a specific set of one or more UEs or position/range a group of proximate UEs). The subsequent session-based or session-less transactions would then be instantiated by SLPP. The following description provides descriptions of possible SLPP session establishment, termination and modification.

LPP does not support explicit management of LPP sessions and services. An LPP session is always a one-to-one association between one UE and one location server, with the location server (e.g., LMF in the case of NR) always assumed to control the LPP session, not the UE. In contrast, for sidelink positioning, a UE may participate simultaneously in multiple SLPP sessions (V2X, MCX, public safety, etc.). Each separate SLPP session may be with a different UE, with a different group of one or more UEs, or with overlapping groups of UEs. Each SLPP session may have different requirements for ranging, positioning, periodicity, methods used, etc. A UE participating in multiple SLPP sessions, each with different session participants and different session requirements, must maintain knowledge and status of the distinct sessions and session participants. To accommodate UE operational considerations, including power consumption and privacy, a UE may also be able to accept or reject session participation. Furthermore, given the mobile nature of sidelink UEs, session participant composition may change over the course of a session, implying the ability to support session modification and session termination. These aspects of sidelink positioning session operation (explicit session accept, reject, modification and termination) cannot be directly supported using the SLPP LPP-based Capability, Assistance Data, Location Information. Instead, new SLPP messages are needed which can be considered part of SLPP session and service management.

The following descriptions of SLPP session establishment and session modification assume SLPP support for session accept, reject, terminate and modify. Note that for session-less operation, these SLPP capabilities are not required.

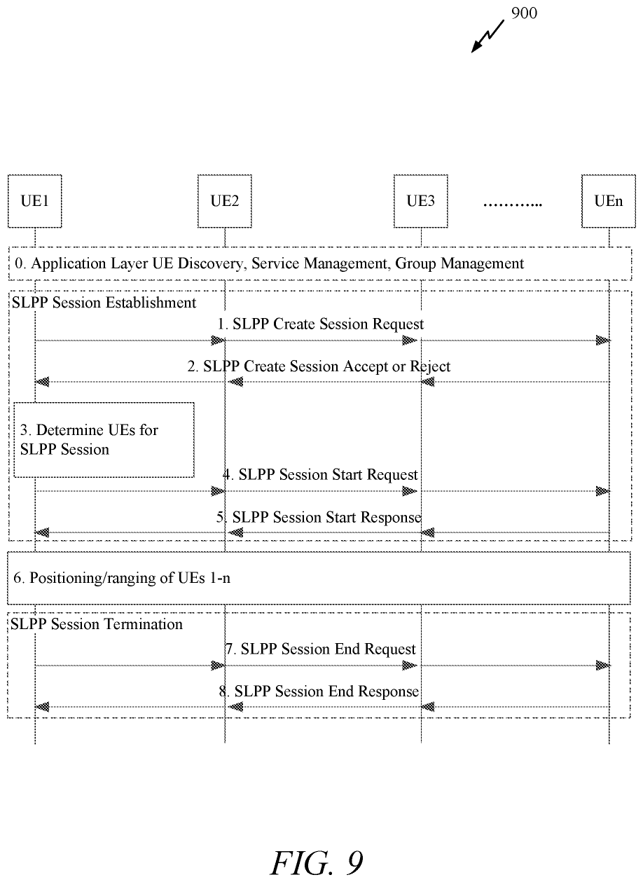

FIG. 9 illustrates a SLPP Session establishment procedure 900, in accordance with aspects of the disclosure. In some designs, SLPP is carried as payload over the V2X/ProSe layer, with interaction and exchanges between the Application-layer and SLPP layer. FIG. 9 includes operations 0 through 8, which are summarized as follows:

FIG. 9, Operation 0: The Application layer in UE1 and other UEs may perform UE discovery, determine and verify required services and perform group management (e.g. create a group containing UEs 1 to n). The Application layer in UE1 also verifies that all of the UEs 1 to n support SLPP. The Application layer in UE1 then requests sidelink ranging and positioning results for UEs 1 to n from the SLPP layer in UE1, and provides the SLPP layer in UE1 the application layer IDs and layer 2 IDs for each of the UEs 1 to n, and may provide an application layer group ID and a layer 2 group ID for the group of one or more UEs 1 to n. In some designs, the exact API between Application Layer and SLPP layer can be regarded as implementation dependent.

FIG. 9, Operation 1: UE1 sends an SLPP Create Session Request message to each of UEs 2 to n. The message includes an SLPP Session ID assigned by UE1 and may include a layer 2 group ID for the SLPP session. The SLPP Create Session Request message also includes an SLPP transaction ID to associate the SLPP Create Session Request message with received SLPP Create Session Accept and SLPP Create Session Reject messages. The SLPP Create Session Request message may be sent via unicast, groupcast or broadcast.

FIG. 9, Operation 2: Each (from the UEs 2 to n) which can accept the Session Request sends an SLPP Create Session Accept Message to UE1. Otherwise, the UE sends a SLPP Create Session Reject message to UE1. The SLPP Create Session Accept message and the SLPP Create Session Reject messages include the SLPP transaction ID associated with the SLPP Create Session Request message. The SLPP Create Session Accept message and the SLPP Create Session Reject message may be sent via unicast, groupcast or broadcast.

FIG. 9, Operation 3: UE1 determines the UEs for the SLPP session from the UEs that return an SLPP Create Session Accept at operation 2. In this example of FIG. 9, all UEs 2 to n are assumed to accept the SLPP session request.

FIG. 9, Operation 4: UE1 transmits a SLPP Session Start Request message to the UEs 2-n determined for the session at operation 3 to start the SLPP session. The SLPP Session Start Request message includes the Application Layer ID and Layer-2 ID for each UE in the session and a UE1 assigned SLPP UE ID for each UE in the positioning session. The SLPP UE ID may be an integer (e.g. in the range 1 to n) identifying each UE within the SLPP session. The SLPP Session Start Request message also includes an SLPP transaction ID to associate the SLPP Session Start Request message with received SLPP Session Start Response message. The SLPP Session Start Request message may be sent via unicast, groupcast or broadcast.

FIG. 9, Operation 5: UEs 2-n acknowledge the session start with an SLPP Session Start Response: Accept message, subsequent to which the positioning within the session can start. The SLPP Session Start Response: Accept message includes the SLPP transaction ID associated with the SLPP Create Session Start Request message. The SLPP Session Start Response: Accept message may be sent via unicast, groupcast or broadcast. In an aspect, after performing the session establishment at operations 4 and 5, all UEs 1 to n would be aware of all other UEs in the session, including their Application Layer IDs, Layer-2 IDs, SLPP IDs and the layer 2 group ID, etc. Only the SLPP UE ID and SLPP Session ID are then required in the subsequent SLPP transactions (e.g., at operation 6).

FIG. 9, Operation 6: The SL positioning/ranging procedures are carried out.

FIG. 9, Operations 7-8: Once positioning has been completed (e.g., once the application layer request at operation 0 is fulfilled), UE1 may send a SLPP Session End Request message to each participant UE 2-n, which each UE acknowledges by sending a SLPP Session End Response message back to UE1. The SLPP Session End Request and the SLPP Session End Response messages include an SLPP transaction ID to associate the Request and Response messages. The SLPP Session End Request message and the SLPP Session End Response message may be sent via unicast, groupcast or broadcast.

Referring to FIG. 9, in an aspect, the SLPP Layer may assign an SLPP Session ID unique to the specific sidelink positioning session, and assign to each UE participating in that session an individual SLPP ID. The SLPP ID may be an integer (e.g. in the range 1 to n). The SLPP Session ID could be an integer value or might comprise a unique indication of UE1 plus a UE1 assigned local numeric ID.

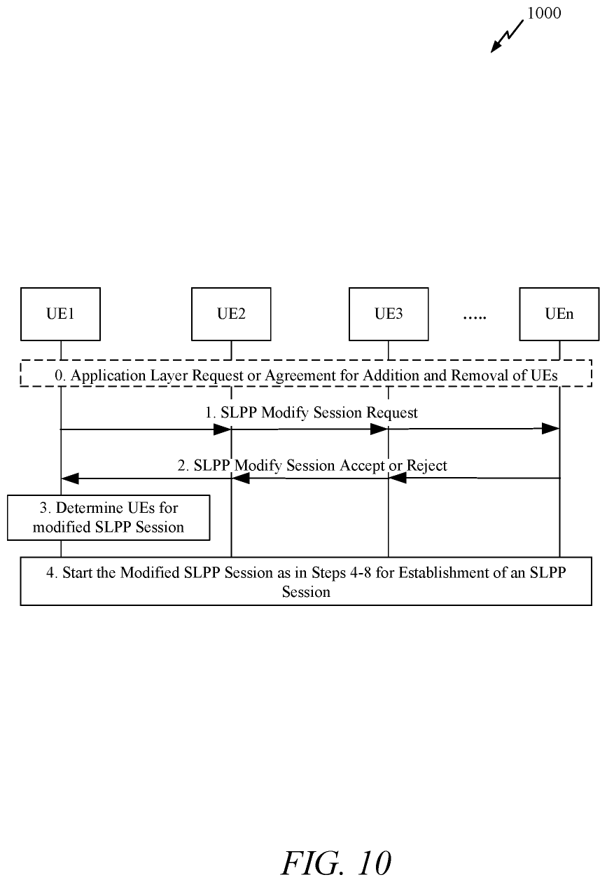

An SLPP session may be modified through the addition or removal of UEs, for example as illustrated in FIG. 10. FIG. 10 illustrates a SLPP Session modification Procedure 1000, in accordance with aspects of the disclosure.

Session modification is particularly relevant to sidelink positioning given the dynamic nature of sidelink use cases introduced by UE mobility. It is quite likely UE accessibility within any initial set of one or more UEs in a sidelink ranging/positioning session may change during the ranging/positioning session. An initial set of one or more UEs in a SLPP session may also change, for example, during Operation 6 in FIG. 9 after the SLPP session has been established because not all UEs may have the required SLPP positioning capabilities (e.g., SL-PRS, SL-position method capability, capability to act as an anchor UE, etc.). Hence, UEs may have to be removed from the SLPP session and newly discovered UEs may have to be added to the SLPP session. The Application Layer may also determine UE addition and removal for other reasons, e.g., due to a change of service requirements for some UEs.

FIG. 10 illustrates a procedure 1000 for modification of an SLPP session (e.g. that may have been established using the procedure 900 of FIG. 9), and includes operations 0 through 4, which are summarized as follows:

FIG. 10, Operation 0: The Application Layer in UE1 may request the SLPP layer to add and/or remove UEs to a group of one or more UEs for which an SLPP session was previously established. Alternatively, or in addition, the SLPP layer in UE1 may detect that some UEs in an SLPP session are no longer available for SLPP positioning (e.g., due to no longer being in PC5 range of other UEs or due to lack of sufficient resources or capabilities to perform SLPP positioning) and may need to remove these UEs from a previously established SLPP session.

FIG. 10, Operation 1: UE1 sends an SLPP Modify Session Request to the modified set of one or more UEs in the SLPP session (UEs currently in the session included in the modified session and any new UEs). The SLPP Modify Session Request message can be sent unicast, groupcast or broadcast to both current UEs and new UEs (e.g. using a new layer 2 group ID provided by the Application layer at operation 0). The SLPP Modify Session Request message may include a new layer 2 group ID for the SLPP modified session and a new SLPP session ID. UEs currently included in the SLPP session can be addressed using their SLPP UE IDs and any new UEs can be addressed using their application layer IDs. If it is not possible or not allowed (e.g. for policy reasons) to groupcast or broadcast the message to both current UEs and new UEs, UE1 performs operations 1 and 2 of the SLPP establishment procedure 900 of FIG. 9 to create the SLPP modified session for the new UEs. For existing UEs that may not be part of the modified session, UE1 may perform operations 7 and 8 of the SLPP establishment procedure 900 of FIG. 9 to end the SLPP session for these UEs. The SLPP Modify Session Request message includes an SLPP transaction ID to associate the SLPP Modify Session Request message with received SLPP Modify Session Accept/Reject messages.

FIG. 10, Operation 2: Each UE (from the UEs 2 to n) which can accept the Session modification request sends an SLPP Modify Session Accept message to UE1. Otherwise, the UE sends a SLPP Modify Session Reject message to UE1. The SLPP Modify Session Accept message and the SLPP Modify Session Reject message may be sent via unicast, groupcast or broadcast. The SLPP Modify Session Accept message and the SLPP Modify Session Reject messages include the SLPP transaction ID associated with the SLPP Modify Session Request message.

FIG. 10, Operation 3: UE1 determines the UEs for the SLPP modified session from the UEs that return an SLPP Modify Session Accept message at operation 2 or an SLPP Create Session Accept message in the case that operations 1 and 2 of FIG. 9 are performed for any new UEs.

FIG. 10, Operation 4: UE1 continues the SLPP modified session as per operations 4-8 of FIG. 9 for establishment of an SLPP session. In this case, new SLPP UE IDs are assigned to all UEs by UE1 at operation 4.

Referring to FIG. 10, in an aspect, SLPP may support at least the following message types for SLPP Session-based operation:
SLPP Create Session Request/Accept/Reject
SLPP Session Start Request/Response (*)
SLPP Session End Request/Response (*)
SLPP Session Modify Request/Accept/Reject (*)

It is noted that Messages indicated above by an asterisk (*) may be combined into a single SLPP message using a setup/modify/release mechanism.

In addition to session-based operation, many sidelink positioning/ranging use cases could benefit from session-less operation, and in support of session-less operation, the following may be supported: At least in the case that positioning methods are supported that do not require a mutual exchange of SLPP messages associated with one another among UEs, SLPP sessionless operation can be supported. In some designs, sessionless operation can be operated with security.

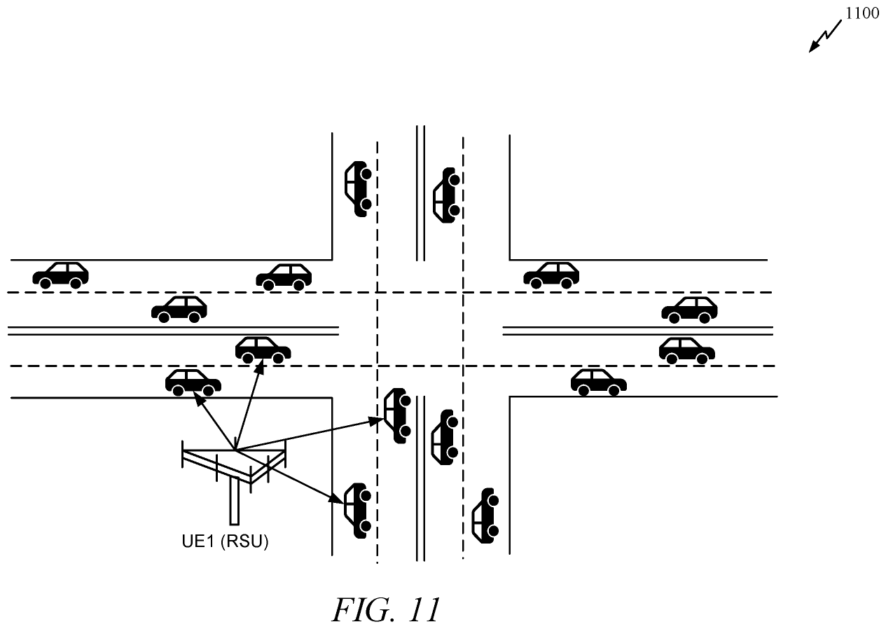

Session-less operation use cases include scenarios with dynamic or mobile UEs where it is desirable to minimize the signaling overhead and associated session-establishment latency that may be incurred with session-based operation. Applicable scenarios include one UE needing to determine position/range to UEs in its vicinity for temporary or brief time intervals, such as vehicles traversing an intersection, vehicles entering a freeway from an on-ramp, or public safety individuals moving about a theatre of operation. An example scenario 1100 is illustrated for a V2X use case in FIG. 11.

Referring to FIG. 11, for the case of vehicles traversing an intersection with an RSU UE conducting sidelink positioning/ranging to the UEs. In such a scenario, the set of one or more UEs proximate and of interest to the RSU for sidelink positioning changes often, lending itself to a more flexible, session-less operation. Note that although this scenario illustrates the benefit of session-less operation for fixed UE (RSU in FIG. 11), session-less operation is equally applicable and beneficial for mobile UEs (vehicles) initiating sidelink positioning.

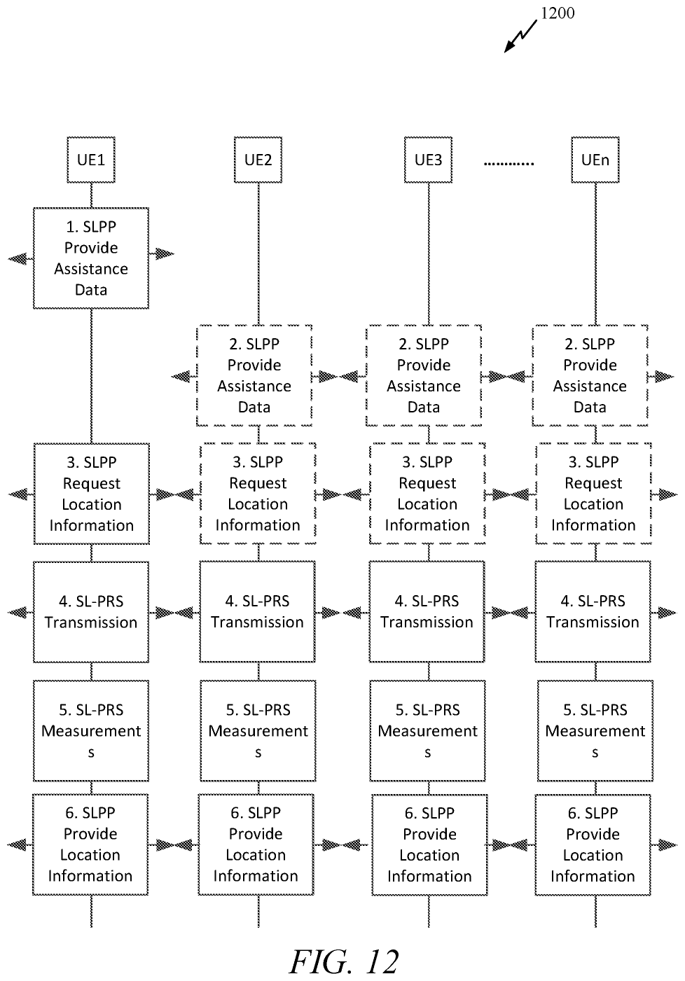

In some designs, session-less operation, signaling overhead is minimized to accommodate the dynamic UE conditions, as described below with respect to FIG. 12.

FIG. 12 illustrates SLPP session-less operation 1200, in accordance with aspects of the disclosure. FIG. 12 includes operations 1 through 6, which are summarized as follows:

FIG. 12, Operation 1: The Application layer in UE1 may request the SLPP layer to initiate sidelink positioning for UEs that may be in the vicinity of UE1. The Application layer in UE1 may make this request of the SLPP layer periodically, through configuration, or based on determination of UEs in its vicinity or by other means. UE1 transmits an SLPP Provide Assistance Data message via connection-less groupcast or broadcast. The SLPP Provide Assistance Data message includes the SL-PRS configuration for UEs which are able to participate (e.g., based on compatible capabilities). The SLPP Provide Assistance Data message includes an SLPP transaction ID to associate the SLPP Provide Assistance Data message with received SLPP Request Location Information messages and SLPP Provide Location Information messages.

Note that UEs receiving an SLPP Provide Assistance Data message absent the mutual exchange of SLPP session establishment messages may determine this is for a session-less sidelink ranging/positioning session from an allocated space of SLPP Session ID, by omission of the SLPP Session ID, or by other means.

FIG. 12, Operation 2: Each of UEs 2-n determines an SL-PRS configuration to be transmitted at operation 4. This may be based on SL PRS configuration information received at operation 1. Optionally, each of UEs 2-n transmits an SLPP Provide Assistance Data message via connection-less groupcast or broadcast. The SLPP Provide Assistance Data message includes the SL-PRS configuration that each UE may transmit at operation 4 and an identity (e.g. an application layer ID) of the UE.

FIG. 12, Operation 3: UE1 and optionally each of UEs 2-n transmits an SLPP Request Location Information message via connection-less groupcast or broadcast. The SLPP Request Location Information message indicates the measurements to be obtained at operation 5 and/or the location results to be sent at operation 6. The SLPP Request Location Information message includes the SLPP transaction ID to associate the SLPP Request Location Information message with the received SLPP Provide Assistance Data message.

FIG. 12. Operation 4: Each participating UE transmits its respective SL-PRS according to the SL-PRS configuration indicated at operation 1 or determined at operation 2. The duration of SL-PRS transmission may be controlled by a timer provided in the SLPP Provide Assistance Data message at operation 1 or operation 2.

FIG. 12, Operation 5: Each participating UE performs SL-PRS measurements according to the configurations in the SLPP Provide Assistance Data message at operation 1 or operation 2 or as requested at operation 3.

FIG. 12, Operation 6: Upon completion of the SL-PRS transmission and SL-PRS measurements or periodically during this, the participating UEs transmit a SLPP Provide Location Information message with the measurement results obtained at operation 5. SL-PRS transmission and SL-PRS measurement may be performed periodically, based on the configuration received in the SLPP Provide Assistance Data message. The SLPP Provide Location Information message includes the SLPP transaction ID to associate the SLPP Provide Location Information message with the received SLPP Provide Assistance Data message.

Referring to FIG. 12, in some designs, Session-less operation is established without mutual exchange of SLPP session establishment signaling via transmission of the SLPP Provide Assistance Data message. In some designs, an SLPP Session ID can allocate specific ID values to denote session-less operation. In an aspect, the importance of group positioning for sidelink ranging and positioning is evident. Since SLPP over PC5-U is carried as V2X payload, group management may be implemented with the upper/application layer providing group information to the V2X (SLPP) layer. The upper layer/application layer manages group composition, group identities and provides overall group management to the lower (SLPP) layer.

Referring to FIG. 12, in some designs, group positioning is to acquire location estimates of multiple target UEs (absolute positioning) or multiple UE pairs (Ranging/relative positioning) per LCS request.

Referring to FIG. 12, in some designs, at least part of the group management for group positioning is performed at upper/application layer.

Range and position calculation by UEs participating in sidelink positioning and ranging, including for range/position calculation by one UE on behalf of other, multiple target UEs (UE-assisted) and range/position calculation by multiple target UEs (UE-based), may be supported via at least unicast SLPP/RSPP “centralized” operation, i.e., operation where one UE performs range and/or position calculations based on measurement/location information relating to itself and/or other UEs. If it is determined to support group positioning, it is feasible to perform at least ranging with the estimate calculation at multiple UEs.

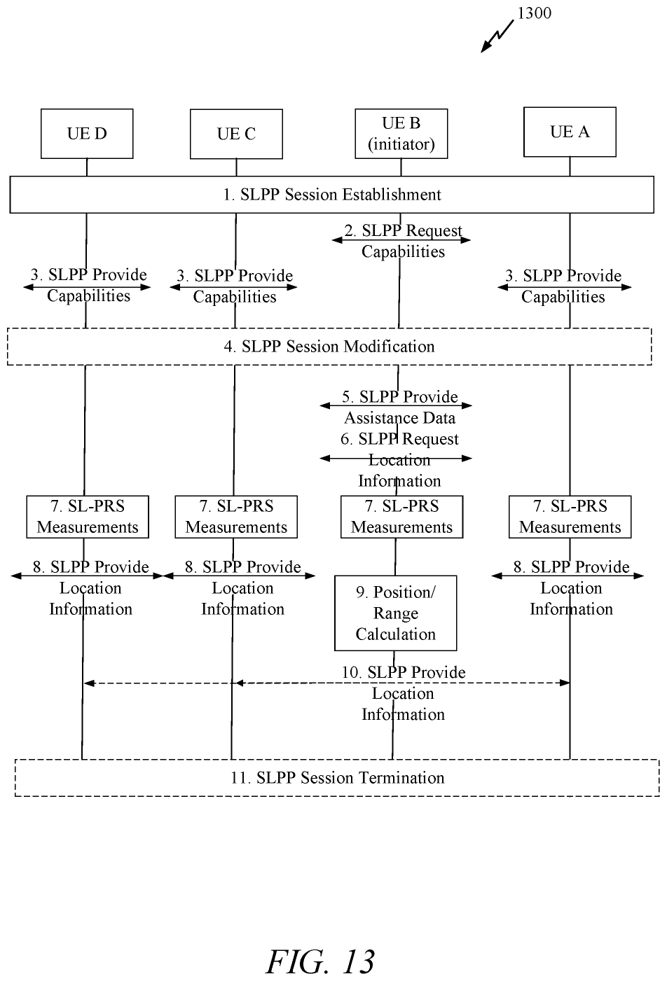

Example procedural flows for SLPP UE-assisted (one UE performing range/position calculation on behalf of other, multiple target UEs) and UE-based (multiple target UEs performing range/position calculation) are illustrated in FIGS. 12 and 13, respectively. Note that both UE-assisted and UE-based operation follow the same first seven operations (session establishment, Capability Transfer, and Assistance Data exchange).

FIG. 13 illustrates session based Sidelink-only Positioning 1300 with UE-assisted Initiator (centralized) position calculation for multiple target UEs, in accordance with aspects of the disclosure. FIG. 13 includes operations 1 through 11, which are summarized as follows:

FIG. 13, Operation 1: UE B performs the SLPP Session Establishment procedure described (e.g., as in FIG. 9)

FIG. 13, Operation 2: UE B transmits a SLPP Request Capabilities message to the group of multiple target UEs established at Operation 1 requesting the SL positioning capabilities from the UEs participating in this session. The SLPP Request Capabilities message may be sent by UE B to UE A, UE C, UE D via broadcast, groupcast or unicast, depending on the specific scenario.

FIG. 13, Operation 3: The multiple target UEs in Operation 2 addressed by UE B respond with a SLPP Provide Capabilities message. The UE capabilities may refer to particular sidelink position methods (e.g., SL-RTT, SL-AoA, SL-TDOA, etc.) or may be common to multiple position methods. The capabilities may also include the SL-PRS capabilities, an indication of whether the UE can function as an anchor UE and/or location server UE, position/range calculation capabilities, etc. If the UE can function as an anchor UE, the SLPP Provide Capabilities message may also include the location coordinates. The SLPP Provide Capabilities message may be sent by UE A, UE C, UE D via broadcast, groupcast or unicast, depending on the specific scenario.

FIG. 13, Operation 4: The SLPP Session may be modified as described in FIG. 10 based on the capability information from Operation 3 (e.g., removal of UEs with incompatible capability such as SL positioning method, anchor capability, etc.).

FIG. 13, Operation 5: UE B transmits a SLPP Provide Assistance Data message to the group of multiple target UEs established at Operations 1 or 4. The SLPP Provide Assistance Data message includes the SL-PRS configuration for each of the UEs in the group. The SLPP Provide Assistance Data message and may be sent via broadcast, groupcast or unicast, depending on the specific scenario. After receipt of the assistance data (or at an indicated starting time included in the message), each UE in the group of multiple target UEs transmits its respective SL-PRS. The duration of SL-PRS transmission may be controlled by a timer provided in the message or may continue until the SLPP session is terminated at Operation 11. The SL-PRS may be sent via broadcast, groupcast or unicast, depending on the specific scenario.

FIG. 13, Operation 6: UE B transmits a SLPP Request Location Information message to the group of one or more UEs. The message indicates the type of location information needed and associated QoS (e.g., desired accuracy, response time, etc.). The message also includes an indication that range/position calculation may be performed by the initiating UE (UE B). The SLPP Request Location Information message may be sent via broadcast, groupcast or unicast, depending on the specific scenario.

FIG. 13, Operation 7: Each participating UE performs the requested SL-PRS transmissions and measurements.

FIG. 13, Operation 8: Upon completion of the transmission and measurements or periodically or after the response time received at Operation 6 expired, the multiple target UEs each transmit a SLPP Provide Location Information message with the location results requested at Operation 6. The message may also include an indication of whether other UEs (the initiating UE B in this case) is requested to provide the location result (e.g., calculated range and/or position) back to this UE. SL-PRS transmission and SL-PRS measurement may be performed periodically, based on the configuration received in the SLPP Provide Assistance Data message. The SLPP Provide Location Information message may be sent via broadcast, groupcast or unicast, depending on the specific scenario.

FIG. 13, Operation 9: The initiating UE B performs the range/position computations using the location results received at Operation 8 and the location results UE B has obtained at Operation 7.

FIG. 13, Operation 10: If requested at Operation 8, UE B may distribute the location results for UEs A, C, D to the other UEs A, C, D in this session. The location results may be distributed via broadcast, groupcast or unicast, depending on the specific scenario.

FIG. 13, Operation 11: The SLPP session may be terminated (e.g., as in FIG. 9).

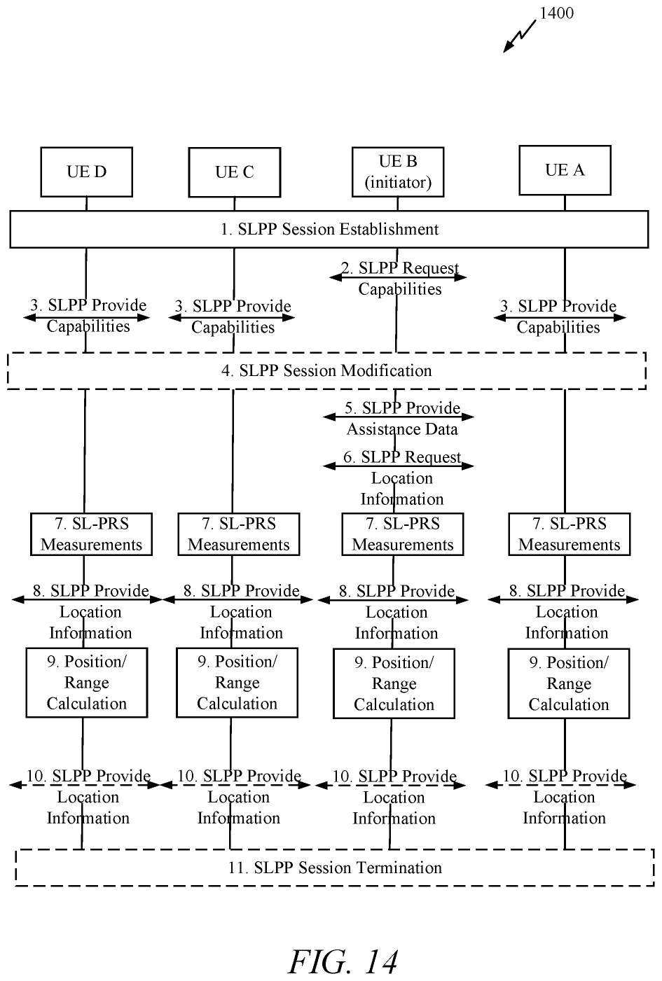

FIG. 14 illustrates session based Sidelink-only Positioning 1400 with UE-based (distributed) position calculation by multiple target UEs, in accordance with aspects of the disclosure. FIG. 14 includes operations 1 through 11, which are summarized as follows:

FIG. 14, Operations 1-5: Same as in FIG. 13.

FIG. 14, Operation 6: UE B transmits a SLPP Request Location Information message to the group of multiple target UEs. The message indicates the type of location information needed and associated QoS (e.g., desired accuracy, response time, etc.). The message also includes an indication that range/position calculation may be performed by each of the participating UEs. The SLPP Request Location Information message may be sent by UE B to UE A, UE C, UE D via broadcast, groupcast or unicast, depending on the specific scenario.

FIG. 14, Operations 7-8: Same as in FIG. 13.

FIG. 14, Operation 9: Each participating UE performs the range/position computations using the location results received at Operation 8 and the own location results obtained at Operation 7.

FIG. 14, Operation 10: If requested at Operation 8, each UE may distribute its location results to the other UEs in this session. The location results may be distributed via broadcast, groupcast or unicast, depending on the specific scenario.

FIG. 14, Operation 11: The SLPP session may be terminated (e.g., as in FIG. 9).

Referring to FIG. 14, in some designs, UE-based (distributed) sidelink positioning and ranging enables UE position calculation without the reliance on a separate UE, and can reduce overall SLPP signaling required for sidelink positioning. In an aspect, SLPP may support UE-based (distributed) sidelink positioning enabling multiple target UEs to determine position and range based on exchanged location information.

Regarding groupcast and broadcast transmission of SLPP, in some designs, it is feasible to send at least the following positioning signaling for groupcast/broadcast (in addition to unicast):
SL positioning capability
SL positioning assistance data
SL location measurements and information

In some designs, both UE-assisted (FIG. 13) and UE-based (FIG. 14) sidelink ranging and positioning involve Capability exchange and Assistance Data transfer to multiple target UEs and between multiple target UEs, as demonstrated in FIG. 13 and FIG. 14. In some designs, unicast, groupcast or broadcast may be used for transmission of Capability exchange and Assistance Data transfer. In some designs, security for sidelink ranging and positioning signaling over groupcast and broadcast is feasible. With regard to Location Information exchange, groupcast/broadcast transmission may be supported for Location Information exchange.

In some designs, sidelink ranging and positioning signaling sent over groupcast or broadcast may be supported. Solutions for secure SLPP transmission over groupcast or broadcast removes any impediments or obstacles to secure distribution of Capability, Assistance Data, and Location Information over groupcast or broadcast.

In some designs, with respect to 3GPP Precedence, existing application-layer messages carried as 3GPP V2X payload defined by SDOs including ETSI-ITS, SAE and CSAE include UE GNSS position and UE GNSS position accuracy (e.g., CAM, BSM, CPM, SDSM, etc.) may be supported. Since SLPP is also carried as V2X payload, conveyance of location information may not present a risk to UE operation.

In some designs with respect to sender UE discretion, distribution of Location Information can be at the discretion or choice of the sending (transmitting) UE. If the sender is subject to policy or other restrictions regarding Location Information exchange, it may elect not to distribute Location Information. In an aspect, security for groupcast or broadcast transmission is not an impediment to Location Information exchange over groupcast/broadcast. In an aspect, existing 3GPP V2X payload standardized messages support exchange of UE GNSS location and UE GNSS location accuracy over groupcast and broadcast. In an aspect, SLPP supports Location Information exchange over unicast, groupcast and broadcast.

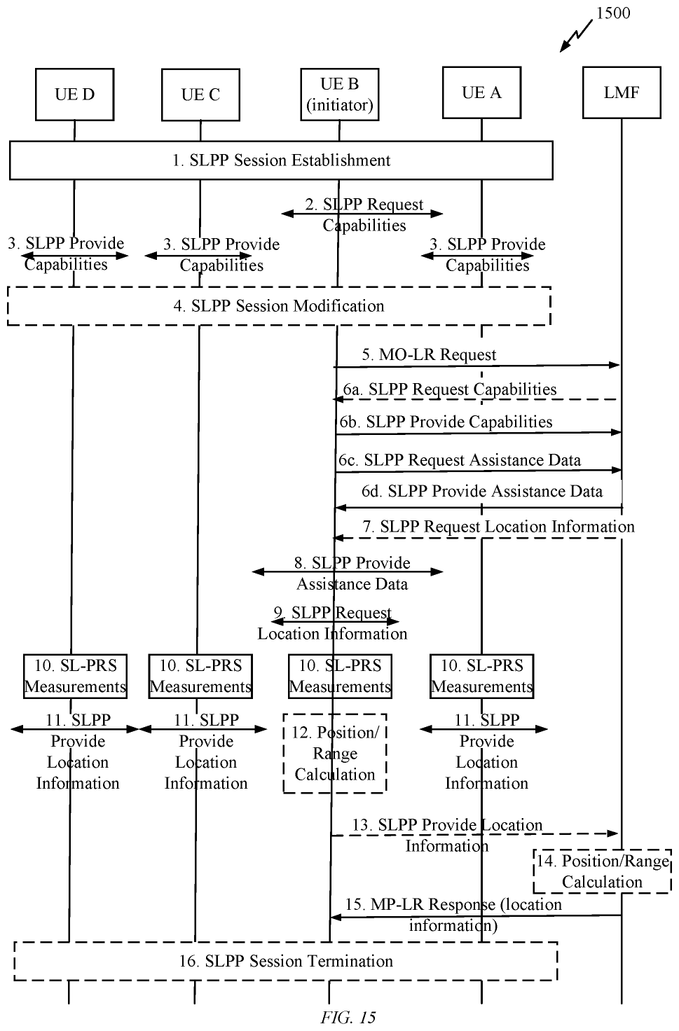

The basic SLPP transaction types (capability transfer, assistance data transfer, location information transfer) suitable for supporting out-of-coverage sidelink positioning and ranging scenarios may also be applied to in-coverage and partial coverage scenarios. These scenarios include LMF-assisted (MO-LR) and LMF-initiated (MT-LR) sidelink positioning and ranging. When at least one participating UE is in network coverage and enabled via a subscription to access a PLMN, the UE may request LMF assistance for a sidelink positioning and ranging session, or may be requested by an LMF to participate in a sidelink positioning and ranging session. In this mode of operation, not all UEs may have PLMN access and be supported by, or provide support to, an LMF (LMF support may be restricted to just some UEs). Possible examples of LMF-assisted (MO-LR) and LMF-initiated (MT-LR) are illustrated in FIGS. 15 and 16, respectively.

FIG. 15 illustrates a LMF-assisted Sidelink positioning Mobile Originated Location Request (MO-LR) procedure 1500, in accordance with aspects of the disclosure. In particular, FIG. 15 shows an example of LMF-assisted sidelink positioning and ranging, where the LMF acts as an adjunct to UE B which is in network coverage and initiating a sidelink positioning and ranging session. FIG. 15 includes operations 1 through 16, which are summarized as follows:

FIG. 15, Operations 1-4: Same as Operations 1-4 in FIG. 13.

FIG. 15, Operation 5: The initiating UE B requests positioning assistance from the LMF by sending a supplementary services (e.g. MO-LR) request to the LMF via the serving AMF of UE B. UE B can indicate whether LMF assistance is needed in the form of assistance data and/or location calculation.

FIG. 15, Operation 6: The initiating UE B may include the SL-PRS capabilities of all UEs (operation 6b) and a request for specific assistance data (operation 6c) as part of operation 5. Alternatively, the LMF may request the SL-PRS capabilities of all UEs at operation 6a, UE B may then return the capabilities at 6b, and may send a request for specific assistance data at operation 6c. The LMF then determines the requested assistance data and provides them to UE B in a SLPP Provide Assistance Data message at operation 6d.

FIG. 15, Operation 7: If UE B requested location calculation assistance at operation 5, the LMF sends an SLPP Request Location Information to UE B to request location measurement results consistent with the SL-PRS capabilities of all UEs received at operation 6b and any assistance data sent at operation 6d.

FIG. 15, Operations 8-11: Same as Operations 5-8 in FIG. 13.

FIG. 15, Operation 12: If operation 7 did not occur, the initiating UE B may perform the range/position computations using the location results received at Operation 11 and the location results UE B has obtained at Operation 10.

FIG. 15, Operation 13: If Operation 7 did occur, UE B provides the obtained location measurements from all participating UEs in the session to the LMF in an SLPP Provide Location Information message.

FIG. 15, Operation 14: The LMF performs the range/position computations.

FIG. 15, Operation 15: The LMF provides the computed ranges/positions to the UE B via the serving AMF in a supplementary service (e.g. MO-LR) response.

FIG. 15, Operation 16: The SLPP session may be terminated as described in FIG. 9.

Referring to FIG. 15, in an aspect, a MO-LR or a new supplementary services operation for UE initiated SLPP transactions towards an LMF may be supported.

FIG. 16 illustrates a LMF-initiated Sidelink positioning for a Mobile Terminated Location Request (MT-LR) procedure 1600, in accordance with aspects of the disclosure. FIG. 16 shows an example of LMF-initiated sidelink positioning and ranging operation with a target UE (UE B) in network coverage to obtain MT-LR location results. The MT-LR could have been instigated by an external client or AF (not shown in FIG. 16) which would have provided all necessary information for the MT-LR to the LMF (e.g. via a GMLC and AMF). FIG. 16 includes operations 1 through 10, which are summarized as follows:

FIG. 16, Operation 1: The LMF requests sidelink positioning from UE B via a Supplementary Service Request message for SL MT-LR. The location request indicates the type of location results requested (e.g. location of UE B and/or of other UEs), identities and/or addresses of specific UEs to be involved (e.g. UEs A, C, D), or whether any UEs can be used, and whether a single set of location results is requested (immediate location), or whether deferred (e.g. periodic or triggered) location results are requested. The supplementary services request might also include an embedded SLPP Request Location Information message indicating specific SLPP location results or measurements to be provided by UE B and/or an embedded SLPP Provide Assistance Data message to provide assistance data for the SLPP positioning session to UE B (e.g. SL-PRS configurations).

FIG. 16, Operation 2: UE B attempts to discover the other UEs A, C, D if not already discovered and establishes an SLPP session as described in FIG. 9

FIG. 16, Operation 3: UE B transmits a SLPP Request Capabilities message to the group of one or more UEs established at Operation 2 requesting the SL positioning capabilities from the UEs participating in this session.

FIG. 16, Operation 4: The UEs in Operation 3 addressed by UE B respond with a SLPP Provide Capabilities message.

FIG. 16, Operation 5: UE B may instigate the SLPP Session Modification procedure as described in FIG. 10.

FIG. 16, Operation 6: UE B confirms or acknowledges the supplementary services request from Operation 1 with a supplementary services response, which may indicate whether any requested UEs are available for positioning (e.g. whether UEs A, C, D have been discovered by UE B).

FIG. 16, Operation 7 Sidelink positioning/ranging occurs as in FIG. 13 operations 5-10, FIG. 14 operations 5-10 or FIG. 15 operations 5-12.

FIG. 16, Operation 8: UE B provides the obtained location results and/or measurements from all participating UEs in the session to the LMF in an SLPP Provide Location Information message.

FIG. 16, Operation 9: If not already included at operation 8, the LMF performs the range/position computations for the UE(s) and returns location(s) to the external client or AF. For deferred (periodic or triggered) location, the SLPP positioning by UE B and return of location results to the LMF might be repeated.

FIG. 16, Operation 10: The SLPP session may be terminated as described in FIG. 9

Referring to FIG. 16, in an aspect, a MT-LR or a new supplementary services operation for LMF-initiated SLPP transactions towards a UE may be supported.

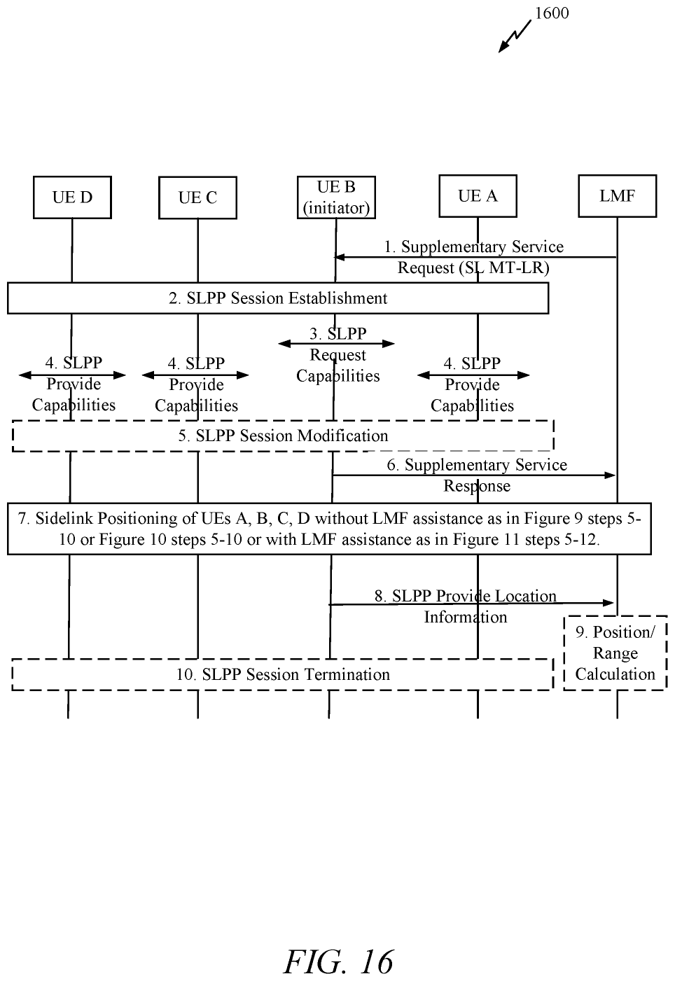

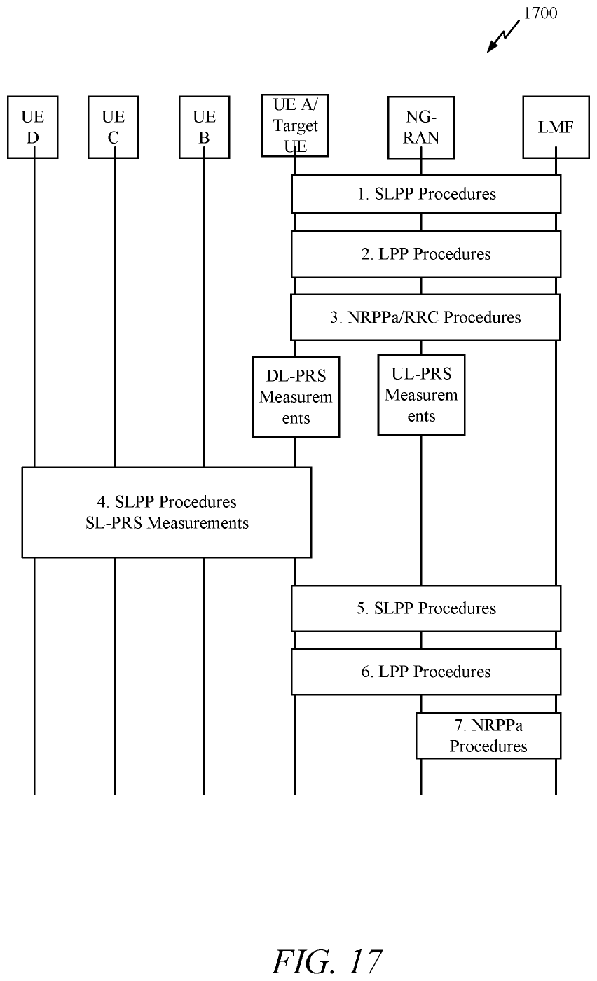

In an aspect, the basic SLPP transaction types and procedures of capability transfer, assistance data transfer, location information transfer are suitable for supporting in-coverage, partial coverage and out-of-coverage sidelink positioning and ranging scenarios may also be applied to support joint sidelink-Uu positioning. This could simply be achieved by jointly performing the SLPP, LPP and NRPPa procedures for the desired positioning methods as shown in FIG. 17 For Uu-only positioning, LPP and NRPPa are jointly used for UE positioning operation (e.g. for Multi-RTT). For joint Uu and SL positioning, any combination of LPP, SLPP, and NRPPa may be used, dependent on the desired positioning method(s) (UL-, DL-, SL-positioning).

FIG. 17 illustrates a Joint Uu-Sidelink Positioning procedure 1700, in accordance with aspects of the disclosure. FIG. 17 includes operations 1 through 7, which are summarized as follows:

FIG. 17, Operation 1: The LMF may obtain the sidelink positioning capabilities from the target UE and may request sidelink location results from the target UE.

FIG. 17, Operation 2: The LMF may obtain the LPP positioning methods capabilities from the target UE and may request location results for one or more LPP positioning method.

FIG. 17, Operation 3: The LMF may request an UL-SRS configuration from the serving NG-RAN node of the target device and may configure TRPs for UL-SRS measurements. NOTE: The procedures and transactions for Operations 1-3 may be serialized in any preferred order. For example, the LMF may first jointly obtain the SLPP and LPP capabilities, then jointly request SLPP and LPP location results, etc.

FIG. 17, Operation 4: The target device performs the sidelink positioning procedures as described in FIG. 13.

FIG. 17, Operation 5: The target device provides the SLPP location results to the LMF.

FIG. 17, Operation 6: The target device provides the LPP location results to the LMF.

FIG. 17, Operation 7: The TRPs provide the NRPPa location results to the LMF.

In an aspect, the process 1700 of FIG. 17 procedure may support hybrid/joint Uu (including RAT-Independent methods) and sidelink positioning in the same way as it is supported today with LPP (and possibly NRPPa). For example, several LPP positioning methods can be used for the same positioning session. The LMF knows that the different positioning methods apply to the same positioning session. The UE does not know that unless the same LPP messages and transactions are used for the different positioning methods. When different LPP transactions and messages are used, the UE may not know if the different positioning methods refer to the same LPP session or to different LPP sessions. When both Uu and PC5 based procedures and signaling are used, then from the perspective of the coordinating entity (LMF in this case), the Uu and PC5 based positioning procedures are part of the same positioning session. This methodology allows SLPP, LPP and NRPPa to be defined and used independently even though a coordinating entity, such as an LMF, can be aware of a common positioning session. In particular, this means that SLPP signaling does not need to convey LPP session-related information and similarly, LPP signaling does not need to convey SLPP session-related information. This can significantly reduce SLPP and LPP impacts, standardization impacts, and requirements levied on the UE and the network.

Referring to FIG. 17, in an aspect, hybrid Uu, SL, and RAT-independent positioning may be supported by jointly using the SLPP, LPP, and NRPPa procedures.

Referring to FIG. 17, in an aspect, using SLPP transactions/procedures independently of LPP also means there are no additional impacts to those UEs (and LMFs) that do not need to support sidelink positioning and vice versa. For example, if an LMF or UE were to receive an LPP message with sidelink positioning content, then even if this content is not supported, the decoding of the LPP message might need to be “sidelink capable”. Similarly, if a sidelink positioning or ranging device (or LMF) does not need to support LPP positioning, there would be no need to support LPP just for the sidelink positioning or ranging content. This allows a smaller protocol to be defined to reduce a memory footprint size for an Abstract Syntax Notation One (ASN.1) definition of the protocol and associated processing support. That could simplify UE implementation when LPP does not otherwise need to be supported.

Referring to FIG. 17, in an aspect, using the LMF as an SLPP endpoint would not only allow embedding SLPP messages into Supplementary Services Operations (e.g., MT-LR, MO-LR, etc.), but would also enable joint sidelink and Uu positioning with minimal changes to existing protocols.

Referring to FIG. 17, in an aspect, using the LMF as an SLPP endpoint would allow sidelink-only positioning (with LMF support) without a requirement for LPP support, which would reduce complexity for sidelink-only capable positioning and ranging devices and LMFs.

Referring to FIG. 17, in an aspect, specifying the sidelink positioning functionality isolated within SLPP would require no modifications to LPP, and therefore, would not increase the LPP ASN.1 footprint for non-sidelink capable UEs and LMFs.

Referring to FIG. 17, in an aspect, the LMF may be a protocol endpoint for SLPP.

In an aspect, a SLPP message may be sent via broadcast, groupcast or unicast, depending on the specific scenario. SLPP may indicate the transaction (communication) mode to be used for each SLPP message, i.e., whether broadcast mode, groupcast mode or unicast mode is to be used (e.g., in a common SLPP message header). SLPP may support at least the following generic transaction modes:
Unicast transaction
Group Transaction with Group Replies
Group Transaction with Unicast Replies
Broadcast Transaction

The exact API between the SLPP layer and Transport layer may be implementation dependent.

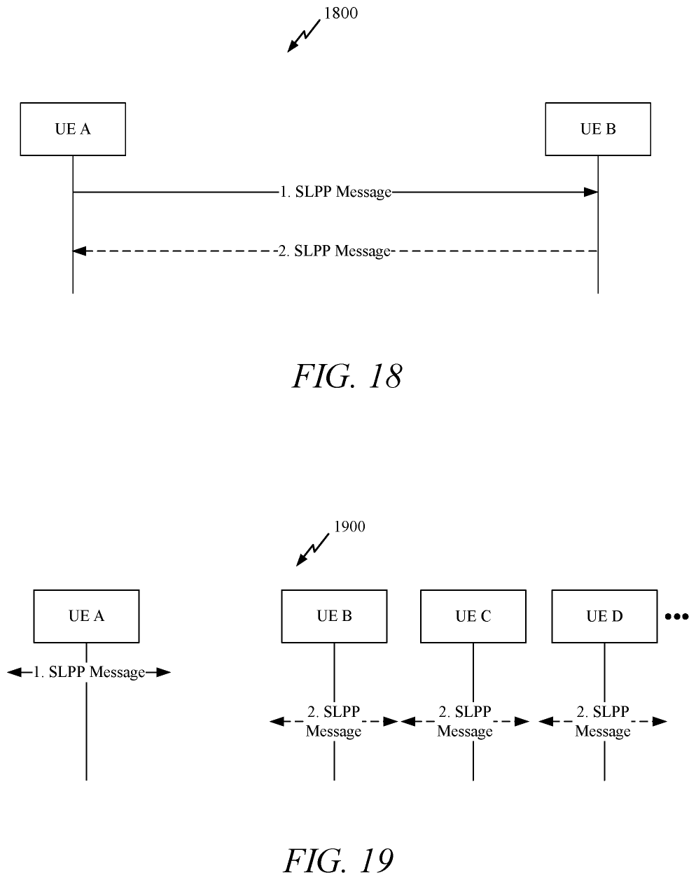

FIG. 18 illustrates a SLPP Unicast Transaction 1800, in accordance with aspects of the disclosure. FIG. 18 includes operations 1 through 2, which are summarized as follows:

FIG. 18, Operation 1: UE A sends a SLPP message to UE B. The message includes the SLPP Mode set to ‘unicast’. The message includes the SLPP Session ID if applicable, a Transaction ID, and the source and destination UE IDs (e.g., Application Layer IDs, Layer 2 IDs, SLPP UE IDs.

FIG. 18, Operation 2: If the SLPP message from Operation 1 requires a response, UE B sends a SLPP message to UE A with the SLPP Mode set to ‘unicast’, the Transaction ID and the destination ID for UE A as received in Operation 1.

FIG. 19 illustrates a SLPP Group Transaction 1900 with Group Replies, in accordance with aspects of the disclosure. FIG. 19 includes operations 1 through 2, which are summarized as follows:

FIG. 19, Operation 1: UE A sends a SLPP message to a group of one or more UEs (UE B, C, D, etc.). The message includes the SLPP Mode set to ‘groupcast-group reply’ indicating that the destination UEs may respond via groupcast, or set to ‘groupcast’ in the case the SLPP message does not require a response. The message includes the SLPP Session ID, if applicable, a Transaction ID, and the Group ID (e.g., application layer group ID, layer-2 group ID, or SLPP Group ID).

FIG. 19, Operation 2: If the SLPP message from Operation 1 received by destination UEs B, C, D, etc. requires a response (SLPP Mode was set to ‘group cast-group reply’), UEs B, C, D, etc. send a SLPP message with the SLPP Mode set to ‘groupcast’ (which are thus also returned to the other UEs in the group). The message includes the Session ID if applicable, the Transaction ID and the Group ID received at Operation 1.

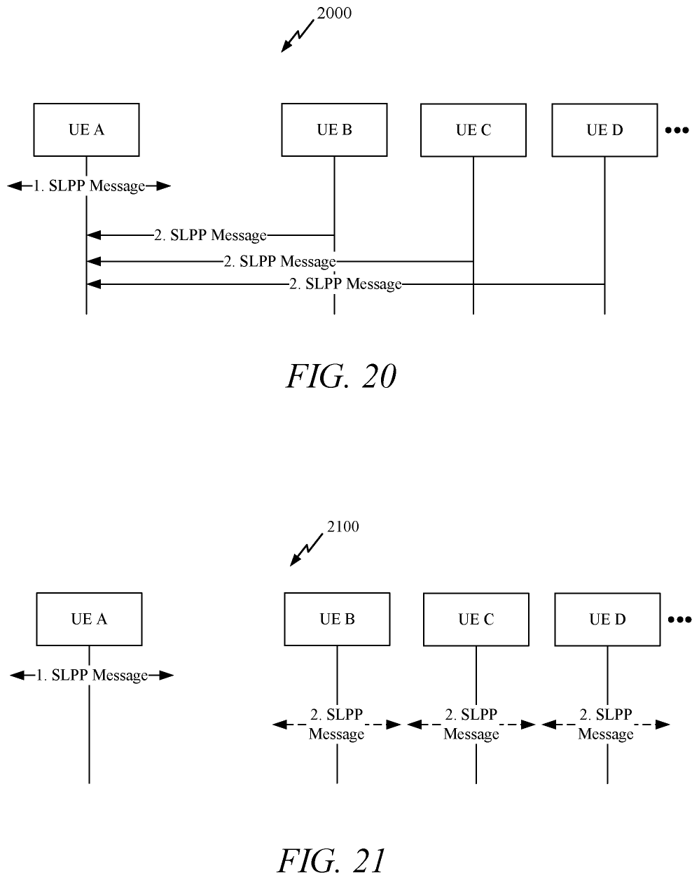

FIG. 20 illustrates a SLPP Group Transaction 2000 with Unicast Replies, in accordance with aspects of the disclosure. FIG. 20 includes operations 1 through 2, which are summarized as follows:

FIG. 20, Operation 1: UE A sends a SLPP message to a group of one or more UEs (UE B, C, D, etc.). The message includes the SLPP Mode set to ‘groupcast—unicast reply’ indicating that the destination UEs may respond via unicast. If no response is requested, the SLPP mode may indicate ‘groupcast’. The message includes the SLPP Session ID, if applicable, a Transaction ID and the Group ID (e.g., application layer group ID, layer-2 group ID, or SLPP Group ID).

FIG. 20, Operation 2: If the SLPP message from Operation 1 received by destination UEs B, C, D, etc. requires a response, UEs B, C, D, etc. each send a SLPP message with the SLPP Mode set to ‘unicast’. The message includes the Session ID if applicable, the Transaction ID and source UE ID of the individual UE, and the destination ID for UE A received at Operation 1.

FIG. 21 illustrates a SLPP Broadcast Transaction 2100, in accordance with aspects of the disclosure. FIG. 21 includes operations 1 through 2, which are summarized as follows:

FIG. 21, Operation 1: UE A sends a SLPP message with the SLPP Mode set to ‘broadcast’. The message includes the SLPP Session ID if applicable and a Transaction ID.

FIG. 21, Operation 2: If the SLPP message from Operation 1 received by UEs B, C, D, etc. requires a response, UEs B, C, D, etc. send a SLPP message with the SLPP Mode set to ‘broadcast’. The message includes SLPP Session ID if received at Operation 1 and the Transaction ID.

Referring to FIG. 21, in an aspect, SLPP may indicate the transaction (communication) mode to be used for each SLPP message, i.e. whether broadcast mode, groupcast mode or unicast mode is to be used (e.g., in a common SLPP message header). At least the following common transaction modes may be supported:
Unicast transaction
Group Transaction with Group Replies
Group Transaction with Unicast Replies
Broadcast Transaction.

It is noted that not all SLPP message types may be allowed for all transaction modes.

In an aspect regarding SLPP functionality, in order to enable sidelink positioning, SLPP/RSPP may support at least the following functionalities:
1. SL Positioning Capability Transfer
2. SL Positioning Assistance Data exchange
3. SL Location Information Transfer
4. Error handling
5. Abort

Capabilities in an SLPP context may refer to the ability to support different position methods defined for SLPP (e.g., SL-RTT, SL-TDOA, etc.), different aspects of a particular position method (e.g. different types of measurements or assistance data) and features specific to certain UE roles (e.g. ability to operate as a server or anchor UE, etc.).

The exchange of capabilities between different endpoints may be initiated by a request or sent as unsolicited information. If a request is used, an endpoint sends an SLPP Request Capabilities message using one of the allowed transaction modes with a request for capability information. The addressed endpoint(s) then respond with an SLPP Provide Capabilities message.

It is noted that an endpoint may comprise one or more UEs or an LMF.

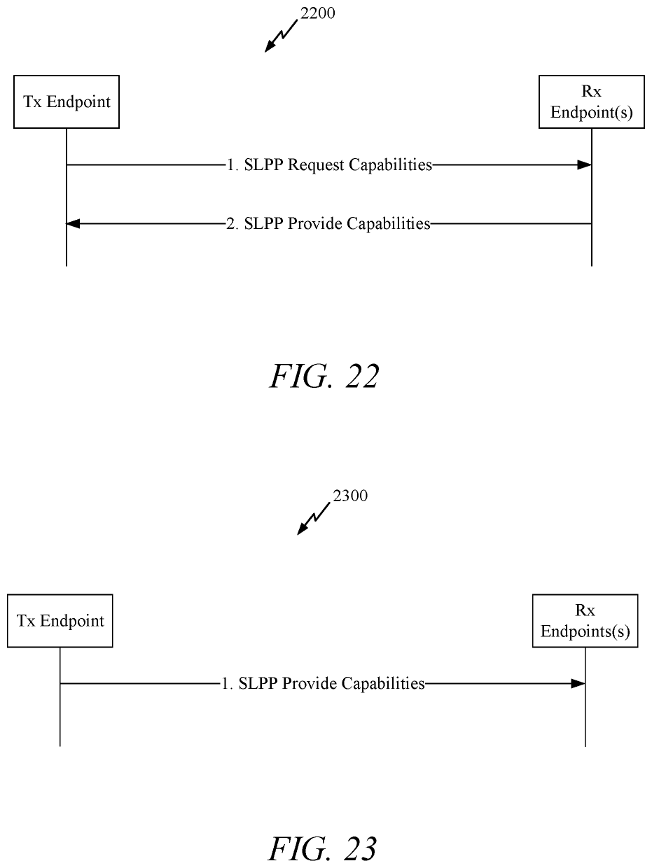

FIG. 22 illustrates a SLPP Capability Transfer Procedure 2200, in accordance with aspects of the disclosure. FIG. 22 includes operations 1 through 2, which are summarized as follows:

FIG. 22, Operation 1: The transmitting endpoint may send a request for the SLPP related capabilities to one or more receiving endpoints using one of the SLPP Transaction Modes described above.

FIG. 22, Operation 2: The receiving endpoint(s) transfer their SLPP-related capabilities to the transmitting endpoint using one of the SLPP Transaction Modes described above. The capabilities may refer to particular position methods or may be common to multiple position methods.

Referring to FIG. 22, in an aspect, the SLPP Capability Indication procedure is used for unsolicited capability transfer.

FIG. 23 illustrates a SLPP Capability Indication Procedure 2300, in accordance with aspects of the disclosure. FIG. 23 includes operation 1, which is summarized as follows:

FIG. 23, Operation 1: The transmitting endpoint provides the SLPP-related capabilities to one or more receiving endpoints using one of the SLPP Transaction Modes described above.

Referring to FIG. 23, in an aspect, the SLPP-related capabilities may include the general information summarized in Table 1 below:

TABLE 1
SLPP-related capabilities
Information
SL Positioning Capability:
Supported position methods and measurements per
method (e.g., SL-RTT, SL-AoA, SL-TDOA)
Supported SL-PRS details
Supported position calculation capability
UE-based: UE can calculate its own position
using its own and other UEs measurements
UE-assisted: UE can only perform measurements;
requires a separate server (UE or LMF) for
position calculation
Anchor capability (yes/no):
Location coordinates of UE (if available)
NOTE: Anchor UE location could also be
obtained/updated via Location Information Transfer
procedures.
Stationary/non-stationary indication and/or velocity
Timing/synchronization capability (e.g., for TDOA
methods); e.g., GNSS-DFN accuracy.
Location Server capability (yes/no):
Position calculation functionality for other UEs
Supported methods: e.g., RTT, AoA, TDOA
Assistance Data generation/distribution functionality
Supported assistance data types (TBD)
May also indicate whether the UE can act as a
server-UE with the help of an LMF

Referring to FIG. 23, in an aspect, SLPP Provide Capabilities message may provide information on the ability of the device to support different position methods defined for SLPP (e.g., SL-RTT, SL-TDOA, etc.), different aspects of a particular position method (e.g. different types of measurements or assistance data) and features specific to certain UE roles (e.g. ability to operate as a server or anchor UE, etc.).

Assistance data may include the SL-PRS configuration information and may be transferred either by request or unsolicited. If a request is used, an endpoint sends an SLPP Request Assistance Data message to a server (e.g., server UE or LMF (via MO-LR)) for SL-PRS assistance data and may indicate the assistance data needed. The addressed endpoint then responds with an SLPP Provide Assistance Data message.

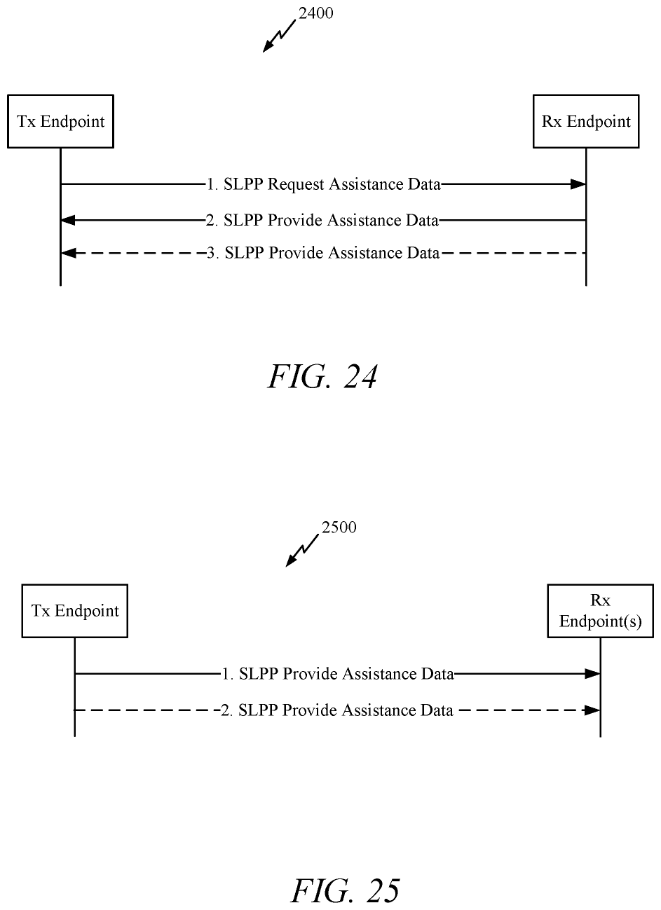

FIG. 24 illustrates a SLPP Assistance Data Transfer Procedure 2400, in accordance with aspects of the disclosure. FIG. 24 includes operations 1 through 3, which are summarized as follows:

FIG. 24, Operation 1: The transmitting endpoint may send a request for assistance data to a receiving endpoint (e.g., server UE or LMF) using one of the SLPP Transaction Modes described above. The message may indicate the particular assistance data needed.

FIG. 24, Operation 2: The receiving endpoint transfers assistance data to the transmitting endpoint using one of the SLPP Transaction Modes described above. The transferred assistance data may match any assistance data requested in operation 1.

FIG. 24, Operation 3: The receiving endpoint may transfer additional assistance data to the transmitting endpoint in one or more additional SLPP Provide Assistance Data messages.

Referring to FIG. 24, in an aspect, SLPP Assistance Data Delivery procedure is used for unsolicited assistance data transfer.

FIG. 25 illustrates a SLPP Assistance Data Delivery Procedure 2500, in accordance with aspects of the disclosure. FIG. 25 includes operations 1 through 2, which are summarized as follows:

FIG. 25, Operation 1: The transmitting endpoint transfers assistance data to one or more receiving endpoint(s) using one of the SLPP Transaction Modes described above.

FIG. 25, Operation 2: The transmitting endpoint may transfer additional assistance data to the receiving UE(s) in one or more additional SLPP Provide Assistance Data messages.

Referring to FIG. 25, in an aspect, the assistance data may comprise the general information summarized in Table 2:

TABLE 2
SLPP-related assistance
Information
SL-PRS Configuration Information for participant UEs in a
session.
Start time and duration for SL-PRS (if the Provide
Assistance Data is used to trigger the SL-PRS transmission
at the receiver).

Referring to FIG. 25, in an aspect, the SLPP Request Assistance Data message may allow an SLPP-capable endpoint to request positioning assistance data (e.g., SL-PRS configuration information and resources) from a server (e.g., server UE or LMF). The SLPP Provide Assistance Data message may allow a server (e.g., server UE or LMF) to provide positioning assistance data (e.g., SL-PRS configuration information and resources) to participant UEs in a session.

The term “location information” applies to both, an actual position estimate and to values used in computing position (SL positioning measurements). It can be delivered either in response to a request or unsolicited.

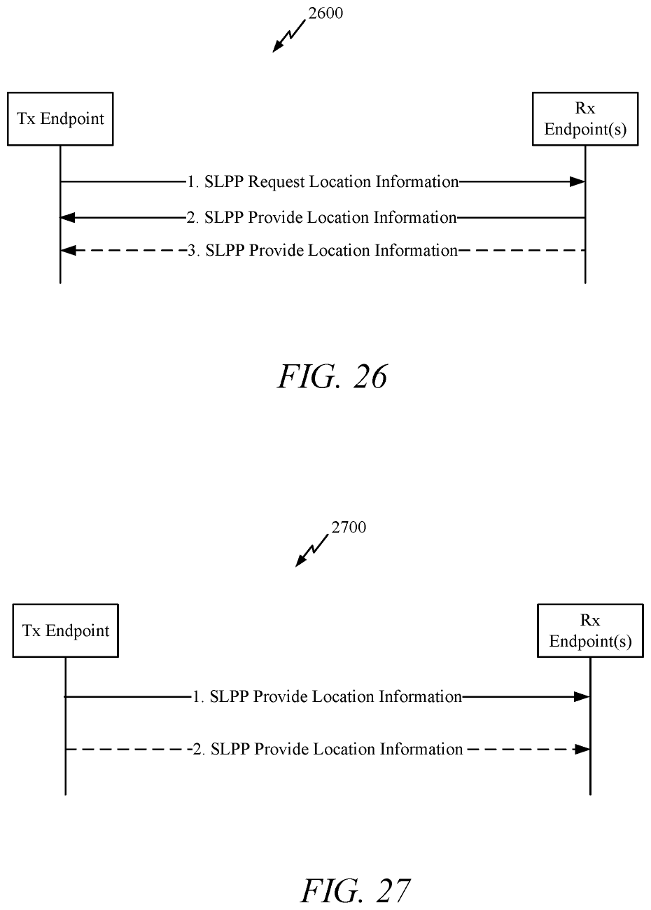

FIG. 26 illustrates a SLPP Location Information Transfer Procedure 2600, in accordance with aspects of the disclosure. FIG. 26 includes operations 1 through 3, which are summarized as follows:

FIG. 26, Operation 1: The transmitting endpoint may send a request for location information to one or more receiving endpoints using one of the SLPP Transaction Modes described above. The message indicates the type of location information needed and associated QoS.

FIG. 26, Operation 2: In response to operation 1, the receiving endpoint(s) transfer location information to the transmitting endpoint using one of the SLPP Transaction Modes described above. The location information transferred may match the location information requested in operation 1.

FIG. 26, Operation 3: The receiving endpoint(s) may transfer additional location information to the transmitting endpoint in one or more additional SLPP Provide Location Information messages using one of the SLPP Transaction Modes described above.

Referring to FIG. 26, in an aspect, the SLPP Location Information Delivery procedure is used for unsolicited location information transfer.

FIG. 27 illustrates a SLPP Location Information Delivery Procedure 2700, in accordance with aspects of the disclosure. FIG. 27 includes operations 1 through 2, which are summarized as follows:

FIG. 27, Operation 1: The transmitting endpoint transfers location information to one or more receiving endpoints using one of the SLPP Transaction Modes described above.

FIG. 27, Operation 2: The transmitting endpoint may transfer additional location information to one or more receiving endpoints using one of the SLPP Transaction Modes described above.

Table 3 depicts the information contained in the signaling for FIG. 27:

TABLE 3
SLPP-related location information
Information
SLPP Request Location Information:
Requested location measurements (e.g., RxTx, AoA,
RSTD, etc.) (UE-assisted)
Request for location coordinates and velocity (UE-
based)
Requested positioning QOS (e.g., accuracy, response
time)
Indication whether calculated location estimate is
requested (centralized mode) or whether each UE is
requested to calculate its own location (distributed
mode).
Optional Trigger Indication for SL-PRS transmission
and measurement
SLPP Provide Location Information:
Location measurements
Location coordinates and velocity

Referring to FIG. 27, in an aspect, the SLPP Request/Provide Location Information message may allow an SLPP-capable endpoint to request/provide location measurements or location estimate from participant UEs in a session.

SLPP-capable UEs can initiate a Sidelink Ranging and Positioning session to other SLPP-capable UEs. The initiation of an SLPP session by an SLPP-capable UE can be done in an unsolicited manner based on an application-layer request for sidelink positioning and ranging results from one or more SLPP-capable UEs.

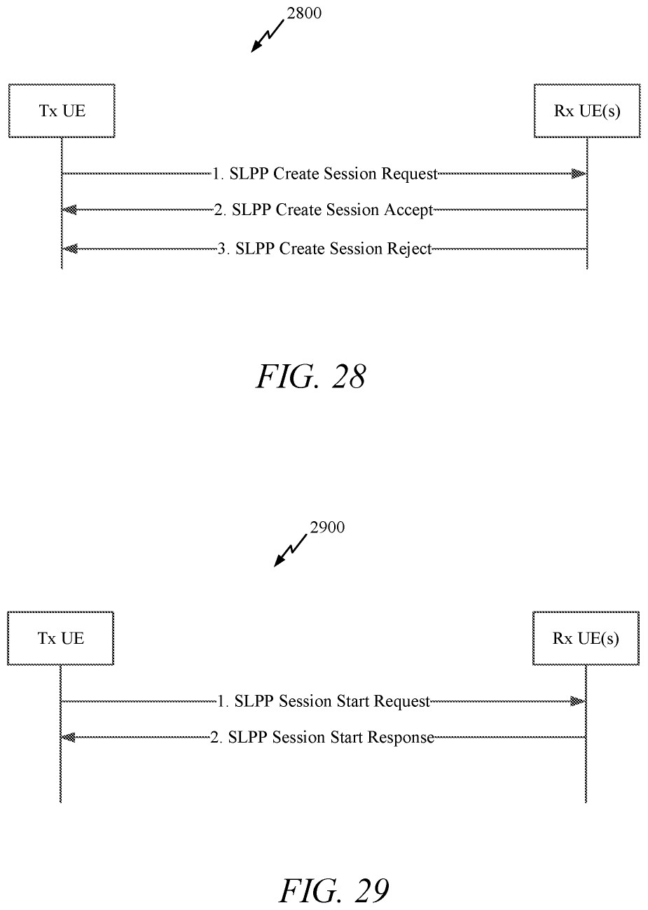

FIG. 28 illustrates a SLPP Create Session Request/Accept/Reject procedure 2800, in accordance with aspects of the disclosure. FIG. 28 includes operations 1 through 3, which are summarized as follows:

FIG. 28, Operation 1: The transmitting UE may send a request to create a Sidelink Ranging and Positioning session to one or more receiving UEs. The SLPP Create Session Request message may be sent by the transmitting UE using one of the SLPP Transaction Modes described above.

FIG. 28, Operation 2: Receiving UE(s) electing to participate in the Sidelink Ranging and Positioning session proposed by the transmitting UE respond to the transmitting UE with an SLPP Create Session Accept message. The SLPP Create Session Accept message may be sent by the transmitting UE using one of the SLPP Transaction Modes described above.

FIG. 28, Operation 3: Receiving UE(s) electing not to participate in the Sidelink Ranging and Positioning session proposed by the transmitting UE respond to the transmitting UE with an SLPP Create Session Reject message. The SLPP Create Session Reject message may be sent by the transmitting UE using one of the SLPP Transaction Modes described above.

Referring to FIG. 28, the SLPP Create Session Request/Accept/Reject messages may include the general information summarized in Table 4 below:

TABLE 4
SLPP Create Session Request/Response
Information
SLPP Create Session Request:
SLPP session ID (assigned by transmitting entity)
Layer 2 Group ID
SLPP Create Session Accept:
SLPP session ID (assigned by transmitting entity)
Layer 2 Group ID
Application Layer ID for each participating
receiving UE
Layer-2 ID for each participating receiving UE
SLPP Create Session Reject:
SLPP session ID (assigned by transmitting entity)
Layer 2 Group ID

Referring to FIG. 28, in an aspect, the SLPP Create Session Request message may allow an SLPP UE to request creation of a sidelink ranging and positioning session and provide information on the sidelink ranging and positioning session proposed, including SLPP and Layer-2 IDs. In an aspect, the SLPP Create Session Accept message may allow an SLPP UE to accept an SLPP session proposed by an SLPP-capable UE. In an aspect, the SLPP Create Session Reject message may allow an SLPP UE to reject an SLPP session proposed by an SLPP-capable UE.

An SLPP-capable UE that has created a Sidelink Ranging and Positioning session to other SLPP-capable UEs (an SLPP session) can start that SLPP session for the SLPP-capable UEs that have accepted the proposed SLPP session request.

FIG. 29 illustrates a SLPP Session Start Request/Response procedure 2900, in accordance with aspects of the disclosure. FIG. 29 includes operations 1 through 2, which are summarized as follows:

FIG. 29, Operation 1: The transmitting UE may start an SLPP session to one or more receiving UEs using SLPP Session Start Request message. The SLPP Session Start Request message may be sent by the transmitting UE using one of the SLPP Transaction Modes described above.

FIG. 29, Operation 2: Receiving UE(s) respond to the transmitting UE with an SLPP Session Start Response message. The SLPP Session Start Response message may be sent by the transmitting UE using one of the SLPP Transaction Modes described above.

Referring to FIG. 29, the SLPP Session Start Request/Response messages may include the general information summarized in Table 5 below:

TABLE 5
SLPP Session Start Request/Response
Information
SLPP Session Start Request:
SLPP session ID
Layer 2 Group ID
Application Layer ID for each participating
receiving UE
Layer-2 ID for each participating receiving UE
SLPP ID for each participating receiving UE
SLPP Session Start Response:
SLPP session ID
Layer 2 Group ID
Application Layer ID for responding receiving UE
Layer-2 ID for responding receiving UE
SLPP ID for responding receiving UE

Referring to FIG. 29, in an aspect, the SLPP Session Start Request message may allow an SLPP UE to request the start of a sidelink ranging and positioning session proposed using the SLPP Create Session Request/Response messages and provide information on the session participating SLPP UEs. In an aspect, the SLPP Session Start Response message may allow an SLPP UE to acknowledge the start of an SLPP session.

An SLPP-capable UE that has created and started a Sidelink Ranging and Positioning session to other SLPP-capable UEs (an SLPP session) can modify that SLPP session for the SLPP-capable UEs that have accepted the proposed SLPP session.

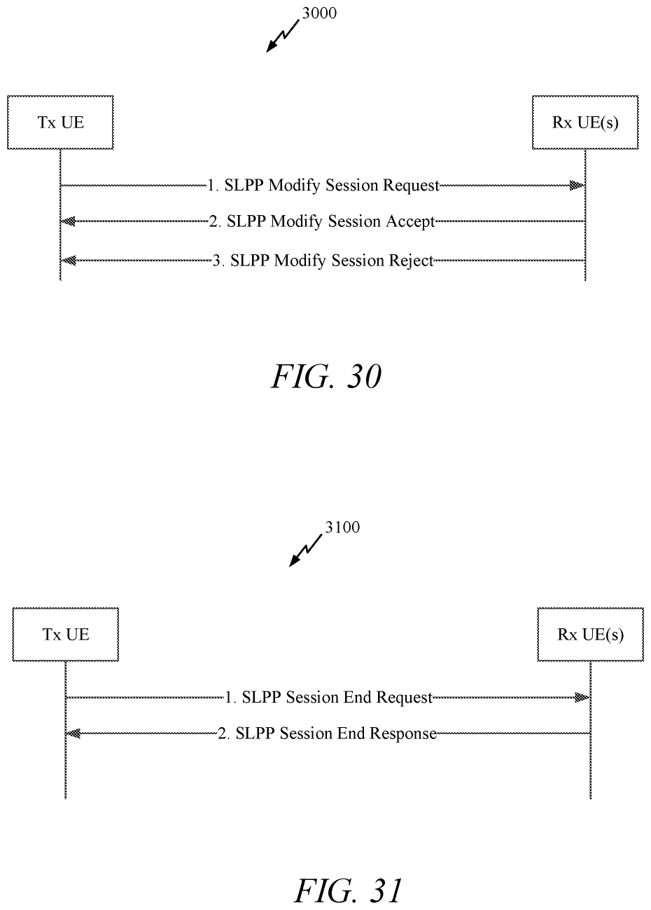

FIG. 30 illustrates a SLPP Modify Session Request/Response procedure 3000, in accordance with aspects of the disclosure. FIG. 30 includes operations 1 through 3, which are summarized as follows:

FIG. 30, Operation 1: The transmitting UE may send a request to modify a Sidelink Ranging and Positioning session (an SLPP session) for the SLPP UEs participating in the SLPP session. The SLPP Modify Session Request message may be sent by the transmitting UE using one of the SLPP Transaction Modes described above.

FIG. 30, Operation 2: Receiving UE(s) participating in the SLPP session electing to accept the proposed session modification respond to the transmitting UE with an SLPP Modify Session Accept message. The SLPP Modify Session Accept message may be sent by the transmitting UE using one of the SLPP Transaction Modes described above.

FIG. 30, Operation 3: Receiving UE(s) participating in the SLPP session electing not to participate in the Sidelink Ranging and Positioning session proposed by the transmitting UE respond to the transmitting UE with an SLPP Modify Session Reject message. The SLPP Modify Session Reject message may be sent by the transmitting UE using one of the SLPP Transaction Modes described above.

Referring to FIG. 30, the SLPP Modify Session Request/Accept/Reject messages may include the general information summarized in Table 6 below:

TABLE 6
SLPP Create Session Request/Response
Information
SLPP Modify Session Request:
Active SLPP session ID
Active Layer 2 Group ID
New SLPP session ID
New Layer 2 Group ID
Active Participants
SLPP ID
Added Participants
Application Layer ID
SLPP ID
SLPP Modify Session Accept:
SLPP session ID
Layer 2 Group ID
Application Layer ID for each participating
receiving UE
Layer-2 ID for each participating receiving UE
SLPP Modify Session Reject:
SLPP session ID
Layer 2 Group ID

Referring to FIG. 30, in an aspect, the SLPP Modify Session Request message may allow an SLPP UE to request modification of an existing SLPP session and provide information on the modified SLPP session proposed and session participating SLPP UEs, including SLPP and Layer-2 IDs. In an aspect, the SLPP Modify Session Accept message may allow an SLPP UE to accept an SLPP session modification proposed by an SLPP-capable UE. In an aspect, the SLPP Modify Session Reject message may allow an SLPP UE to reject an SLPP session modification proposed by an SLPP-capable UE.

An SLPP-capable UE that has created a Sidelink Ranging and Positioning session to other SLPP-capable UEs (an SLPP session) can end that SLPP session for the SLPP-capable UEs participating in the SLPP session.

FIG. 31 illustrates a SLPP Session End Request/Response procedure 3100, in accordance with aspects of the disclosure. FIG. 31 includes operations 1 through 2, which are summarized as follows:

FIG. 31, Operation 1: The transmitting UE may end a Sidelink Ranging and Positioning session (an SLPP session) for the SLPP UEs participating in the SLPP session by sending a SLPP Session End Request message. The SLPP Session End Request messages may be sent by the transmitting UE using one of the SLPP Transaction Modes described above.

FIG. 31, Operation 2: Receiving UE(s) respond to the transmitting UE with an SLPP Session End Response message. The SLPP Session End Response message may be sent by the transmitting UE using one of the SLPP Transaction Modes described above. The receiving UE(s) delete the SLPP Session ID and SLPP ID when the session is terminated.

Referring to FIG. 31, the SLPP Session End Request/Response messages may include the general information summarized in Table 7 below.

TABLE 7
SLPP Session Start Request/Response
Information
SLPP Session End Request:
SLPP session ID
Layer 2 Group ID
SLPP Session End Response:
SLPP session ID
Layer 2 Group ID
SLPP ID for responding receiving UE

Referring to FIG. 31, in an aspect, the SLPP Session End Request message may allow an SLPP UE to request the termination of a sidelink ranging and positioning session. In an aspect, the SLPP Session End Response message may allow an SLPP UE to acknowledge the termination of an SLPP session.

In an aspect regarding discovery for sidelink positioning, a discovery procedure is included in the sidelink positioning procedure at least for out of coverage scenario. In an aspect, discovery messages may be used to carry information for targeted discovery and candidate selection of SL positioning UEs, including at least the indication of anchor UE, target UE. and server UE roles. Various information may be indicated about anchor UEs (e.g., knowledge of location). In an aspect, the UE role information is indicated in the discovery SLPP meta-field. In an aspect, this may apply to both discovery modes and which messages.

Regarding sidelink positioning discovery for in-coverage and partial coverage scenarios, sidelink ranging and positioning procedures may be implemented for SL-MT-LR and SL-MO-LR. These procedures (SL-MT-LR, SL-MO-LR) delineate operations for an LCS client and a UE, respectively to obtain sidelink Positioning/Ranging results over PC5 for a group of n UEs (n≥2). For both SL-MT-LR and SL-MO-LR procedures, UEs perform discovery over PC5. In an aspect, discovery is included in the sidelink positioning procedure for all PC5 sidelink positioning scenarios (e.g. in-coverage, out-of-coverage, partial coverage).

Structuring SLPP ASN.1 in a manner similar to LPP enables reuse of the existing LPP design and facilitates commonality between the two designs. Specifically, an SLPP message may include common header information (e.g., session ID, UE IDs, transaction IDs, etc.) and a message body realizing the individual SLPP transaction types (capability transfer, assistance data transfer, location information transfer, etc.). In an aspect, a SLPP message contains a common header (including e.g., session ID, UE IDs, transaction IDs, etc.) and a message body realizing the individual SLPP transaction types (capability transfer, assistance data transfer, location information transfer, etc.). In LPP, each message body Information Element (IE) is a SEQUENCE of individual IEs, applicable to all or individual positioning methods. For example, the LPP RequestCapabilities message body contains relevant IEs for each LPP positioning method (similar for all other LPP message body IEs) using the following ASN.1 definition:

| RequestCapabilities-r9-IEs ::= SEQUENCE { | |
|---|---|
| commonIEsRequestCapabilities | CommonIEsRequestCapabilities |

| | |
|---|---|
| OPTIONAL, | -- Need ON |

| | |
|---|---|
| a-gnss-RequestCapabilities | A-GNSS-RequestCapabilities |

| | |
|---|---|
| OPTIONAL, | -- Need ON |

| | |
|---|---|
| otdoa-RequestCapabilities | OTDOA-RequestCapabilities |

| | |
|---|---|
| OPTIONAL, | -- Need ON |

| | |
|---|---|
| ecid-RequestCapabilities | ECID-RequestCapabilities |

| | |
|---|---|
| OPTIONAL, | -- Need ON |

| | |
|---|---|
| epdu-RequestCapabilities | EPDU-Sequence |

| OPTIONAL, | -- Need ON |
|---|---|
| ..., | |
| [[ sensor-RequestCapabilities-r13 Sensor-RequestCapabilities-r13 | |
| OPTIONAL, | -- Need ON |

| | |
|---|---|
| tbs-RequestCapabilities-r13 | TBS-RequestCapabilities-r13 |

| | |
|---|---|
| OPTIONAL, | -- Need ON |

| | |
|---|---|
| wlan-RequestCapabilities-r13 | WLAN-RequestCapabilities-r13 |

| | |
|---|---|
| OPTIONAL, | -- Need ON |

| | |
|---|---|
| bt-RequestCapabilities-r13 | BT-RequestCapabilities-r13 |

| OPTIONAL | -- Need ON |
|---|---|
| ]], | |
| [[ nr-ECID-RequestCapabilities-r16 NR-ECID-RequestCapabilities-r16 | |
| OPTIONAL, | -- Need ON |

nr-Multi-RTT-RequestCapabilities-r16

NR-Multi-RTT-RequestCapabilities-r16

| | |
|---|---|
| OPTIONAL, | -- Need ON |

nr-DL-AoD-RequestCapabilities-r16

NR-DL-AoD-RequestCapabilities-r16

| | |
|---|---|
| OPTIONAL, | -- Need ON |

nr-DL-TDOA-RequestCapabilities-r16

NR-DL-TDOA-RequestCapabilities-r16

| OPTIONAL, | -- Need ON |
|---|---|
| nr-UL-RequestCapabilities-r16 NR-UL-RequestCapabilities-r16 | |
| OPTIONAL | -- Need ON |

]]
}
-- ASN1STOP

An implementation using this approach would have to compile the entire LPP ASN.1 even in the case of just a single positioning method supported. This is because each field in the SEQUENCE has an explicit ASN.1 definition (e.g., IEs CommonIEsRequestCapabilities, A-GNSS-RequestCapabilities, etc.). Therefore, the footprint size of the actual LPP encoder/decoder is the same, regardless of which/how many positioning methods are supported by a device. This can be a potential problem and cost impediment for low-cost devices having limited memory to support only a small subset of positioning methods they require. This issue was already discussed during Rel-14 when NB-IoT support was added to LPP.

Assuming SLPP may also evolve/increase in future Releases, the SLPP ASN.1 design may allow for “selective ASN. 1 compilation”, where an implementation needs to compile the ASN.1 for only the SLPP functionality supported. This could be achieved by grouping the “SLPP functionality” into separate, standalone modules. Using LPP as an example, each SLPP module/group could be an individual positioning method. Instead of using an explicit ASN.1 definition for each message body IE, it could be defined as just an OCTET STRING. For example, the RequestCapabilities-r9-IEs above could be defined in ASN.1 as follows:

RequestCapabilities-r9-IEs ::= SEQUENCE {

| | |
|---|---|
| commonIEsRequestCapabilities | OCTET STRING OPTIONAL, -- |

CommonIEsRequestCapabilities

| | |
|---|---|
| a-gnss-RequestCapabilities | OCTET STRING OPTIONAL, -- A-GNSS- |

RequestCapabilities

| | |
|---|---|
| otdoa-RequestCapabilities | OCTET STRING OPTIONAL, -- OTDOA- |

RequestCapabilities

| | |
|---|---|
| ecid-RequestCapabilities | OCTET STRING OPTIONAL, -- ECID- |

RequestCapabilities

| | |
|---|---|
| epdu-RequestCapabilities | OCTET STRING OPTIONAL, -- EPDU- |

```
Sequence
  ...,
  [[  sensor-RequestCapabilities-r13 OCTET STRING OPTIONAL, -- Sensor-
RequestCapabilities
```

| | |
|---|---|
| tbs-RequestCapabilities-r13 | OCTET STRING OPTIONAL, -- TBS- |

RequestCapabilities

| | |
|---|---|
| wlan-RequestCapabilities-r13 | OCTET STRING OPTIONAL, -- WLAN- |

RequestCapabilities

| | |
|---|---|
| bt-RequestCapabilities-r13 | OCTET STRING OPTIONAL -- BT- |

RequestCapabilities
]],

| | |
|---|---|
| [[ nr-ECID-RequestCapabilities-r16 | OCTET STRING OPTIONAL, -- NR- |

ECID-RequestCapabilities

| | |
|---|---|
| nr-Multi-RTT-RequestCapabilities-r16 | OCTET STRING OPTIONAL, -- NR-Multi- |

RTT-RequestCapabilities
nr-DL-AoD-RequestCapabilities-r16

OCTET STRING OPTIONAL, -- NR-DL-AoD-

RequestCapabilities
nr-DL-TDOA-RequestCapabilities-r16

OCTET STRING OPTIONAL, -- NR-DL-

```
TDOA-RequestCapabilities
    nr-UL-RequestCapabilities-r16 OCTET STRING OPTIONAL -- NR-UL-
RequestCapabilities
  ]]
}
-- ASN1STOP
```

In an aspect, the positioning method IEs would be defined in separate ASN.1 PDUs which are imported by the main SLPP PDU. In this way, any (sub) PDU containing an unsupported positioning method or functionality can be excluded from the protocol and would not need to be compiled. Therefore, the message encoder/decoder footprint size is reduced, since it does not contain the entire SLPP. Any unsupported received IE/message would still be correctly decoded (as an OCTET STRING), and then ignored, as is the case for an explicit ASN.1 definition. But in the above example, the content of a not supported OCTET STRING does not need to be decoded individually.

An example structure using LPP as baseline is provided below. Note, this does not imply that SLPP must be structured like LPP as shown. It is only used as baseline to illustrate the proposal. In an aspect, the SLPP design may allow support for individual SL positioning methods in a forward compatible manner to allow additional positioning methods to be added in future Releases (e.g., similar to LPP). In an aspect, the SLPP ASN.1 design may allow for “selective ASN.1 compilation”. The overall SLPP functionality is divided into “groups”, where each group is defined as a separate ASN.1 module. A “group” may correspond to a positioning method, but other grouping may also be possible. An implementation needs to compile only the SLPP modules which contain a supported “group” (functionality, positioning method, etc.).

Example SLPP PDU ASN.1 structures for SLPP-PDU-Definitions are as follows:

```
-  SLPP-PDU-Definitions
-- ASN1START
SLPP-PDU-Definitions
DEFINITIONS AUTOMATIC TAGS ::=
BEGIN
-- ASN1STOP
-  Imports
    NOTE: An implementation needs to include only the supported “Method” PDUs. Not
          supported methods do not need to be included, and therefore, do not
          contribute to the protocol size. For example, if “Method-A” is not supported
          by an implementation, the SLPP-PDU-Method-A-Contents PDU does not
          need to be included in the protocol.
-- ASN1START
IMPORTS
  CommonIEsRequestCapabilities,
  CommonIEsProvideCapabilities,
  CommonIEsRequestAssistanceData,
  CommonIEsProvideAssistanceData,
  CommonIEsRequestLocationInformation,
  CommonIEsProvideLocationInformation
FROM
  SLPP-PDU-Common-Contents
  Method-A-RequestCapabilities,
  Method-A-ProvideCapabilities,
  Method-A-RequestAssistanceData,
  Method-A-ProvideAssistanceData,
  Method-A-RequestLocationInformation,
  Method-A-ProvideLocationInformation
FROM
  SLPP-PDU-Method-A-Contents
  Method-B-RequestCapabilities,
  Method-B-ProvideCapabilities,
  Method-B-RequestAssistanceData,
  Method-B-ProvideAssistanceData,
  Method-B-RequestLocationInformation,
  Method-B-ProvideLocationInformation
FROM
  SLPP-PDU-Method-B-Contents
  Method-C-RequestCapabilities,
  Method-C-ProvideCapabilities,
  Method-C-RequestAssistanceData,
  Method-C-ProvideAssistanceData,
  Method-C-RequestLocationInformation,
  Method-C-ProvideLocationInformation
FROM
  SLPP-PDU-Method-C-Contents;
-- ASN1STOP
-  SLPP-Message
-- ASN1START
SLPP-Message ::= SEQUENCE {
  slpp-MessageHeader  SLPP-MessageHeader,
  slpp-MessageBody  SLPP-MessageBody
}
-- ASN1STOP
-  SLPP-MessageHeader
-- ASN1START
SLPP-MessageHeader ::= CHOICE {
c1  CHOICE {
slpp-message-header  SLPP-Message-Header,
spare1  NULL
  },
  messageClassExtension  SEQUENCE { }
}
SLPP-Message-Header ::= SEQUENCE {
  -- e.g., transaction ID, sequence number, etc.
}
-- ASN1STOP
-  SLPP-MessageBody
-- ASN1START
SLPP-MessageBody ::= CHOICE {
c1  CHOICE {
    requestCapabilities  RequestCapabilities,
    provideCapabilities  ProvideCapabilities,
    requestAssistance Data  RequestAssistanceData,
    provideAssistanceData  ProvideAssistance Data,
    requestLocationInformation RequestLocationInformation,
    provideLocationInformation ProvideLocationInformation,
    --
    -- additional SLPP messages FFS (e.g., session operation messages)
    --
    spare2 NULL, spare1 NULL
    },
    messageClassExtension SEQUENCE { }
}
-- ASN1STOP
-  RequestCapabilities
-- ASN1START
RequestCapabilities ::= SEQUENCE {
  criticalExtensions  CHOICE {
    requestCapabilities  RequestCapabilities-IEs,
```

| | |
|---|---|
| criticalExtensionsFuture | SEQUENCE { } |

}
}
RequestCapabilities-IEs ::= SEQUENCE {

| | |
|---|---|
| commonIEsRequestCapabilities | OCTET STRING OPTIONAL, -- Containing |

CommonIEsRequestCapabilities

| | |
|---|---|
| method-A-RequestCapabilities | OCTET STRING OPTIONAL, -- Containing |

Method-A-RequestCapabilities

| | |
|---|---|
| method-B-RequestCapabilities | OCTET STRING OPTIONAL, -- Containing |

Method-B-RequestCapabilities

| | |
|---|---|
| method-C-RequestCapabilities | OCTET STRING OPTIONAL, -- Containing |

Method-C-RequestCapabilities

| | |
|---|---|
| lateNonCriticalExtension | OCTET STRING OPTIONAL, |
| nonCriticalExtension | SEQUENCE { } OPTIONAL |

}
-- ASN1STOP
- ProvideCapabilities
-- ASN1START
ProvideCapabilities ::= SEQUENCE {
criticalExtensions CHOICE {
provideCapabilities ProvideCapabilities-IEs,

| | |
|---|---|
| criticalExtensionsFuture | SEQUENCE { } |

}
}
ProvideCapabilities-IEs ::= SEQUENCE {

| | |
|---|---|
| commonIEsProvideCapabilities | OCTET STRING OPTIONAL, -- Containing |

CommonIEsProvideCapabilities

| | |
|---|---|
| method-A-ProvideCapabilities | OCTET STRING OPTIONAL, -- Containing |

Method-A-ProvideCapabilities

| | |
|---|---|
| method-B-ProvideCapabilities | OCTET STRING OPTIONAL, -- Containing |

Method-B-ProvideCapabilities

| | |
|---|---|
| method-C-ProvideCapabilities | OCTET STRING OPTIONAL, -- Containing |

Method-C-ProvideCapabilities

| | |
|---|---|
| lateNonCriticalExtension | OCTET STRING OPTIONAL, |
| nonCriticalExtension | SEQUENCE { } OPTIONAL |

```
}
-- ASN1STOP
-  RequestAssistanceData
-- ASN1START
RequestAssistanceData ::= SEQUENCE {
  criticalExtensions  CHOICE {
    requestAssistanceData  RequestAssistanceData-IEs,
```

| | |
|---|---|
| criticalExtensionsFuture | SEQUENCE { } |

```
  }
}
RequestAssistanceData-IEs ::= SEQUENCE {
  commonIEsRequestAssistanceData  OCTET STRING OPTIONAL, -- Containing
CommonIEsRequestAssistanceData
  method-A-RequestAssistanceData  OCTET STRING OPTIONAL, -- Containing
Method-A-RequestAssistanceData
  method-B-RequestAssistanceData  OCTET STRING OPTIONAL, -- Containing
Method-B-RequestAssistanceData
  method-C-RequestAssistanceData  OCTET STRING OPTIONAL, -- Containing
Method-C-RequestAssistanceData
```

| | |
|---|---|
| lateNonCriticalExtension | OCTET STRING OPTIONAL, |
| nonCriticalExtension | SEQUENCE { } OPTIONAL |

}
-- ASN1STOP
- ProvideAssistanceData
-- ASN1START
ProvideAssistanceData ::= SEQUENCE {
criticalExtensions CHOICE {

| | |
|---|---|
| provideAssistanceData | ProvideAssistanceData-IEs, |
| criticalExtensionsFuture | SEQUENCE { } |

}
}
ProvideAssistanceData-IEs ::= SEQUENCE {

| | |
|---|---|
| commonIEsProvideAssistanceData | OCTET STRING OPTIONAL, -- Containing |

CommonIEsProvideAssistanceData

| | |
|---|---|
| method-A-ProvideAssistanceData | OCTET STRING OPTIONAL, -- Containing |

Method-A-ProvideAssistanceData

| | |
|---|---|
| method-B-ProvideAssistanceData | OCTET STRING OPTIONAL, -- Containing |

Method-B-ProvideAssistanceData

| | |
|---|---|
| method-C-ProvideAssistanceData | OCTET STRING OPTIONAL, -- Containing |

Method-C-ProvideAssistanceData

| | |
|---|---|
| lateNonCriticalExtension | OCTET STRING OPTIONAL, |
| nonCriticalExtension | SEQUENCE { } OPTIONAL |

```
}
-- ASN1STOP
-  RequestLocationInformation
-- ASN1START
RequestLocationInformation ::= SEQUENCE {
  criticalExtensions CHOICE {
    requestLocationInformation RequestLocationInformation-IEs,
```

| | |
|---|---|
| criticalExtensionsFuture | SEQUENCE { } |

```
  }
}
RequestLocationInformation-IEs ::= SEQUENCE {
  commonIEsRequestLocationInformation OCTET STRING OPTIONAL, --
Containing CommonIEsRequestLocationInformation
  method-A-RequestLocationInformation OCTET STRING OPTIONAL, -- Containing
Method-A-RequestLocationInformation
  method-B-RequestLocationInformation OCTET STRING OPTIONAL, -- Containing
Method-B-RequestLocationInformation
  method-C-RequestLocationInformation OCTET STRING OPTIONAL, -- Containing
Method-C-RequestLocationInformation
```

| | |
|---|---|
| lateNonCriticalExtension | OCTET STRING OPTIONAL, |
| nonCriticalExtension | SEQUENCE { } OPTIONAL |

```
}
-- ASN1STOP
-  ProvideLocationInformation
-- ASN1START
ProvideLocationInformation ::= SEQUENCE {
  criticalExtensions  CHOICE {
    provideLocationInformation ProvideLocationInformation-IEs,
```

| | |
|---|---|
| criticalExtensionsFuture | SEQUENCE { } |

```
  }
}
ProvideLocationInformation-IEs ::= SEQUENCE {
  commonIEsProvideLocationInformation OCTET STRING OPTIONAL, --
Containing CommonIEsProvideLocationInformation
  method-A-ProvideLocationInformation OCTET STRING OPTIONAL, --
Containing Method-A-ProvideLocationInformation
  method-B-ProvideLocationInformation OCTET STRING OPTIONAL, --
Containing Method-B-ProvideLocationInformation
  method-C-ProvideLocationInformation OCTET STRING OPTIONAL, --
Containing Method-C-ProvideLocationInformation
```

| | |
|---|---|
| lateNonCriticalExtension | OCTET STRING OPTIONAL, |
| nonCriticalExtension | SEQUENCE { } OPTIONAL |

}
-- ASN1STOP
- End of SLPP-PDU-Definitions
-- ASN1START
END
-- ASN1STOP
Example SLPP PDU Comment Contents are as follows:
- SLPP-PDU-Common-Contents
-- ASN1START
SLPP-PDU-Common-Contents
DEFINITIONS AUTOMATIC TAGS ::=
BEGIN
-- ASN1STOP
- CommonIEsRequestCapabilities
-- ASN1START
CommonIEsRequestCapabilities ::= SEQUENCE {
}
-- ASN1STOP
- CommonIEsProvideCapabilities
-- ASN1START
CommonIEsProvideCapabilities ::= SEQUENCE {
}
-- ASN1STOP
- CommonIEsRequestAssistanceData
-- ASN1START
CommonIEsRequestAssistanceData ::= SEQUENCE {
}
-- ASN1STOP
- CommonIEsProvideAssistanceData
-- ASN1START
CommonIEsProvideAssistanceData ::= SEQUENCE {
}
-- ASN1STOP
- CommonIEsRequestLocationInformation
-- ASN1START
CommonIEsRequestLocationInformation ::= SEQUENCE {
}
-- ASN1STOP
- CommonIEsProvideLocationInformation
-- ASN1START
CommonIEsProvideLocationInformation ::= SEQUENCE {
}
-- ASN1STOP
- End of SLPP-PDU-Common-Contents
-- ASN1START
END
-- ASN1STOP

### Example SLPP PDU Method

A Contents are as follows:

| - | SLPP-PDU-Method-A-Contents |
|---|---|
| -- ASN1START | |
| SLPP-PDU-Method-A-Contents | |
| DEFINITIONS AUTOMATIC TAGS ::= | |
| BEGIN | |
| -- ASN1STOP | |
| - | Method-A-RequestCapabilities |
| -- ASN1START | |
| Method-A-RequestCapabilities ::= SEQUENCE { | |
| } | |
| -- ASN1STOP | |
| - | Method-A-ProvideCapabilities |
| -- ASN1START | |
| Method-A-ProvideCapabilities ::= SEQUENCE { | |
| } | |
| -- ASN1STOP | |
| - | Method-A-RequestAssistanceData |
| -- ASN1START | |
| Method-A-RequestAssistanceData ::= SEQUENCE { | |
| } | |
| -- ASN1STOP | |
| - | Method-A-Provide AssistanceData |
| -- ASN1START | |
| Method-A-ProvideAssistanceData ::= SEQUENCE { | |
| } | |
| -- ASN1STOP | |
| - | Method-A-RequestLocationInformation |
| -- ASN1START | |
| Method-A-RequestLocationInformation ::= SEQUENCE { | |
| } | |
| -- ASN1STOP | |
| - | Method-A-ProvideLocationInformation |
| -- ASN1START | |
| Method-A-ProvideLocationInformation ::= SEQUENCE { | |
| } | |
| -- ASN1STOP | |
| - | End of SLPP-PDU-Method-A-Contents |

-- ASN1START
END
-- ASN1STOP

Example SLPP PDU Method-B Contents are as follows:

| - | SLPP-PDU-Method-B-Contents |
|---|---|
| -- ASN1START | |
| SLPP-PDU-Method-B-Contents | |
| DEFINITIONS AUTOMATIC TAGS ::= | |
| BEGIN | |
| -- ASN1STOP | |
| - | Method-B-RequestCapabilities |
| -- ASN1START | |
| Method-B-RequestCapabilities ::= SEQUENCE { | |
| } | |
| -- ASN1STOP | |
| - | Method-B-ProvideCapabilities |
| -- ASN1START | |
| Method-B-ProvideCapabilities ::= SEQUENCE { | |
| } | |
| -- ASN1STOP | |
| - | Method-B-RequestAssistanceData |
| -- ASN1START | |
| Method-B-RequestAssistanceData ::= SEQUENCE { | |
| } | |
| -- ASN1STOP | |
| - | Method-B-Provide AssistanceData |
| -- ASN1START | |
| Method-B-Provide AssistanceData ::= SEQUENCE { | |
| } | |
| -- ASN1STOP | |
| - | Method-B-RequestLocationInformation |
| -- ASN1START | |
| Method-B-RequestLocationInformation ::= SEQUENCE { | |
| } | |
| -- ASN1STOP | |
| - | Method-B-ProvideLocationInformation |
| -- ASN1START | |
| Method-B-ProvideLocationInformation ::= SEQUENCE { | |
| } | |
| -- ASN1STOP | |
| - | End of SLPP-PDU-Method-B-Contents |

-- ASN1START
END
-- ASN1STOP

Example SLPP PDU Method-C Contents are as follows:

| - | SLPP-PDU-Method-C-Contents |
|---|---|
| -- ASN1START | |
| SLPP-PDU-Method-C-Contents | |
| DEFINITIONS AUTOMATIC TAGS ::= | |
| BEGIN | |
| -- ASN1STOP | |
| - | Method-C-RequestCapabilities |
| -- ASN1START | |
| Method-C-RequestCapabilities ::= SEQUENCE { | |
| } | |
| -- ASN1STOP | |
| - | Method-C-ProvideCapabilities |
| -- ASN1START | |
| Method-C-ProvideCapabilities ::= SEQUENCE { | |
| } | |
| -- ASN1STOP | |
| - | Method-C-RequestAssistanceData |
| } | |
| -- ASN1START | |
| Method-C-RequestAssistanceData ::= SEQUENCE { | |
| } | |
| -- ASN1STOP | |
| - | Method-C-Provide AssistanceData |
| -- ASN1START | |
| Method-C-ProvideAssistanceData ::= SEQUENCE { | |
| } | |
| -- ASN1STOP | |
| - | Method-C-RequestLocationInformation |
| -- ASN1START | |
| Method-C-RequestLocationInformation ::= SEQUENCE { | |
| } | |
| -- ASN1STOP | |
| - | Method-C-ProvideLocationInformation |
| -- ASN1START | |
| Method-C-ProvideLocationInformation ::= SEQUENCE { | |
| } | |
| -- ASN1STOP | |
| - | End of SLPP-PDU-Method-C-Contents |

-- ASN1START
END
-- ASN1STOP

Sidelink ranging and positioning use cases involving multiple target UEs for the same positioning session may be supported, including use cases support of sidelink ranging and positioning control over groupcast or broadcast. In an aspect, at least unicast SLPP/RSPP “centralized” operation may be supported, i.e., operation where one UE performs range and/or position calculations based on measurement/location information relating to itself and/or other UEs. In an aspect, if it is determined to support group positioning, it is feasible to perform at least ranging with the estimate calculation at multiple UEs.

In an aspect, it may be feasible to send at least the following positioning signaling for groupcast/broadcast (in addition to unicast):
SL positioning capability
SL positioning assistance data
SL Location information and measurements

In an aspect, group positioning may be utilized to acquire location estimates of multiple target UEs (absolute positioning) or multiple UE pairs (Ranging/relative positioning) per LCS request. At least part of the group management for group positioning is performed at upper/application layer.

With respect to the overall signaling procedure for PC5-only positioning (including at least IC and OOC), the sidelink positioning procedures may comprise the following series of operations as a baseline, between the LMF/positioning server UE/NG-RAN/candidate Anchor UE(s) and Target UE(s):
1. Triggering event
2. Sidelink positioning capability exchange
3. Sidelink positioning assistance data transfer
4. SL Positioning Request Location Information
5. Measurement of SL-PRS
6. Location calculation
7. SL Positioning Provide Location Information

The order (1-7) is an example and may be modified. In an aspect, discovery and selection of anchor UEs and/or server UE may be part of the positioning layer.

In an aspect, Anchor UE and target UE roles can be shown in the sidelink positioning procedures in stage 2. Server UE can be further discussed at least for the case that the server UE is separate from the target and anchor. In an aspect, discovery procedure is included in the sidelink positioning procedure at least for out of coverage scenario

Example SLPP procedural operations and call flows aligned with above-noted aspects are described below and illustrated for UE-assisted (centralized) sidelink ranging and positioning and for UE-based (distributed) sidelink ranging and positioning. These flows demonstrate sidelink ranging and positioning for a single target UE and for multiple target UEs and show that the same SLPP messages and message sequence can be used whether a sidelink positioning SLPP session involves single target UE or multiple target UEs. Specifically, it is shown that the SLPP call flow can be independent of the number of participating UEs and the number of target UEs.

In an aspect, there has been some discussion and controversy over whether additional SLPP messages are needed to manage service requirements and SLPP sessions. In LPP, there is no explicit management of LPP sessions and services. This is possible because an LPP session is always between one UE and one location server (e.g. LMF in the case of NR access), the location server is always assumed to control the LPP session (not the UE) and any association with a separate service request (e.g. an MO-LR supplementary services request or a periodic-triggered location supplementary services request) can be indicated or implied using a same Correlation ID/Routing ID value (for a periodic-triggered location supplementary services request) or at least an association in time (for an MO-LR supplementary services request). These restrictions and associations would not always apply to SLPP sessions between pairs or groups of UEs, where any one UE (e.g. for V2X or MCX) may be participating in multiple SLPP sessions with other UEs in which service requirements and identities of other UEs need to be precisely and unambiguously known for each SLPP session. This leads to an assumption below that additional SLPP messages may be needed to manage SLPP sessions (e.g. regarding establishment, modification and termination) and the services (e.g. location results) that each session enables. However, these additional SLPP messages may not be needed in all cases, where an SLPP session can be implicitly defined in some other way (e.g. as for LPP), and could then be omitted.

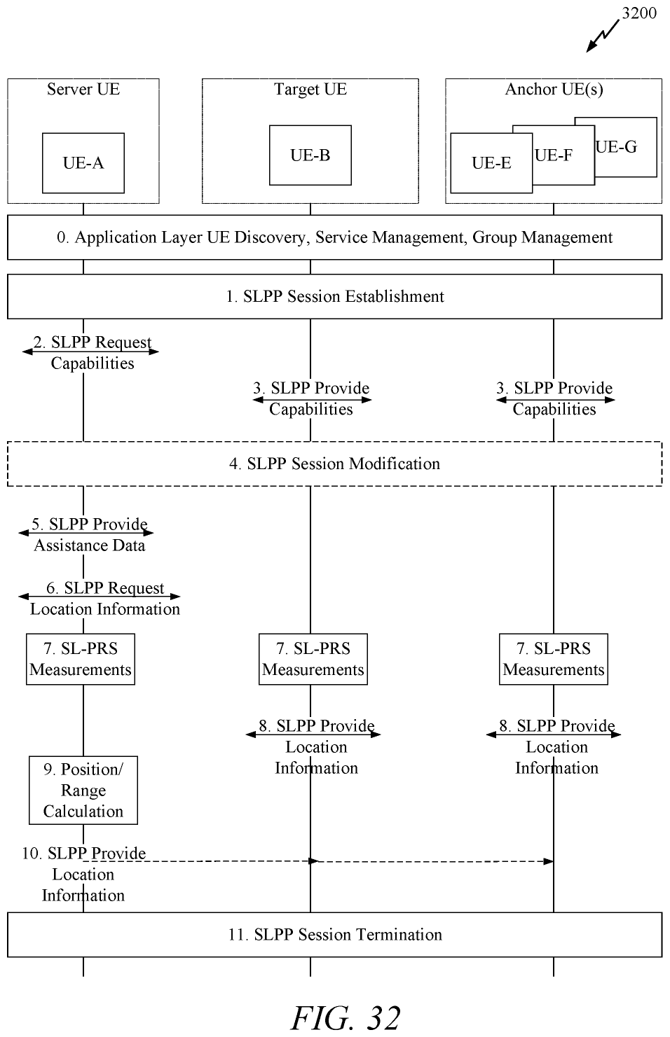

FIG. 32 illustrates a UE-assisted (centralized) Sidelink-only Positioning procedure 3200 for a Single Target UE, in accordance with aspects of the disclosure. FIG. 32 illustrates a UE-assisted sidelink positioning session for a single Target UE, where a server UE (UE-A) initiates the SLPP session and performs position calculation based on SL-PRS measurements received from the single Target UE and the other (e.g. anchor) UEs. Following UE discovery, the SLPP message flow consists of session establishment, capability and assistance data exchange, location information transfer and session termination.

FIG. 32 illustrates an SLPP session including session establishment, session modification and positioning actions and includes operations 0 through 11, which are summarized as follows:

FIG. 32, Operation 0: The Application layer in UE-A and other UEs may perform UE discovery, determine and verify required services and perform group management (e.g. create a group containing UEs A, B and E, F, G). The Application layer in UE-A also verifies that all of the UEs support SLPP. The Application layer in UE-A then requests sidelink ranging and positioning results for the single Target UE-B from the SLPP layer in UE-A, and provides the SLPP layer in UE-A the application layer IDs and layer 2 IDs for each of the UEs-A to E, and may provide an application layer group ID and a layer 2 group ID for the group of one or more UEs A to E. NOTE: The exact API between Application Layer and SLPP layer can be regarded as implementation dependent.

FIG. 32, Operation 1: The initiating UE (Server UE-A) establishes an SLPP Session (e.g. as in FIG. 9) to make all participating UEs aware of each other.

FIG. 32, Operation 2: The initiating UE (Server UE-A) transmits an SLPP Request Capabilities message to the single Target UE (UE-B) and the anchor UEs (UE-E, UE-F, UE-G). The SLPP Request Capabilities message may be sent by initiating UE (Server UE-A) to the single Target UE (UE-B) and to the anchor UEs (UE-E, UE-F, UE-G) via unicast, groupcast or broadcast, depending on the specific scenario.

FIG. 32, Operation 3: The single Target UE (UE-B) and the anchor UEs (UE-E, UE-F, UE-G) respond to the initiating UE (Server UE-A) with an SLPP Provide Capabilities message. The SLPP Provide Capabilities message may be sent by the single Target UE (UE-B) and by the anchor UEs (UE-E, UE-F, UE-G) to the initiating UE (Server UE-A) via unicast, groupcast or broadcast, depending on the specific scenario.

FIG. 32, Operation 4: The SLPP Session may be modified (e.g. as in FIG. 10) based on the capability information from Operation 3 (e.g., removal of UEs with incompatible capability such as SL positioning method, etc.).

FIG. 32, Operation 5: The initiating UE (Server UE-A) transmits an SLPP Provide Assistance Data message to the single Target UE (UE-B) and the anchor UEs (UE-E, UE-F, UE-G). The SLPP Provide Assistance Data message may be sent by initiating UE (Server UE-A) to the single Target UE (UE-B) and to the anchor UEs (UE-E, UE-F, UE-G) via unicast, groupcast or broadcast, depending on the specific scenario. The SLPP Provide Assistance Data message includes the SL-PRS configuration for each of the UEs in the session. After receipt of the assistance data (or at an indicated starting time included in the message), each UE in the session transmits its respective SL-PRS. The duration of SL-PRS transmission may be controlled by a timer provided in the message or may continue until the SLPP session is terminated at Operation 11.

FIG. 32, Operation 6: The initiating UE (Server UE-A) transmits an SLPP Request Location Information message to the single Target UE (UE-B) and/or to the anchor UEs (UE-E, UE-F, UE-G), dependent on the desired positioning method. The SLPP Request Location Information message may be sent by initiating UE (Server UE-A) to the single Target UE (UE-B) and to the anchor UEs (UE-E, UE-F, UE-G) via unicast, groupcast or broadcast, depending on the specific scenario. The SLPP Request Location Information message indicates the type of location information needed and associated QoS (e.g., desired accuracy, response time, etc.). The message also includes an indication that range/position calculation will be performed by the initiating UE (Server UE-A).

FIG. 32, Operation 7: Each participating UE performs the requested SL-PRS transmissions and measurements. Note: The Server UE-A may participate in the sidelink positioning session through transmission and measurement of SL-PRS (for example also taking the role of an anchor UE) or may participate only in managing the session and performing and disseminating position calculations.

FIG. 32, Operation 8: The single Target UE (UE-B) and/or the anchor UEs (UE-E, UE-F, UE-G) respond to the initiating UE (Server UE-A) with an SLPP Provide Location Information message. The SLPP Provide Location Information message may be sent by the single Target UE (UE-B) and by the anchor UEs (UE-E, UE-F, UE-G) to the initiating UE (Server UE-A) via unicast, groupcast or broadcast, depending on the specific scenario. The SLPP Provide Location Information message may be sent upon completion of the transmission and measurements or periodically or after the response time received at Operation 6 expired and may also include an indication of whether other UEs (the initiating Server UE-A in this case) is requested to provide the location result (e.g., calculated range and/or position) back to this UE. SL-PRS transmission and SL-PRS measurement may be performed periodically, based on the configuration received in the SLPP Provide Assistance Data message.

FIG. 32, Operation 9: The initiating UE (Server UE-A) performs the range/position computations using the location results received at Operation 8 and the location results UE A has obtained at Operation 7.

FIG. 32, Operation 10: If requested at Operation 8 to distribute location results, the initiating UE (Server UE-A) may distribute the location results by transmitting an SLPP Provide Location Information message to the single Target UE-B. The SLPP Provide Location Information message may be sent by initiating UE (Server UE-A) to the single Target UE (UE-B) via unicast, groupcast or broadcast, depending on the specific scenario.

FIG. 32, Operation 11: The SLPP session may be terminated.

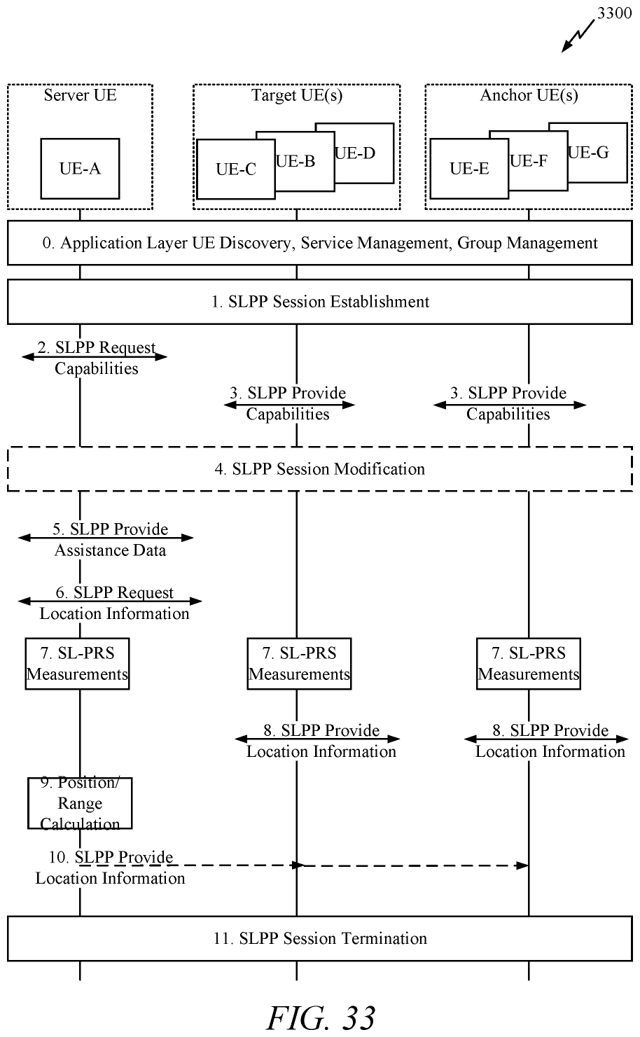

FIG. 33 illustrates a UE-assisted (centralized) Sidelink-only Positioning—Multiple Target UEs procedure 3300, in accordance with aspects of the disclosure. FIG. 33 illustrates a UE-assisted sidelink positioning session for multiple Target UEs, where a server UE (UE-A) initiates the SLPP session and performs position calculation based on SL-PRS measurements received from multiple Target UEs and the anchor UEs. The SLPP message flow is identical to the flow shown in FIG. 1 for UE-assisted sidelink positioning for a single Target UE. Following UE discovery, the UEs perform session establishment, capability and assistance data exchange, location information transfer and session termination. FIG. 33 includes operations 0 through 11, which are summarized as follows:

FIG. 33, Operation 0: The Application layer in UE-A and other UEs may perform UE discovery, determine and verify required services and perform group management (e.g., create a group containing UEs A to G). The Application layer in UE-A also verifies that all of the UEs support SLPP. The Application layer in UE-A then requests sidelink ranging and positioning results for the multiple Target UEs (UE-B, UE-C, UE-D) from the SLPP layer in UE-A, and provides the SLPP layer in UE-A the application layer IDs and layer 2 IDs for each of the UEs-A to E, and may provide an application layer group ID and a layer 2 group ID for the group of one or more UEs A to E. NOTE: The exact API between Application Layer and SLPP layer can be regarded as implementation dependent.

FIG. 33, Operation 1: The initiating UE (Server UE-A) establishes an SLPP Session (e.g. as in FIG. 9) to make all participating UEs aware of each other.

FIG. 33, Operation 2: The initiating UE (Server UE-A) transmits an SLPP Request Capabilities message to the multiple Target UEs (UE-B, UE-C, UE-D) and the anchor UEs (UE-E, UE-F, UE-G). The SLPP Request Capabilities message may be sent by initiating UE (Server UE-A) to the multiple Target UEs (UE-B, UE-C, UE-D) and to the anchor UEs (UE-E, UE-F, UE-G) via unicast, groupcast or broadcast, depending on the specific scenario.

FIG. 33, Operation 3: The Multiple Target UEs (UE-B, UE-C, UE-D) and the anchor UEs (UE-E, UE-F, UE-G) respond to the initiating UE (Server UE-A) with an SLPP Provide Capabilities message. The SLPP Provide Capabilities message may be sent by the multiple Target UEs (UE-B, UE-C, UE-D) and by the anchor UEs (UE-E, UE-F, UE-G) to the initiating UE (Server UE-A) via unicast, groupcast or broadcast, depending on the specific scenario.

FIG. 33, Operation 4: The SLPP Session may be modified (e.g. as in FIG. 10) based on the capability information from Operation 3 (e.g., removal of UEs with incompatible capability such as SL positioning method, etc.).

FIG. 33, Operation 5: The initiating UE (Server UE-A) transmits an SLPP Provide Assistance Data message to the multiple Target UEs (UE-B, UE-C, UE-D) and to the anchor UEs (UE-E, UE-F, UE-G). The SLPP Provide Assistance Data message may be sent by initiating UE (Server UE-A) to the multiple Target UEs (UE-B, UE-C, UE-D) and to the anchor UEs (UE-E, UE-F, UE-G) via unicast, groupcast or broadcast, depending on the specific scenario. The SLPP Provide Assistance Data message includes the SL-PRS configuration for each of the UEs participating in the SLPP session. After receipt of the assistance data (or at an indicated starting time included in the message), each UE in the session transmits its respective SL-PRS. The duration of SL-PRS transmission may be controlled by a timer provided in the message or may continue until the SLPP session is terminated at Operation 11.

FIG. 33, Operation 6: The initiating UE (Server UE-A) transmits an SLPP Request Location Information message to the multiple Target UEs (UE-B, UE-C, UE-D) and/or to the anchor UEs (UE-E, UE-F, UE-G), dependent on the desired positioning method. The SLPP Request Location Information message may be sent by initiating UE (Server UE-A) to the multiple Target UEs (UE-B, UE-C, UE-D) and to the anchor UEs (UE-E, UE-F, UE-G) via unicast, groupcast or broadcast, depending on the specific scenario. The SLPP Request Location Information message indicates the type of location information needed and associated QoS (e.g., desired accuracy, response time, etc.). The message also includes an indication that range/position calculation will be performed by the initiating UE (Server UE-A).

FIG. 33, Operation 7: Each participating UE performs the requested SL-PRS transmissions and measurements. Note: The Server UE-A may participate in the sidelink positioning session through transmission and measurement of SL-PRS (for example also taking the role of an anchor UE) or may participate only in managing the session and performing and disseminating position calculations.

FIG. 33, Operation 8: The Multiple Target UEs (UE-B, UE-C, UE-D) and the anchor UEs (UE-E, UE-F, UE-G) respond to the initiating UE (Server UE-A) with an SLPP Provide Location Information message. The SLPP Provide Location Information message may be sent by the multiple Target UEs (UE-B, UE-C, UE-D) and by the anchor UEs (UE-E, UE-F, UE-G) to the initiating UE (Server UE-A) via unicast, groupcast or broadcast, depending on the specific scenario. The SLPP Provide Location Information message may be sent upon completion of the transmission and measurements or periodically or after the response time received at Operation 6 expired and may also include an indication of whether other UEs (the initiating Server UE-A in this case) is requested to provide the location result (e.g., calculated range and/or position) back to this UE. SL-PRS transmission and SL-PRS measurement may be performed periodically, based on the configuration received in the SLPP Provide Assistance Data message.

FIG. 33, Operation 9: The initiating UE (Server UE-A) performs the range/position computations using the location results received at Operation 8 and the location results UE B has obtained at Operation 7.

FIG. 33, Operation 10: If requested at Operation 8 to distribute location results, the initiating UE (Server UE-A) may distribute the location results by transmitting an SLPP Provide Location Information message to the multiple Target UEs (UE-B, UE-C, UE-D). The SLPP Provide Location Information message may be sent by initiating UE (Server UE-A) to the multiple Target UEs (UE-B, UE-C, UE-D) via unicast, groupcast or broadcast, depending on the specific scenario.

FIG. 33, Operation 11: The SLPP session may be terminated.

Referring to FIG. 33, the SLPP messages and message call flow for a UE-assisted sidelink positioning session for multiple Target UEs may be identical to the SLPP messages and message call flow for a UE-assisted sidelink positioning session for a single Target UE.

In an aspect, UE-assisted Sidelink Positioning SLPP sessions use the same SLPP messages and SLPP message call flow regardless of whether the session is for a single Target UE or for multiple Target UEs.

Referring to FIG. 33, in an aspect, if an SLPP positioning session is constrained to support only a single Target UE, an application-layer request to perform sidelink positioning for multiple Target UEs will require as many SLPP positioning sessions as there are target UEs. Each separate session will require its own separate capability negotiation, assistance data exchange, SL-PRS configuration, SL-PRS transmissions and location information transfer, resulting in far less efficient, temporally elongated sidelink positioning transaction than would be the case if an SLPP session supports multiple target UEs. In an aspect, if an SLPP session does not support multiple target UEs, an application-layer request to position multiple UEs will require as many SLPP sessions as there are target UEs. Each SLPP session requiring its own capability negotiation, assistance data exchange, SL-PRS configuration, SL-PRS transmission and location information exchange. The resulting positioning session will be inefficient in resource utilization and require a longer time to complete compared to a session supporting multiple target UEs.

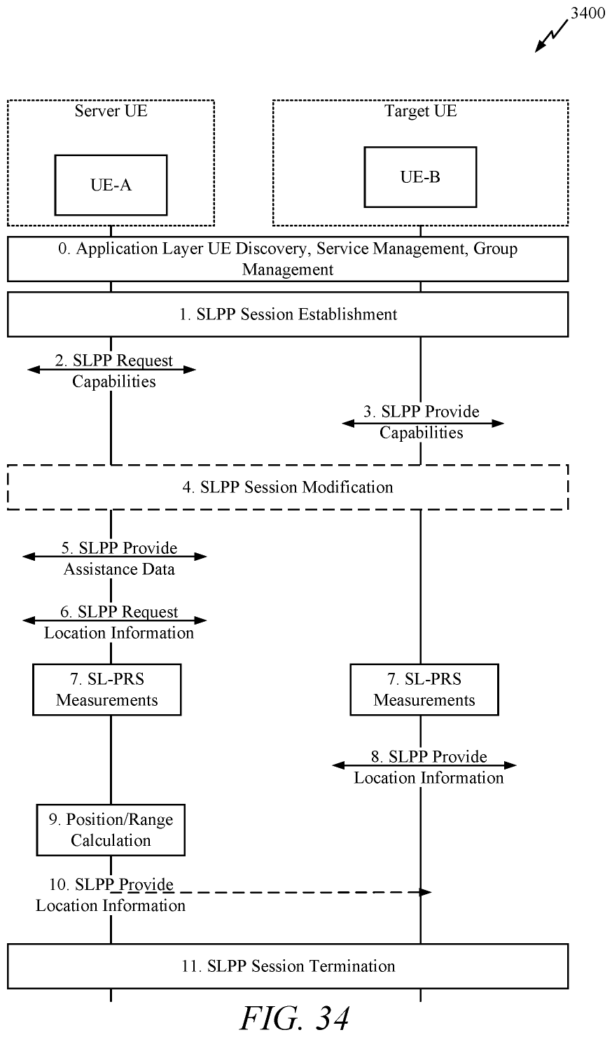

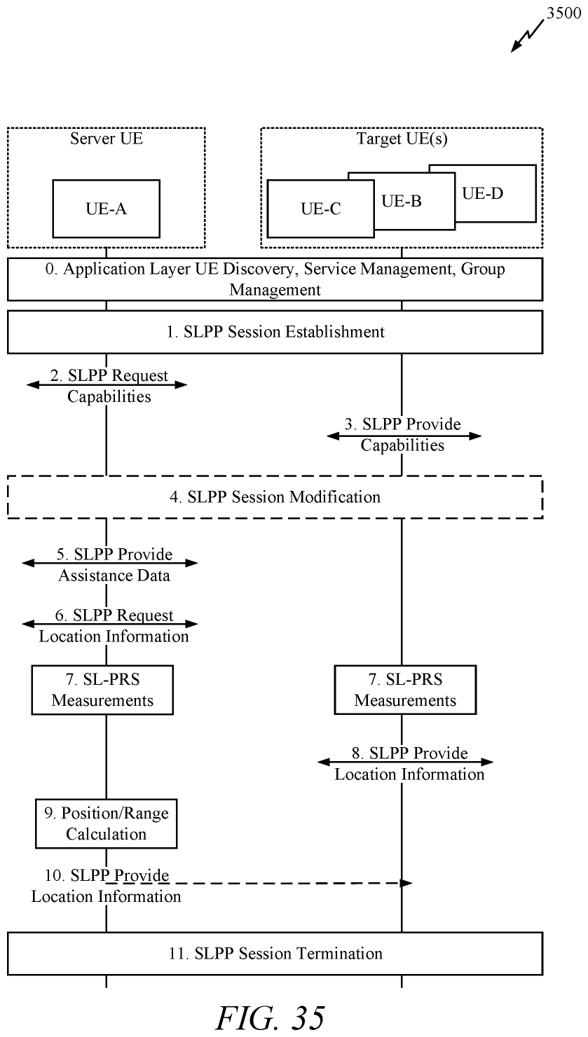

FIG. 34 illustrates a UE-assisted (centralized) Sidelink-only Ranging procedure 3400 for a single target UE, in accordance with aspects of the disclosure. FIG. 35 illustrates a UE-assisted (centralized) Sidelink-only Ranging procedure 3500 for multiple target UEs, in accordance with aspects of the disclosure. In FIGS. 34-35, a server UE (UE-A) performs range calculation based on SL-PRS measurements received from the single Target UE or from the multiple Target UEs. The SLPP message flow is the same for ranging to a single Target UE and for ranging to Multiple Target UEs, and is identical to the flow shown in FIGS. 32-33 for UE-assisted sidelink positioning for a single Target UE and multiple Target UEs, respectively. Following UE discovery, the UEs perform session establishment, capability and assistance data exchange, location information transfer and session termination. FIGS. 34-35 each include operations 0 to 11, which are summarized as follows:

FIGS. 34-35, Operation 0: The Application layer in UE-A and other UEs may perform UE discovery, determine and verify required services and perform group management (e.g., create a group containing UE A and UE B or a group containing UEs A-D). The Application layer in UE-A also verifies that all of the UEs support SLPP. The Application layer in UE-A then requests sidelink ranging and positioning results for the single Target UE-B from the SLPP layer in UE-A, and provides the SLPP layer in UE-A the application layer IDs and layer 2 IDs for each of the UEs-A to E, and may provide an application layer group ID and a layer 2 group ID for the group of one or more UEs A to E. NOTE: The exact API between Application Layer and SLPP layer can be regarded as implementation dependent.

FIGS. 34-35, Operation 1: The initiating UE (Server UE-A) establishes an SLPP Session (e.g. as in FIG. 9) to make all participating UEs aware of each other.

FIGS. 34-35, Operation 2: The initiating UE (Server UE-A) transmits an SLPP Request Capabilities message: Single Target UE: The SLPP Request Capabilities message is transmitted by the initiating UE (Server UE-A) to the single Target UE-B. Multiple Target UEs: The SLPP Request Capabilities message is transmitted by the initiating UE (Server UE-A) to the multiple Target UEs (UE-B, UE-C, UE-D). The SLPP Request Capabilities message may be sent by initiating UE (Server UE-A) to the single Target UE (UE-B) or to the multiple Target UEs (UE-B, UE-C, UE-D) via unicast, groupcast or broadcast, depending on the specific scenario.

FIGS. 34-35, Operation 3: SLPP Provide Capabilities: Single Target UE: The Single Target UE (UE-B) responds to the initiating UE (Server UE-A) with an SLPP Provide Capabilities message. Multiple Target UEs: The Multiple Target UEs (UE-B, UE-C, UE-D) respond to the initiating UE (Server UE-A) with an SLPP Provide Capabilities message. The SLPP Provide Capabilities message may be sent by the single Target UE (UE-B) to the initiating UE (Server UE-A) or by the multiple Target UEs (UE-B, UE-C, UE-D) to the initiating UE (Server UE-A) via unicast, groupcast or broadcast, depending on the specific scenario.

FIGS. 34-35, Operation 4: The SLPP Session may be modified (e.g. as in FIG. 10) based on the capability information from Operation 3 (e.g., removal of UEs with incompatible capability such as SL positioning method, anchor capability, etc.).

FIGS. 34-35, Operation 5: The initiating UE (Server UE-A) transmits an SLPP Provide Assistance Data message: Single Target UE: The SLPP Provide Assistance Data message is transmitted by the initiating UE (Server UE-A) to the Target UE-B. Multiple Target UEs: The SLPP Provide Assistance Data message is transmitted by the initiating UE (Server UE-A) to the multiple Target UEs established at Operation 1 or 4 (UE-B, UE-C, UE-D). The SLPP Provide Assistance message may be sent by initiating UE (Server UE-A) to the single Target UE (UE-B) or to the multiple Target UEs (UE-B, UE-C, UE-D) via unicast, groupcast or broadcast, depending on the specific scenario. The SLPP Provide Assistance Data message includes the SL-PRS configuration for each of the UEs participating in the SLPP session. After receipt of the assistance data (or at an indicated starting time included in the message), each UE in the session transmits its respective SL-PRS. The duration of SL-PRS transmission may be controlled by a timer provided in the message or may continue until the SLPP session is terminated at Operation 11.

FIGS. 34-35, Operation 6: The initiating UE (Server UE-A) transmits an SLPP Request Location Information message: Single Target UE: The SLPP Request Location Information message is transmitted by the initiating UE (Server UE-A) to the Target UE-B. Multiple Target UEs: The SLPP Request Location Information message is transmitted by the initiating UE (Server UE-A) to the multiple Target UEs (UE-B, UE-C, UE-D). The SLPP Request Location Information message may be sent by initiating UE (Server UE-A) to the single Target UE (UE-B) or multiple Target UEs (UE-B, UE-C, UE-D) via unicast, groupcast or broadcast, depending on the specific scenario. The SLPP Request Location Information message indicates the type of location information needed and associated QoS (e.g., desired accuracy, response time, etc.). The message also includes an indication that range/position calculation will be performed by the initiating UE (Server UE-A).

FIGS. 34-35, Operation 7: Each participating UE performs the requested SL-PRS transmissions and measurements.

FIGS. 34-35, Operation 8: SLPP Provide Location Information: Single Target UE: The Single Target UE (UE-B) responds to the initiating UE (Server UE-A) with an SLPP Provide Location Information message. Multiple Target UEs: The multiple Target UEs (UE-B, UE-C, UE-D) respond to the initiating UE (Server UE-A) with an SLPP Provide Location Information message. The SLPP Provide Location Information message may be sent by the single Target UE (UE-B) to the initiating UE (Server UE-A) or by the multiple Target UEs (UE-B, UE-C, UE-D) to the initiating UE (Server UE-A) via unicast, groupcast or broadcast, depending on the specific scenario. The SLPP Provide Location Information message may be sent upon completion of the transmission and measurements or periodically or after the response time received at Operation 6 expired and may also include an indication of whether other UEs (the initiating Server UE-A in this case) is requested to provide the location result (e.g., calculated range and/or position) back to this UE. SL-PRS transmission and SL-PRS measurement may be performed periodically, based on the configuration received in the SLPP Provide Assistance Data message.

FIGS. 34-35, Operation 9: The initiating UE (Server UE-A) performs the range/position computations using the location results received at Operation 8 and the location results UE B has obtained at Operation 7.

FIGS. 34-35, Operation 10: If requested at Operation 8 to distribute location results, the initiating UE (Server UE-A) may distribute the location results by transmitting an SLPP Provide Location Information message: Single Target UE: The SLPP Provide Location Information message is transmitted by the initiating UE (Server UE-A) to the single Target UE-B. Multiple Target UEs: The SLPP Provide Location Information message is transmitted by the initiating UE (Server UE-A) to the multiple Target UEs (UE-B, UE-C, UE-D). The SLPP Provide Location Information message may be sent by initiating UE (Server UE-A) to the single Target UE (UE-B) or to the multiple Target UEs (UE-B, UE-C, UE-D) via unicast, groupcast or broadcast, depending on the specific scenario.

FIGS. 34-35, Operation 0: The SLPP session may be terminated.

FIGS. 34-35 demonstrate that the SLPP messages and message call flow for an SLPP UE-assisted sidelink ranging session for multiple Target UEs may be identical to the SLPP messages and message call flow for an SLPP UE-assisted sidelink ranging session for a single Target UE. Furthermore, the SLPP messages and message call flow for an SLPP UE-assisted sidelink ranging session for a single or for multiple target UEs is identical to the SLPP messages and message flow for an SLPP UE-assisted sidelink positioning session for a single or for multiple target UEs.

Referring to FIGS. 34-35, in an aspect, UE-assisted Sidelink Ranging SLPP sessions for a single Target UE and UE-assisted Sidelink Ranging SLPP sessions for multiple Target UEs use the same SLPP messages and SLPP message call flow.

Referring to FIGS. 34-35, in an aspect, regardless of whether an SLPP session is for a single target UE or for multiple target UEs, the same SLPP messages and SLPP message call flow are used for UE-assisted Sidelink Ranging SLPP sessions and UE-assisted Sidelink Positioning SLPP sessions.

Referring to FIGS. 34-35, in an aspect, as in UE-assisted sidelink positioning, for UE-assisted sidelink ranging, if an SLPP ranging session is constrained to support only a single Target UE, an application-layer request to perform sidelink ranging for multiple Target UEs will require as many SLPP ranging sessions as there are target UEs, with each separate session requiring its own separate capability negotiation, assistance data exchange, SL-PRS configuration, SL-PRS transmissions and location information transfer. The resulting multiple ranging sessions are far less efficient, and incur greater latency to determine the multiple ranges than would be the case if an SLPP ranging session supports multiple target UEs.

Referring to FIGS. 34-35, in an aspect, if an SLPP session does not support multiple target UEs, an application-layer request to range multiple UEs will require as many SLPP sessions as there are target UEs, with each SLPP session including its own capability negotiation, assistance data exchange, SL-PRS configuration, SL-PRS transmission and location information exchange, resulting in a resource-inefficient, temporally elongated sidelink ranging session.

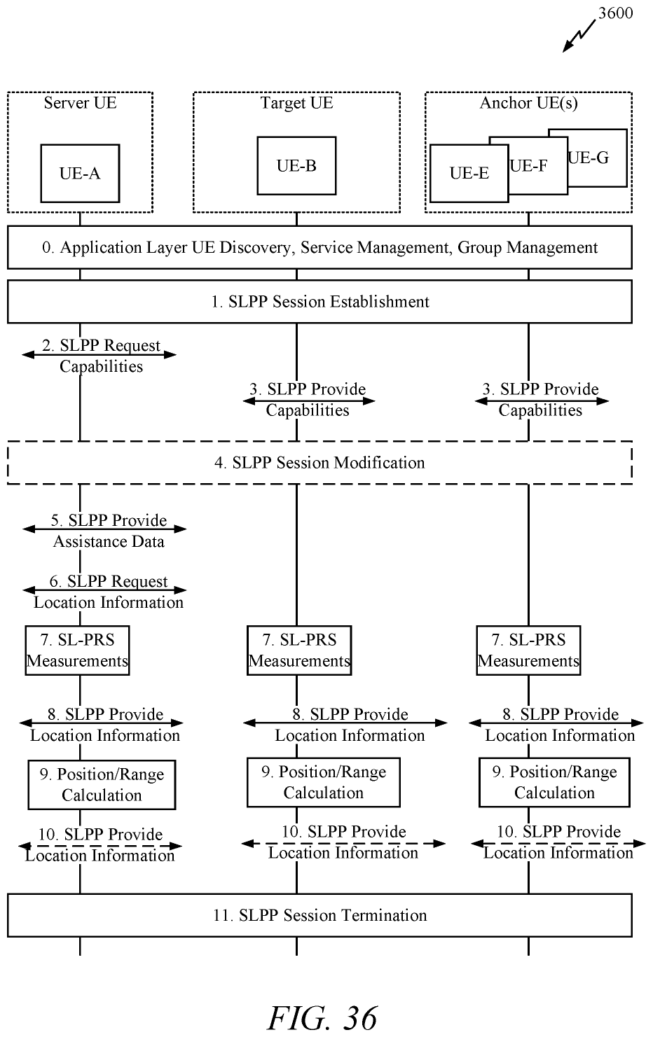

FIG. 36 illustrates a UE-based (distributed) Sidelink-only Positioning—Single Target UE procedure 3600, in accordance with aspects of the disclosure. FIG. 36 illustrates a UE-based sidelink positioning session for a single Target UE, where a server UE (UE-A) initiates the SLPP session and subsequent position calculation is performed by the participating UEs based on SL-PRS measurements received from the single Target UE and the anchor UEs. Following UE discovery, the SLPP message flow consists of session establishment, capability and assistance data exchange, location information transfer and session termination. FIG. 36 includes operations 0 through 11, which are summarized as follows:

FIG. 36, Operations 0-5: Same as in FIG. 32

FIG. 36, Operation 6: The initiating UE (Server UE-A) transmits an SLPP Request Location Information message to the Single Target UE-B and/or to the anchor UEs (UE-E, UE-F, UE-G), dependent on the desired positioning method. The SLPP Request Location Information message may be sent by initiating UE (Server UE-A) to the single Target UE (UE-B) and to the anchor UEs (UE-E, UE-F, UE-G) via unicast, groupcast or broadcast, depending on the specific scenario. The SLPP Request Location Information message indicates the type of location information needed and associated QOS (e.g., desired accuracy, response time, etc.). The message also includes an indication that range/position calculation should be performed by each of the participating UEs (the initiating Server UE-A and the Target UE(s)).

FIG. 36, Operation 7: Each participating UE performs the requested SL-PRS transmissions and measurements. Note: The Server UE-A may participate in the sidelink positioning session through transmission and measurement of SL-PRS (for example also taking the role of an anchor UE) or may participate only in managing the session and performing and disseminating position calculations.

FIG. 36, Operation 8: The Single Target UE (UE-B), the initiating UE (Server UE-A) and the anchor UEs (UE-E, UE-F, UE-G) transmit an SLPP Provide Location Information message. The SLPP Provide Location Information message may be transmitted by the Single Target UE (UE-B), the initiating UE (Server UE-A) and the anchor UEs (UE-E, UE-F, UE-G) via unicast, groupcast or broadcast, depending on the specific scenario. The SLPP Provide Location Information message may be sent upon completion of the transmission and measurements or periodically or after the response time received at Operation 6 expired and may also include an indication of whether other UEs are requested to provide the location result (e.g., calculated range and/or position) back to the sending UE. SL-PRS transmission and SL-PRS measurement may be performed periodically, based on the configuration received in the SLPP Provide Assistance Data message.

FIG. 36, Operation 9: Each participating UE performs the range/position computations using the location results received at Operation 8 and its own location results obtained at Operation 7.

FIG. 36, Operation 10: If requested at Operation 8, each UE may distribute its location results to the other UEs in this session by transmitting an SLPP Provide Location Information message. The SLPP Provide Location Information message may be sent by the Single Target UE (UE-B), the initiating UE (Server UE-A) and the anchor UEs (UE-E, UE-F, UE-G) via unicast, groupcast or broadcast, depending on the specific scenario.

FIG. 36, Operation 11: The SLPP session may be terminated.

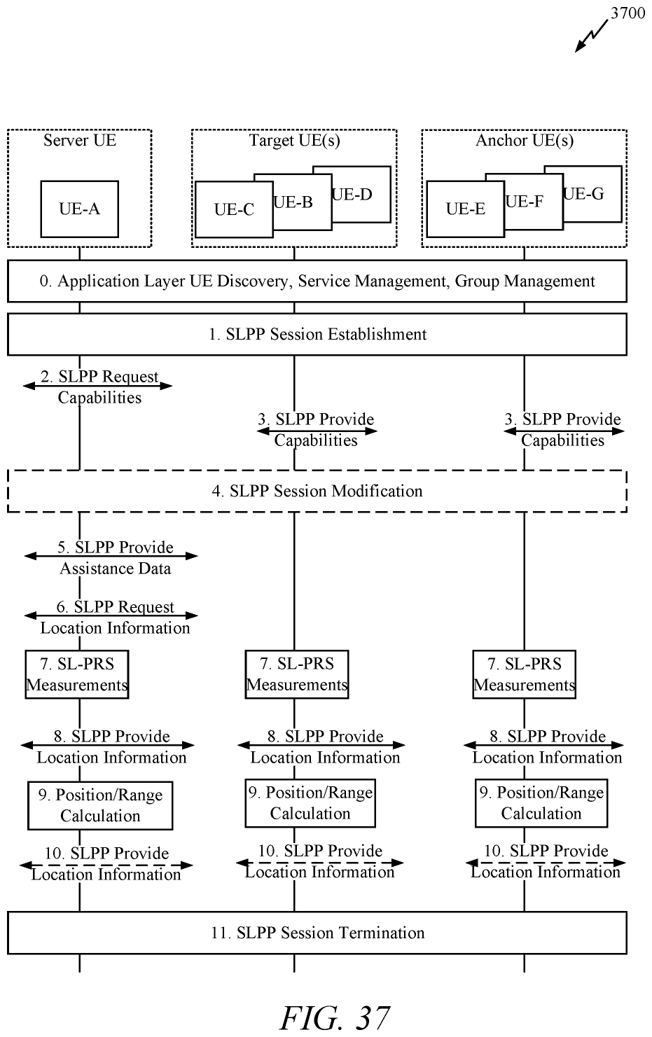

FIG. 37 illustrates a UE-based (distributed) Sidelink-only Positioning—Multiple Target UEs procedure 3700, in accordance with aspects of the disclosure. FIG. 37 illustrates a UE-based sidelink positioning session for a multiple Target UEs, where a server UE (UE-A) initiates the SLPP session and subsequent position calculation is performed by the participating UEs based on SL-PRS measurements received from the multiple Target UEs and the anchor UEs. Following UE discovery, the SLPP message flow consists of session establishment, capability and assistance data exchange, location information transfer and session termination. FIG. 37 includes operations 0 through 11, which are summarized as follows:

FIG. 37, Operations 0-5: Same as in FIG. 33

FIG. 37, Operation 6: The initiating UE (Server UE-A) transmits an SLPP Request Location Information message to the Multiple Target UEs (UE-B, UE-C, UE-D) and/or to the anchor UEs (UE-E, UE-F, UE-G), dependent on the desired positioning method. The SLPP Request Location Information message may be sent by initiating UE (Server UE-A) to the Multiple Target UEs (UE-B, UE-C, UE-D) and the anchor UEs (UE-E, UE-F, UE-G) via unicast, groupcast or broadcast, depending on the specific scenario. The SLPP Request Location Information message indicates the type of location information needed and associated QoS (e.g., desired accuracy, response time, etc.). The message also includes an indication that range/position calculation should be performed by each of the participating UEs (the initiating Server UE-A and the Target UE(s)).

FIG. 37, Operation 7: Each participating UE performs the requested SL-PRS transmissions and measurements. Note: The Server UE-A may participate in the sidelink positioning session through transmission and measurement of SL-PRS (for example also taking the role of an anchor UE) or may participate only in managing the session and performing and disseminating position calculations.

FIG. 37, Operation 8: The Multiple Target UEs (UE-B, UE-C, UE-D), the initiating UE (Server UE-A) and the anchor UEs (UE-E, UE-F, UE-G) transmit an SLPP Provide Location Information message. The SLPP Provide Location Information message may be transmitted by the Multiple Target UEs (UE-B, UE-C, UE-D), the initiating UE (Server UE-A) and the anchor UEs (UE-E, UE-F, UE-G) via unicast, groupcast or broadcast, depending on the specific scenario. The SLPP Provide Location Information message may be sent upon completion of the transmission and measurements or periodically or after the response time received at Operation 6 expired and may also include an indication of whether other UEs are requested to provide the location result (e.g., calculated range and/or position) back to the sending UE. SL-PRS transmission and SL-PRS measurement may be performed periodically, based on the configuration received in the SLPP Provide Assistance Data message.

FIG. 37, Operation 9: Each participating UE performs the range/position computations using the location results received at Operation 8 and its own location results obtained at Operation 7.

FIG. 37, Operation 10: If requested at Operation 8, each UE may distribute its location results to the other UEs in this session by transmitting an SLPP Provide Location Information message. The SLPP Provide Location Information message may be sent by the multiple Target UEs (UE-B, UE-C, UE-D), the initiating UE (Server UE-A) and the anchor UEs (UE-E, UE-F, UE-G) via unicast, groupcast or broadcast, depending on the specific scenario.

FIG. 37, Operation 11: The SLPP session may be terminated.

As shown in FIG. 37, the SLPP messages and message call flow for a UE-based sidelink positioning session for multiple Target UEs may be identical to the SLPP messages and message call flow for a UE-based sidelink positioning session for a single Target UE. Furthermore, both UE-based and UE-assisted sidelink positioning use the same SLPP messages and SLPP message call flows regardless of whether the session is for a single target UE or for multiple target UEs.

Referring to FIG. 37, in an aspect, UE-based Sidelink Positioning SLPP sessions may use the same SLPP messages and SLPP message call flow regardless of whether the session is for a single Target UE or for multiple Target UEs.

Referring to FIG. 37, in an aspect, SLPP sidelink positioning sessions (UE-assisted or UE-based) may use the same SLPP messages and SLPP message call flow regardless of whether the SLPP session is for a single target UE or multiple Target UEs.

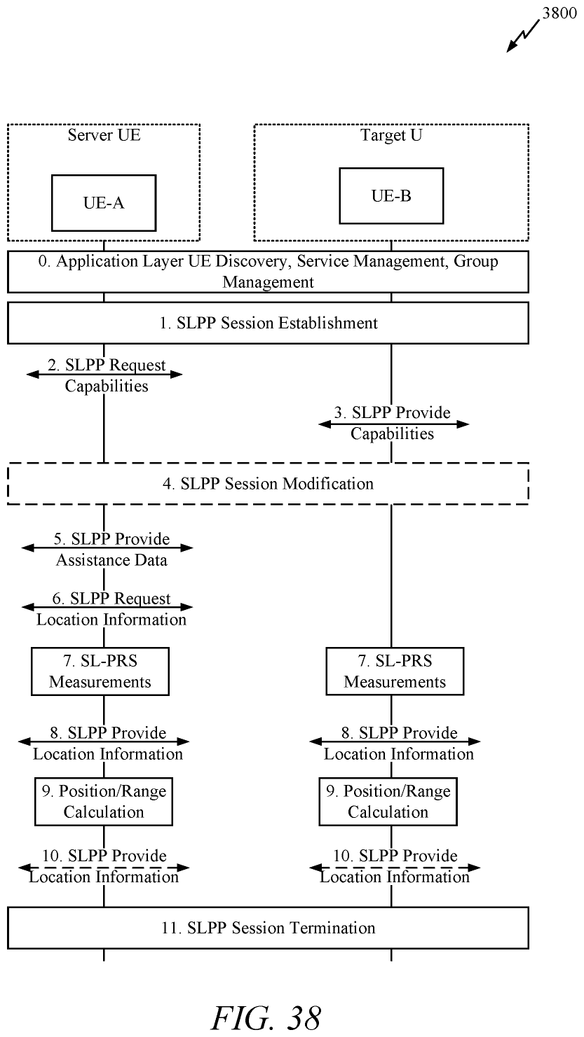

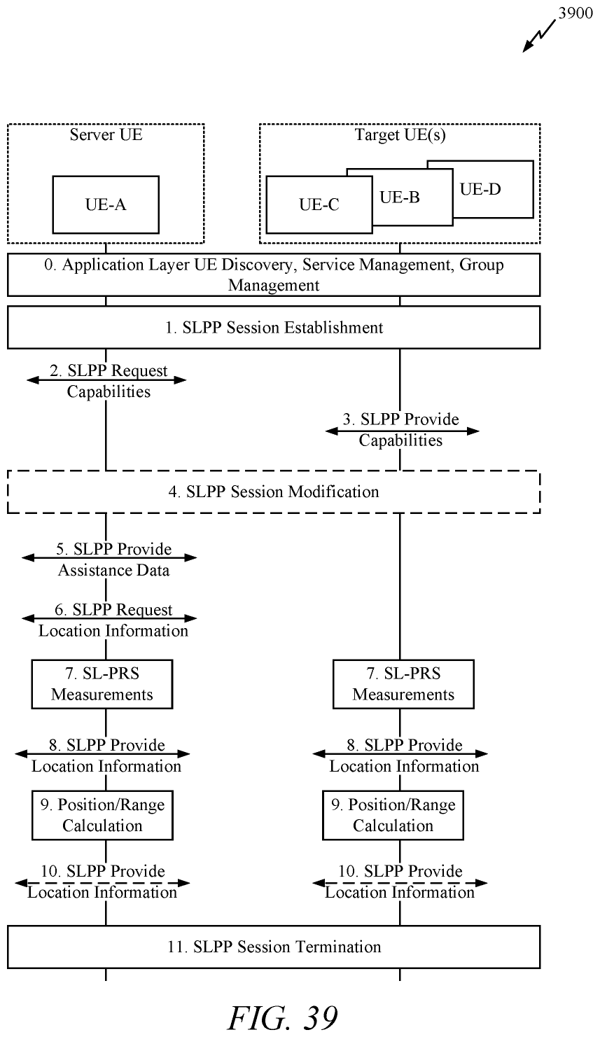

FIG. 38 illustrates a UE-based (distributed) Sidelink-only Ranging procedure 3800 for a single target UE, in accordance with aspects of the disclosure. FIG. 39 illustrates a UE-based (distributed) Sidelink-only Ranging procedure 3900 for multiple target UEs, in accordance with aspects of the disclosure. FIGS. 38-39 illustrate UE-based sidelink ranging for a single Target UE and for multiple Target UEs, where a server UE (UE-A) initiates the SLPP session and subsequent range calculation is performed by the participating UEs based on SL-PRS measurements received from the single Target UE or multiple Target UEs. The SLPP message flow is the same for ranging to a single Target UE and for ranging to Multiple Target UEs, and is identical to the flow shown in FIGS. 36 and 37 for UE-based sidelink positioning for a single Target UE and multiple Target UEs, respectively. Following UE discovery, the UEs perform session establishment, capability and assistance data exchange, location information transfer and session termination. FIGS. 38-39 each include operations 0 to 11, which are summarized as follows:

FIGS. 38-39, Operations 0-5: Same as in FIGS. 34-35.

FIGS. 38-39, Operation 6: The initiating UE (Server UE-A) transmits an SLPP Request Location Information message: Single Target UE: The SLPP Request Location Information message is transmitted by the initiating UE (Server UE-A) to the Target UE-B. Multiple Target UEs: The SLPP Request Location Information message is transmitted by the initiating UE (Server UE-A) to the multiple Target UEs (UE-B, UE-C, UE-D). The SLPP Request Location Information message may be sent by initiating UE (Server UE-A) to the single Target UE (UE-B) or multiple Target UEs (UE-B, UE-C, UE-D) via unicast, groupcast or broadcast, depending on the specific scenario. The SLPP Request Location Information message indicates the type of location information needed and associated QoS (e.g., desired accuracy, response time, etc.). The message also includes an indication that range/position calculation should be performed by each of the participating UEs (the initiating Server UE-A and the Target UE(s)).

FIGS. 38-39, Operation 7: Each participating UE performs the requested SL-PRS transmissions and measurements.

FIGS. 38-39, Operation 8: SLPP Provide Location Information: Single Target UE: The Single Target UE (UE-B) and the initiating UE (Server UE-A) transmit an SLPP Provide Location Information message. Multiple Target UEs: The multiple Target UEs (UE-B, UE-C, UE-D) and the initiating UE (Server UE-A) transmit an SLPP Provide Location Information message. The SLPP Provide Location Information message may be sent by the single Target UE (UE-B) to the initiating UE (Server UE-A) or by the multiple Target UEs (UE-B, UE-C, UE-D) to the initiating UE (Server UE-A) via unicast, groupcast or broadcast, depending on the specific scenario. The SLPP Provide Location Information message may be sent upon completion of the transmission and measurements or periodically or after the response time received at Operation 6 expired and may also include an indication of whether other UEs (the initiating Server UE-A in this case) is requested to provide the location result (e.g., calculated range and/or position) back to this UE. SL-PRS transmission and SL-PRS measurement may be performed periodically, based on the configuration received in the SLPP Provide Assistance Data message.

FIGS. 38-39, Operation 9: Each participating UE performs the range/position computations using the location results received at Operation 8 and its own location results obtained at Operation 7.

FIGS. 38-39, Operation 7: If requested at Operation 8, each UE may distribute its location results to the other UEs in this session by transmitting an SLPP Provide Location Information message. Single Target UE: The SLPP Provide Location Information message is transmitted by the initiating UE (Server UE-A) and the single Target UE-B. Multiple Target UEs: The SLPP Provide Location Information message is transmitted by the initiating UE (Server UE-A) and the multiple Target UEs (UE-B, UE-C, UE-D). The SLPP Provide Location Information message may be sent by initiating UE (Server UE-A) to the single Target UE (UE-B) or by the multiple Target UEs (UE-B, UE-C, UE-D) via unicast, groupcast or broadcast, depending on the specific scenario.

FIGS. 38-39, Operation 7: The SLPP session may be terminated.

In an aspect, FIGS. 38-39 demonstrate that the SLPP messages and message sequence may be the same regardless of whether an SLPP session is established to range/position a single target UE, or an SLPP session is established to range/position a set of multiple target UEs. In an aspect, there is no difference in SLPP signaling between SLPP sessions for a single target UE or for multiple target UEs. Moreover, enforcing an SLPP session to support only a single target UE may be unnecessary and may require any ranging/positioning session involving more than one target UE to invoke multiple SLPP sessions. The resulting performance may be inefficient in use of over-the-air resources and extend the time required to obtain the range and/or position results.

Referring to FIGS. 38-39, in an aspect, the same SLPP messages and the same SLPP message sequence may be used regardless of whether an SLPP session is established for ranging and/or positioning a single target UE, or an SLPP session is established for ranging and/or positioning a set of multiple target UEs.

Referring to FIGS. 38-39, in an aspect, invoking multiple SLPP sessions to range and/or position a set of multiple target UEs consumes more over-the-air resources and requires a longer period of time to obtain range/position results for all the UEs than involving a single SLPP session including the set of multiple target UEs.

Referring to FIGS. 38-39, in an aspect, sidelink ranging/positioning for a group of one or more UEs (a set of multiple target UEs) may be applicable to various use cases, including IIoT, commercial, Public Safety and V2X. In particular, the V2X use case can involve large groups of UEs which may engage in sidelink ranging/positioning. In an aspect, the same SLPP messages and SLPP message sequence may apply to a single target UE and to multiple target UEs, such that there is no additional burden in terms of specification development by supporting multiple target UEs. In an aspect, SLPP supports a single target UE or multiple target UEs within the same SLPP Ranging/SL Positioning session.

In some designs, unicast link establishment signaling overhead, and the requirement of at least as many unicast links as UE participants (for centralized operation (n-1) unicast links are required) significantly limits the scalability of unicast as a general solution for sidelink positioning and ranging. This can be appreciated for the V2X use case, a key use case called out on in the SID. As the number of participating UEs (vehicles) increases, the additional unicast links required increases, resulting in increased signaling overhead, bandwidth consumption, and latency, thereby decreasing efficiency, and limiting the number of participants. For example, in high traffic conditions, there may be many more V2X UEs than depicted in FIG. 8C. For public safety, commercial, and IIOT use cases, performance over unicast will be impacted as the number of UEs engaged in sidelink positioning and ranging increases. For this reason groupcast/broadcast for sidelink positioning and ranging may be beneficial for various use cases. Such use cases may involve a Road Side Unit (RSU) and multiple vehicles, or multiple vehicles in a platoon, and so on. Additionally, the MCX service that relies on group communication would also benefit from groupcast/broadcast signaling support. In addition, for Ranging based services, there are multiple use cases that involve groups of UEs performing Ranging/Sidelink positioning services, e.g. Museum Tour, etc.

In an aspect, PC5-U has a well-defined Quality-of-Service (QOS) management procedure, enabling the upper layer to specify the exact QoS requirements to the AS layer. PC5-U supports QoS through the mapping of PC5 QoS Flow Identifier (PFI) from the application layer to the AS layer, including Resource Type, Priority Level, Packet Delay Budget, Packet Error Rate, thus providing flexibility in specification of QoS for different use cases. This is in contrast to the PDCP approach, where only default QoS settings can be applied to the SRB assigned. No mechanism is present to differentiate messages sent over an SRB in terms of QoS (all use the same, default QoS).

In an aspect, in terms of cast type support, SLPP transport over PC5-U as payload over V2X/ProSe layer enables existing procedures for cast type specification to be reused. In this case, no additional standards specification work is required. In contrast, for SLPP over PDCP, new procedures for treatment and specification of cast type may need to be developed.

In an aspect, for one-to-one, one-to-many, and many-to-one, sidelink positioning/ranging PC5-U provides flexibility in QoS, cast type and reduced link establishment latency, with the minimal standards specification work required. In an aspect, no modification is required to the PC5 reference point for SLPP transport over the PC5 user plane.

In addition to total the number of UEs in communication via sidelink at any one time, the rate of change in the number of UEs in communicating over sidelink also impacts scalability. For example, if traffic (the number of vehicles) increases over time interval T, the RSU may be required to establish communication with each of the new vehicles over the time interval T. The rate at which new connections must be established would be N/T (N being the number of vehicles entering the intersection during T). Solutions able to establish (and release) connections faster would then be preferred.

Aspects of the disclosure are directed to SLPP session establishment procedures. In current designs, sidelink positioning session establishment procedures are not defined in the relevant standard and are instead left up to implementation. Such aspects related to SLPP session establishment procedures may provide various technical advantages, such as reliable SLPP session establishment, which may provide improved position estimation accuracy, position estimation latency, and so on.

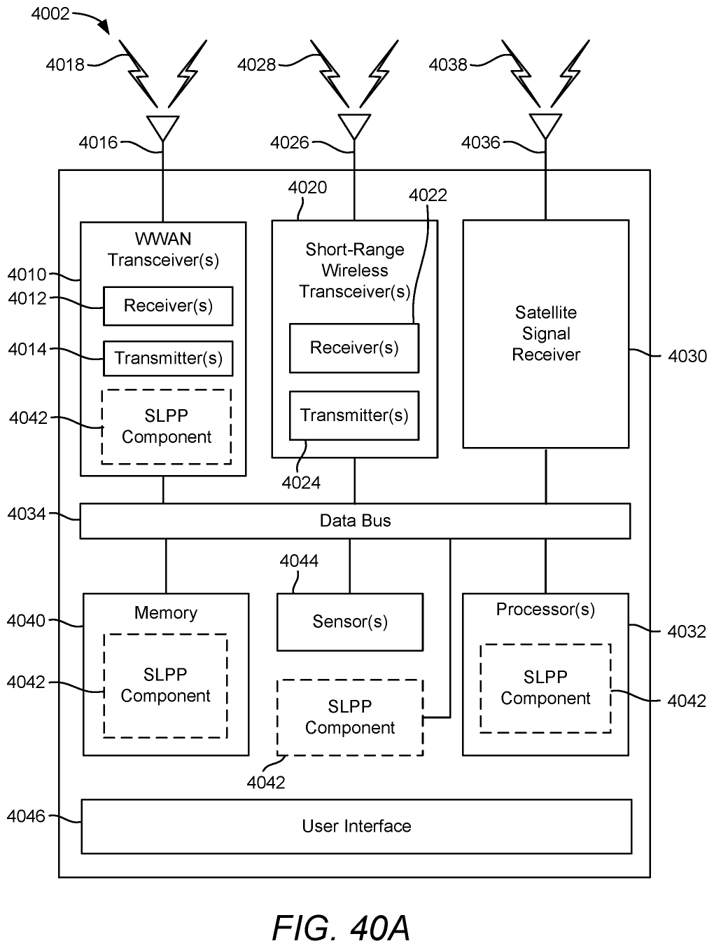

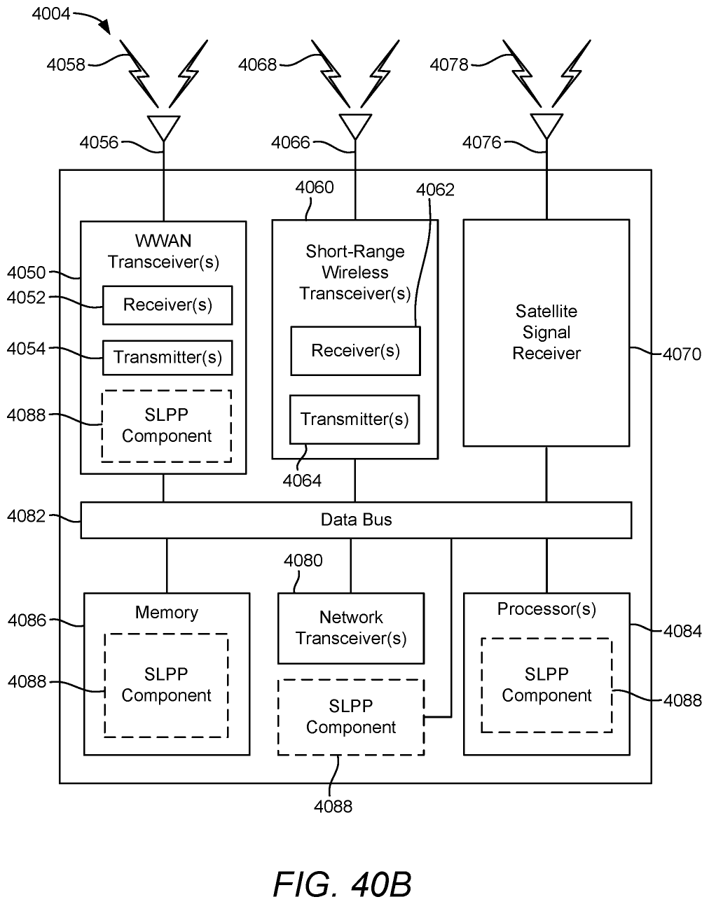

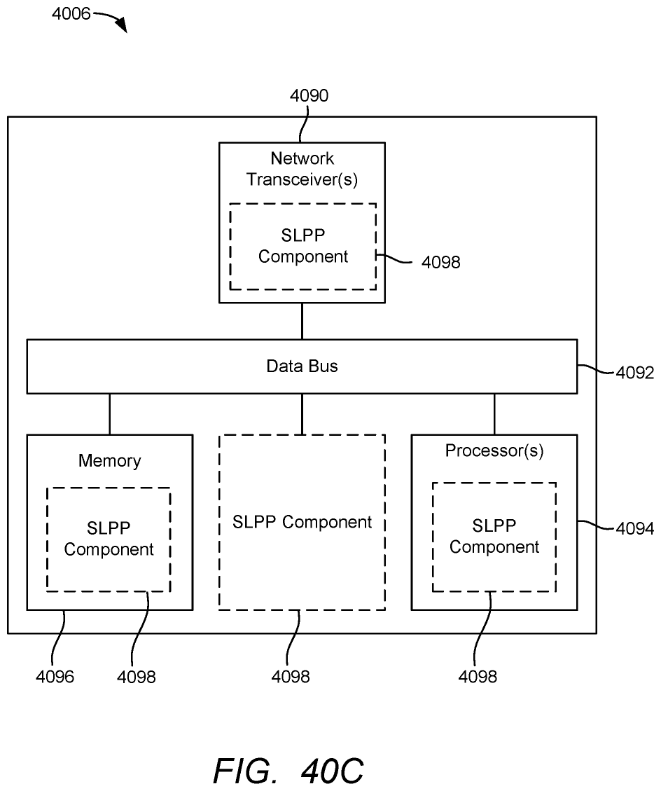

FIGS. 40A, 40B, and 40C illustrate several example components (represented by corresponding blocks) that may be incorporated into a UE 4002 (which may correspond to any of the UEs described herein), a base station 4004 (which may correspond to any of the base stations described herein), and a network entity 4006 (which may correspond to or embody any of the network functions described herein, including a location server and a LMF, or alternatively may be independent from the NG-RAN and/or 5GC infrastructure, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 4002 and the base station 4004 each include one or more wireless wide area network (WWAN) transceivers 4010 and 4050, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 4010 and 4050 may each be connected to one or more antennas 4016 and 4056, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 4010 and 4050 may be variously configured for transmitting and encoding signals 4018 and 4058 (e.g., messages, indications, information, and so on), respectively, and, conversely, for receiving and decoding signals 4018 and 4058 (e.g., messages, indications, information, pilots, and so on), respectively, in accordance with the designated RAT. Specifically, the WWAN transceivers 4010 and 4050 include one or more transmitters 4014 and 4054, respectively, for transmitting and encoding signals 4018 and 4058, respectively, and one or more receivers 4012 and 4052, respectively, for receiving and decoding signals 4018 and 4058, respectively.

The UE 4002 and the base station 4004 each also include, at least in some cases, one or more short-range wireless transceivers 4020 and 4060, respectively. The short-range wireless transceivers 4020 and 4060 may be connected to one or more antennas 4026 and 4066, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 4020 and 4060 may be variously configured for transmitting and encoding signals 4028 and 4068 (e.g., messages, indications, information, and so on), respectively, and, conversely, for receiving and decoding signals 4028 and 4068 (e.g., messages, indications, information, pilots, and so on), respectively, in accordance with the designated RAT. Specifically, the short-range wireless transceivers 4020 and 4060 include one or more transmitters 4024 and 4064, respectively, for transmitting and encoding signals 4028 and 4068, respectively, and one or more receivers 4022 and 4062, respectively, for receiving and decoding signals 4028 and 4068, respectively. As specific examples, the short-range wireless transceivers 4020 and 4060 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 4002 and the base station 4004 also include, at least in some cases, satellite signal receivers 4030 and 4070. The satellite signal receivers 4030 and 4070 may be connected to one or more antennas 4036 and 4076, respectively, and may provide means for receiving and/or measuring satellite positioning/communication signals 4038 and 4078, respectively. Where the satellite signal receivers 4030 and 4070 are satellite positioning system receivers, the satellite positioning/communication signals 4038 and 4078 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 4030 and 4070 are non-terrestrial network (NTN) receivers, the satellite positioning/communication signals 4038 and 4078 may be communication signals (e.g., carrying control and/or user data) originating from a 5G network. The satellite signal receivers 4030 and 4070 may comprise any suitable hardware and/or software for receiving and processing satellite positioning/communication signals 4038 and 4078, respectively. The satellite signal receivers 4030 and 4070 may request information and operations as appropriate from the other systems, and, at least in some cases, perform calculations to determine locations of the UE 4002 and the base station 4004, respectively, using measurements obtained by any suitable satellite positioning system algorithm.

The base station 4004 and the network entity 4006 each include one or more network transceivers 4080 and 4090, respectively, providing means for communicating (e.g., means for transmitting, means for receiving, etc.) with other network entities (e.g., other base stations 4004, other network entities 4006). For example, the base station 4004 may employ the one or more network transceivers 4080 to communicate with other base stations 4004 or network entities 4006 over one or more wired or wireless backhaul links. As another example, the network entity 4006 may employ the one or more network transceivers 4090 to communicate with one or more base station 4004 over one or more wired or wireless backhaul links, or with other network entities 4006 over one or more wired or wireless core network interfaces.

A transceiver may be configured to communicate over a wired or wireless link. A transceiver (whether a wired transceiver or a wireless transceiver) includes transmitter circuitry (e.g., transmitters 4014, 4024, 4054, 4064) and receiver circuitry (e.g., receivers 4012, 4022, 4052, 4062). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 4080 and 4090 in some implementations) may be coupled to one or more wired network interface ports. Wireless transmitter circuitry (e.g., transmitters 4014, 4024, 4054, 4064) may include or be coupled to a plurality of antennas (e.g., antennas 4016, 4026, 4056, 4066), such as an antenna array, that permits the respective apparatus (e.g., UE 4002, base station 4004) to perform transmit “beamforming,” as described herein. Similarly, wireless receiver circuitry (e.g., receivers 4012, 4022, 4052, 4062) may include or be coupled to a plurality of antennas (e.g., antennas 4016, 4026, 4056, 4066), such as an antenna array, that permits the respective apparatus (e.g., UE 4002, base station 4004) to perform receive beamforming, as described herein. In an aspect, the transmitter circuitry and receiver circuitry may share the same plurality of antennas (e.g., antennas 4016, 4026, 4056, 4066), such that the respective apparatus can only receive or transmit at a given time, not both at the same time. A wireless transceiver (e.g., WWAN transceivers 4010 and 4050, short-range wireless transceivers 4020 and 4060) may also include a network listen module (NLM) or the like for performing various measurements.

As used herein, the various wireless transceivers (e.g., transceivers 4010, 4020, 4050, and 4060, and network transceivers 4080 and 4090 in some implementations) and wired transceivers (e.g., network transceivers 4080 and 4090 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 4002) and a base station (e.g., base station 4004) will generally relate to signaling via a wireless transceiver.

The UE 4002, the base station 4004, and the network entity 4006 also include other components that may be used in conjunction with the operations as disclosed herein. The UE 4002, the base station 4004, and the network entity 4006 include one or more processors 4032, 4084, and 4094, respectively, for providing functionality relating to, for example, wireless communication, and for providing other processing functionality. The processors 4032, 4084, and 4094 may therefore provide means for processing, such as means for determining, means for calculating, means for receiving, means for transmitting, means for indicating, etc. In an aspect, the processors 4032, 4084, and 4094 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 4002, the base station 4004, and the network entity 4006 include memory circuitry implementing memories 4040, 4086, and 4096 (e.g., each including a memory device), respectively, for maintaining information (e.g., information indicative of reserved resources, thresholds, parameters, and so on). The memories 4040, 4086, and 4096 may therefore provide means for storing, means for retrieving, means for maintaining, etc. In some cases, the UE 4002, the base station 4004, and the network entity 4006 may include SLPP component 4042, 4088, and 4098, respectively. The SLPP component 4042, 4088, and 4098 may be hardware circuits that are part of or coupled to the processors 4032, 4084, and 4094, respectively, that, when executed, cause the UE 4002, the base station 4004, and the network entity 4006 to perform the functionality described herein. In other aspects, the SLPP component 4042, 4088, and 4098 may be external to the processors 4032, 4084, and 4094 (e.g., part of a modem processing system, integrated with another processing system, etc.). Alternatively, the SLPP component 4042, 4088, and 4098 may be memory modules stored in the memories 4040, 4086, and 4096, respectively, that, when executed by the processors 4032, 4084, and 4094 (or a modem processing system, another processing system, etc.), cause the UE 4002, the base station 4004, and the network entity 4006 to perform the functionality described herein.

FIG. 40A illustrates possible locations of the SLPP component 4042, which may be, for example, part of the one or more WWAN transceivers 4010, the memory 4040, the one or more processors 4032, or any combination thereof, or may be a standalone component. FIG. 40B illustrates possible locations of the SLPP component 4088, which may be, for example, part of the one or more WWAN transceivers 4050, the memory 4086, the one or more processors 4084, or any combination thereof, or may be a standalone component. FIG. 40C illustrates possible locations of the SLPP component 4098, which may be, for example, part of the one or more network transceivers 4090, the memory 4096, the one or more processors 4094, or any combination thereof, or may be a standalone component.

The UE 4002 may include one or more sensors 4044 coupled to the one or more processors 4032 to provide means for sensing or detecting movement and/or orientation information that is independent of motion data derived from signals received by the one or more WWAN transceivers 4010, the one or more short-range wireless transceivers 4020, and/or the satellite signal receiver 4030. By way of example, the sensor(s) 4044 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 4044 may include a plurality of different types of devices and combine their outputs in order to provide motion information. For example, the sensor(s) 4044 may use a combination of a multi-axis accelerometer and orientation sensors to provide the ability to compute positions in two-dimensional (2D) and/or three-dimensional (3D) coordinate systems.

In addition, the UE 4002 includes a user interface 4046 providing means for providing indications (e.g., audible and/or visual indications) to a user and/or for receiving user input (e.g., upon user actuation of a sensing device such a keypad, a touch screen, a microphone, and so on). Although not shown, the base station 4004 and the network entity 4006 may also include user interfaces.

Referring to the one or more processors 4084 in more detail, in the downlink, IP packets from the network entity 4006 may be provided to the processor 4084. The one or more processors 4084 may implement functionality for an RRC layer, a packet data convergence protocol (PDCP) layer, a radio link control (RLC) layer, and a medium access control (MAC) layer. The one or more processors 4084 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 4054 and the receiver 4052 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 4054 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 4002. Each spatial stream may then be provided to one or more different antennas 4056. The transmitter 4054 may modulate an RF carrier with a respective spatial stream for transmission.

At the UE 4002, the receiver 4012 receives a signal through its respective antenna(s) 4016. The receiver 4012 recovers information modulated onto an RF carrier and provides the information to the one or more processors 4032. The transmitter 4014 and the receiver 4012 implement Layer-1 functionality associated with various signal processing functions. The receiver 4012 may perform spatial processing on the information to recover any spatial streams destined for the UE 4002. If multiple spatial streams are destined for the UE 4002, they may be combined by the receiver 4012 into a single OFDM symbol stream. The receiver 4012 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 4004. These soft decisions may be based on channel estimates computed by a channel estimator. The soft decisions are then decoded and de-interleaved to recover the data and control signals that were originally transmitted by the base station 4004 on the physical channel. The data and control signals are then provided to the one or more processors 4032, which implements Layer-3 (L3) and Layer-2 (L2) functionality.

In the downlink, the one or more processors 4032 provides demultiplexing between transport and logical channels, packet reassembly, deciphering, header decompression, and control signal processing to recover IP packets from the core network. The one or more processors 4032 are also responsible for error detection.

Similar to the functionality described in connection with the downlink transmission by the base station 4004, the one or more processors 4032 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 4004 may be used by the transmitter 4014 to select the appropriate coding and modulation schemes, and to facilitate spatial processing. The spatial streams generated by the transmitter 4014 may be provided to different antenna(s) 4016. The transmitter 4014 may modulate an RF carrier with a respective spatial stream for transmission.

The uplink transmission is processed at the base station 4004 in a manner similar to that described in connection with the receiver function at the UE 4002. The receiver 4052 receives a signal through its respective antenna(s) 4056. The receiver 4052 recovers information modulated onto an RF carrier and provides the information to the one or more processors 4084.

In the uplink, the one or more processors 4084 provides demultiplexing between transport and logical channels, packet reassembly, deciphering, header decompression, control signal processing to recover IP packets from the UE 4002. IP packets from the one or more processors 4084 may be provided to the core network. The one or more processors 4084 are also responsible for error detection.

For convenience, the UE 4002, the base station 4004, and/or the network entity 4006 are shown in FIGS. 40A, 40B, and 40C as including various components that may be configured according to the various examples described herein. It will be appreciated, however, that the illustrated components may have different functionality in different designs. In particular, various components in FIGS. 40A to 40C are optional in alternative configurations and the various aspects include configurations that may vary due to design choice, costs, use of the device, or other considerations. For example, in case of FIG. 40A, a particular implementation of UE 4002 may omit the WWAN transceiver(s) 4010 (e.g., a wearable device or tablet computer or PC or laptop may have Wi-Fi and/or Bluetooth capability without cellular capability), or may omit the short-range wireless transceiver(s) 4020 (e.g., cellular-only, etc.), or may omit the satellite signal receiver 4030, or may omit the sensor(s) 4044, and so on. In another example, in case of FIG. 40B, a particular implementation of the base station 4004 may omit the WWAN transceiver(s) 4050 (e.g., a Wi-Fi “hotspot” access point without cellular capability), or may omit the short-range wireless transceiver(s) 4060 (e.g., cellular-only, etc.), or may omit the satellite signal receiver 4070, and so on. For brevity, illustration of the various alternative configurations is not provided herein, but would be readily understandable to one skilled in the art.

The various components of the UE 4002, the base station 4004, and the network entity 4006 may be communicatively coupled to each other over data buses 4034, 4082, and 4092, respectively. In an aspect, the data buses 4034, 4082, and 4092 may form, or be part of, a communication interface of the UE 4002, the base station 4004, and the network entity 4006, respectively. For example, where different logical entities are embodied in the same device (e.g., gNB and location server functionality incorporated into the same base station 4004), the data buses 4034, 4082, and 4092 may provide communication between them.

The components of FIGS. 40A, 40B, and 40C may be implemented in various ways. In some implementations, the components of FIGS. 40A, 40B, and 40C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 4010 to 4046 may be implemented by processor and memory component(s) of the UE 4002 (e.g., by execution of appropriate code and/or by appropriate configuration of processor components). Similarly, some or all of the functionality represented by blocks 4050 to 4088 may be implemented by processor and memory component(s) of the base station 4004 (e.g., by execution of appropriate code and/or by appropriate configuration of processor components). Also, some or all of the functionality represented by blocks 4090 to 4098 may be implemented by processor and memory component(s) of the network entity 4006 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 4002, base station 4004, network entity 4006, etc., such as the processors 4032, 4084, 4094, the transceivers 4010, 4020, 4050, and 4060, the memories 4040, 4086, and 4096, the SLPP component 4042, 4088, and 4098, etc.

In some designs, the network entity 4006 may be implemented as a core network component. In other designs, the network entity 4006 may be distinct from a network operator or operation of the cellular network infrastructure (e.g., NG RAN and/or 5GC). For example, the network entity 4006 may be a component of a private network that may be configured to communicate with the UE 4002 via the base station 4004 or independently from the base station 4004 (e.g., over a non-cellular communication link, such as WiFi).

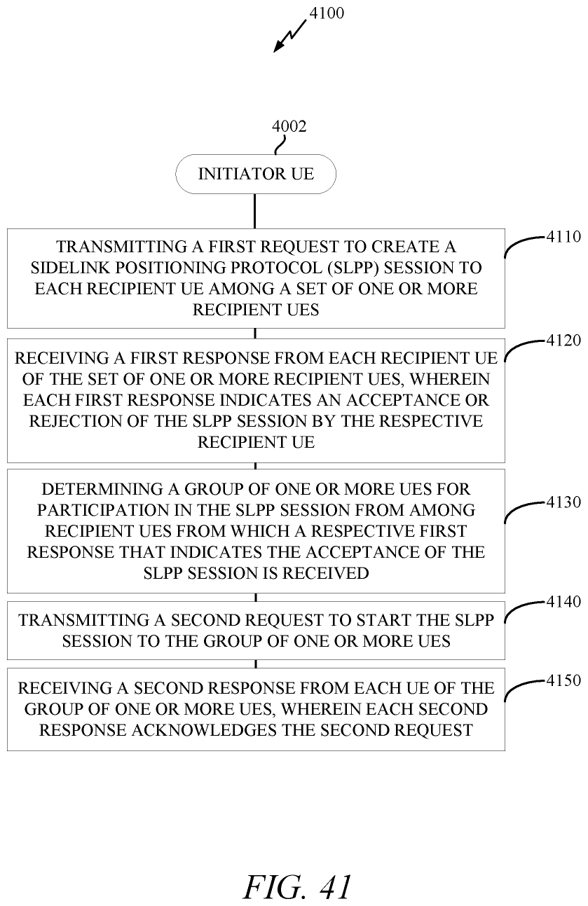

FIG. 41 illustrates an exemplary process 4100 of communications according to an aspect of the disclosure. The process 4100 of FIG. 41 is performed by a UE, such as UE 4002. In particular, the process 4100 of FIG. 41 is performed by an initiator UE (e.g., an initiator of an SLPP session), as described above. In some designs, the process 4100 of FIG. 41 may be performed during the device & service discovery described above.

Referring to FIG. 41, at 4110, the initiator UE (e.g., transmitter 4014 or 4024, etc.) transmits a first request to create a sidelink positioning protocol (SLPP) session to each recipient UE among a set of one or more recipient UEs.

Referring to FIG. 41, at 4120, the initiator UE (e.g., receiver 4012 or 4022, etc.) receives a first response from each recipient UE of the set of one or more recipient UEs, wherein each first response indicates an acceptance or rejection of the SLPP session by the respective recipient UE.

Referring to FIG. 41, at 4130, the initiator UE (e.g., processor(s) 4032, SLPP component 4042, etc.) determines a group of one or more UEs for participation in the SLPP session from among recipient UEs from which a respective first response that indicates the acceptance of the SLPP session is received (e.g., based on signal strength, based on a spatial or distance separation parameter for UEs in the group, etc.).

Referring to FIG. 41, at 4140, the initiator UE (e.g., transmitter 4014 or 4024, etc.) transmits a second request to start the SLPP session to the group of one or more UEs.

Referring to FIG. 41, at 4150, the initiator UE (e.g., receiver 4012 or 4022, etc.) receives second responses from the group of one or more UEs that each acknowledge the second request.

Referring to FIG. 41, in some designs, the first request is transmitted via unicast, groupcast, or broadcast, or each first response is received via unicast, groupcast, broadcast, or a combination thereof, or the second request is transmitted via unicast, groupcast, or broadcast, or each second response is received via unicast, groupcast, broadcast, or a combination thereof, or any combination thereof.

Referring to FIG. 41, in some designs, the first request comprises a session identifier associated with the SLPP session.

Referring to FIG. 41, in some designs, the first request comprises an Layer-2 (L2) group identifier associated with the SLPP session.

Referring to FIG. 41, in some designs, the group of one or more UEs includes each recipient UE that indicates the acceptance of the SLPP session via a respective first response (e.g., all accepting recipient UEs, while in alternative embodiments the fastest N responding UEs or all accepting recipient UEs that respond within some time window are added to the group, etc.), or the group of one or more UEs omits one or more recipient UEs that indicate the rejection of the SLPP session via one or more respective first responses (e.g., because not all recipient UEs may accept the first request, etc.). In some designs, the initiator UE further transmits (e.g., during the SLPP session) a third request to modify the SLPP session to the group of one or more UEs and to any new recipient UE to be added to the group of one or more UEs which indicates whether the respective recipient UE will be included or excluded in the modified SLPP session associated with a modified group of one or more UEs. In some designs, the modified group of one or more UEs includes each recipient UE that indicates the acceptance of the modified SLPP session via a respective third response, or the modified group of one or more UEs omits one or more recipient UEs that indicate the rejection of the modified SLPP session via one or more respective third responses.

Referring to FIG. 41, in some designs, the second request comprises Layer-2 (L2) and Layer-3 (L3) (e.g., application layer) identifiers associated with the SLPP session, a UE identifier associated with the initiator UE, and a UE identifier associated with each UE in the group of one or more UEs.

Referring to FIG. 41, in some designs, the initiator UE may further obtain a set of sidelink positioning reference signal (SL-PRS) measurements associated with the SLPP session, and determine a position estimate for the initiator UE, one or more UEs in the group of one or more UEs, or a combination thereof, based on the set of SL-PRS measurements. Note that the initiator UE may directly measure some or all of the SL-PRS measurements itself, or may alternatively other UE(s) may directly measure some or all of the SL-PRS measurements, which are then communicated (in whole or in part) to the initiator UE. A combination of these approaches is also possible. In some designs, one or more position estimates for the one or more UEs are determined and transmitted to the one or more UEs.

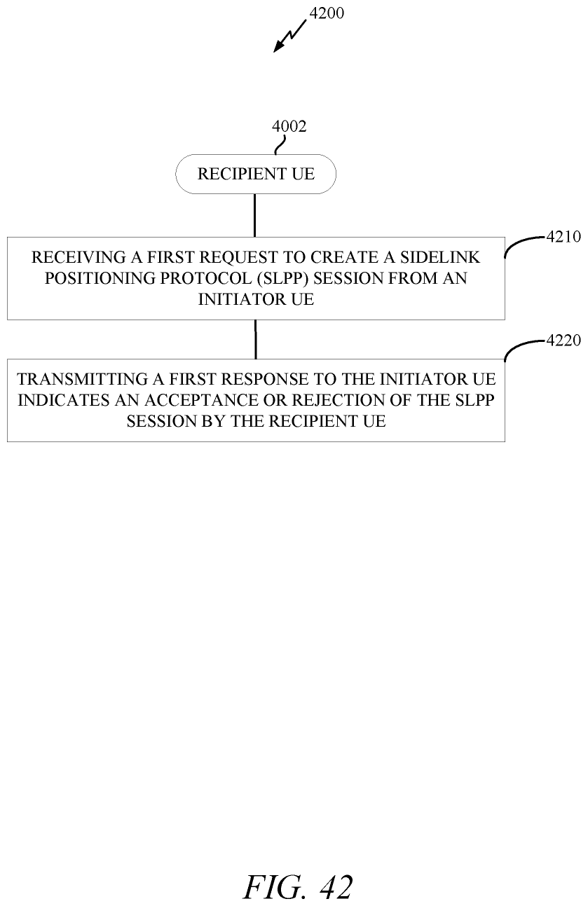

FIG. 42 illustrates an exemplary process 4200 of communications according to an aspect of the disclosure. The process 4200 of FIG. 42 is performed by a UE, such as UE 4002. In particular, the process 4200 of FIG. 42 is performed by a recipient UE, as described above. In some designs, the process 4200 of FIG. 42 may be performed during the device & service discovery described above. In some designs, the process 4200 of FIG. 42 may be performed in conjunction with the process 4100 of FIG. 42.

Referring to FIG. 42, at 4210, the recipient UE (e.g., receiver 4012 or 4022, etc.) receives a first request to create a sidelink positioning protocol (SLPP) session from an initiator UE.

Referring to FIG. 42, at 4220, the recipient UE (e.g., transmitter 4014 or 4024, etc.) transmits a first response to the initiator UE indicates an acceptance or rejection of the SLPP session by the recipient UE.

Referring to FIG. 42, in some designs, the first response indicates the acceptance of the SLPP session by the recipient UE. In some designs, the recipient UE may further receive a second request to start the SLPP session from the initiator UE, and transmit a second response that acknowledges the second request. In some designs, the second request is received via unicast, groupcast, or broadcast, or the second response is transmitted via unicast, groupcast, or broadcast, or any combination thereof. In some designs, the second request comprises Layer-2 (L2) and Layer-3 (L3) (e.g., application layer) identifiers associated with the SLPP session, a UE identifier associated with the initiator UE, and a UE identifier associated with each UE in a group of one or more UEs associated with the SLPP session. In some designs, the recipient UE may further receive (e.g., during the SLPP session) a third request from the initiator UE to modify the SLPP session, the third request indicating whether the recipient UE will be included or excluded in the modified SLPP session. In some designs, the recipient UE may further transmit a third response to the initiator UE indicates an acceptance or rejection or acknowledgment of the modified SLPP session by the recipient UE. In some designs, the recipient UE may further transmit sidelink positioning reference signal (SL-PRS) measurements associated with the SLPP session to the initiator UE. In some designs, the recipient UE may further receive a position estimate of the recipient UE from the initiator UE.

Referring to FIG. 42, in some designs, the first request is received via unicast, groupcast, or broadcast, or the first response is transmitted via unicast, groupcast, or broadcast, or any combination thereof. In some designs, the first request comprises a session identifier associated with the SLPP session. In some designs, the first request comprises a set of group identifiers associated with the SLPP session.

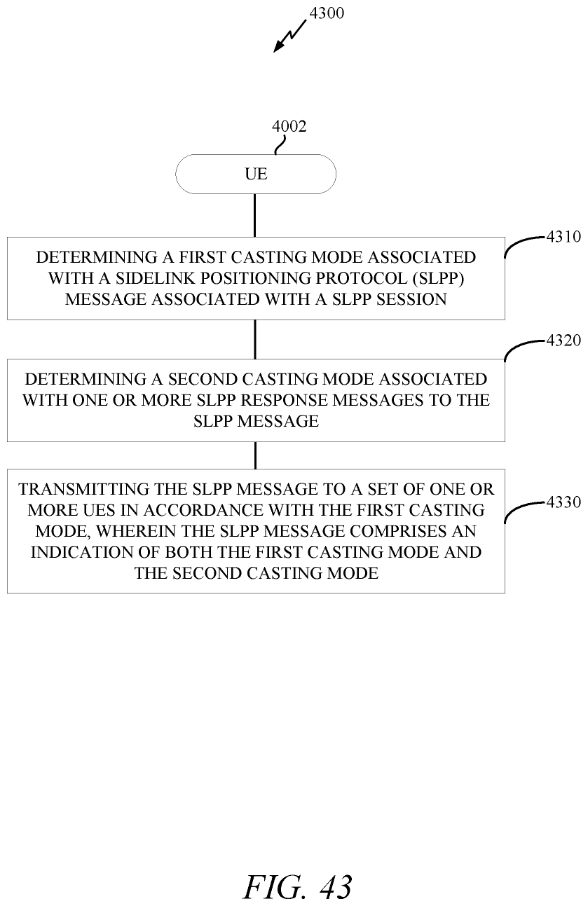

FIG. 43 illustrates an exemplary process 4300 of communications according to an aspect of the disclosure. The process 4300 of FIG. 43 is performed by a UE, such as UE 4002. In some designs, the UE that performs the process of FIG. 43 may be either an initiator UE or a recipient UE.

Referring to FIG. 43, at 4310, the UE (e.g., processor(s) 4032, SLPP component 4042, etc.) determines a first casting mode associated with a sidelink positioning protocol (SLPP) message associated with a SLPP session. As used herein, a “casting mode” is used interchangeably with a “cast type”, e.g., unicast, groupcast, or broadcast.

Referring to FIG. 43, at 4320, the UE (e.g., processor(s) 4032, SLPP component 4042, etc.) determines a second casting mode associated with one or more SLPP response messages to the SLPP message. Note that not all SLPP messages are necessarily configured to trigger such response(s)

Referring to FIG. 43, at 4330, the UE (e.g., transmitter 4014 or 4024, etc.) transmits the SLPP message to a set of one or more UEs in accordance with the first casting mode. In an aspect, the SLPP message comprises an indication of both the first casting mode and the second casting mode.

Referring to FIG. 43, in some designs, the first casting mode is unicast, groupcast, or broadcast, and the second casting mode is unicast, groupcast, or broadcast.

Referring to FIG. 43, in some designs, the first casting mode is unicast, and the set of one or more UEs comprises a single target UE. In some designs, the SLPP message comprises a session identifier for the SLPP session, a first set of identifiers associated with the UE, a second set of identifiers associated with the target UE. In some designs, the second casting mode is unicast, and the SLPP message further comprises an indication of the second casting mode or the second casting mode is implicitly indicated from the first casting mode. In an aspect, the UE may further receive a response to the SLPP message from the target UE via unicast.

Referring to FIG. 43, in some designs, the first casting mode is groupcast, and the set of one or more UEs comprises a group of one or more UEs. In some designs, the SLPP message comprises a session identifier for the SLPP session, and a set of group identifiers associated with the SLPP session. In some designs, the second casting mode is groupcast, and the SLPP message further comprises an indication of the second casting mode or the second casting mode is implicitly indicated from the first casting mode. In this case, in an aspect, the UE may further receive a response to the SLPP message from at least one UE in the group of one or more UEs via groupcast. In other designs, the second casting mode is unicast, and the SLPP message further comprises an indication of the second casting mode. In this case, in an aspect, the UE may further receive a response to the SLPP message from at least one UE in the group of one or more UEs via unicast.

Referring to FIG. 43, in some designs, the first casting mode is broadcast. In some designs, the SLPP message comprises a session identifier for the SLPP session. In some designs, the second casting mode is broadcast, and the SLPP message further comprises an indication of the second casting mode or the second casting mode is implicitly indicated from the first casting mode. In some designs, the UE may further receive a response to the SLPP message from at least one UE in the set of one or more UEs via broadcast.

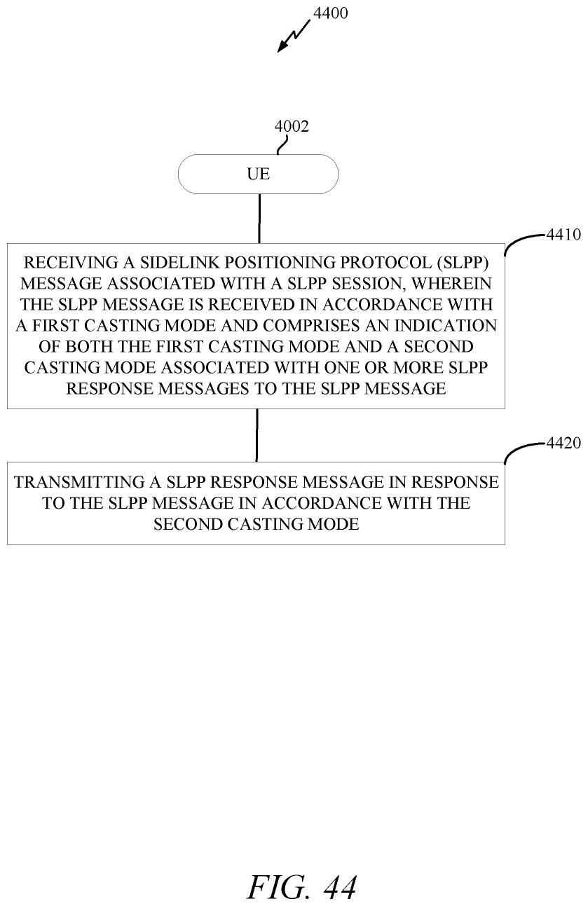

FIG. 44 illustrates an exemplary process 4400 of communications according to an aspect of the disclosure. The process 4400 of FIG. 44 is performed by a UE, such as UE 4002. In some designs, the UE that performs the process of FIG. 44 may be either an initiator UE or a recipient UE. In some designs, the process 4400 of FIG. 44 may be performed in conjunction with the process 4300 of FIG. 43.

Referring to FIG. 44, at 4410, the UE (e.g., receiver 4012 or 4022, etc.) receives a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message.

Referring to FIG. 44, at 4420, the UE (e.g., transmitter 4014 or 4024, etc.) transmits a SLPP response message in response to the SLPP message in accordance with the second casting mode.

Referring to FIG. 44, in some designs, the first casting mode is unicast, groupcast, or broadcast, and the second casting mode is unicast, groupcast, or broadcast.

Referring to FIG. 44, in some designs, the first casting mode is unicast, and the set of one or more UEs comprises a single target UE. In some designs, the SLPP message comprises a session identifier for the SLPP session, a first set of identifiers associated with the UE, a second set of identifiers associated with the target UE. In some designs, the SLPP message further comprises an indication of the second casting mode or the second casting mode is implicitly indicated from the first casting mode, the second casting mode is unicast.

Referring to FIG. 44, in some designs, the first casting mode is groupcast, and the set of one or more UEs comprises a group of one or more UEs. In some designs, the SLPP message comprises a session identifier for the SLPP session, and a set of group identifiers associated with the SLPP session. In some designs, the SLPP message further comprises an indication of the second casting mode or the second casting mode is implicitly indicated from the first casting mode, the second casting mode is groupcast. In other designs, the SLPP message further comprises an indication of the second casting mode or the second casting mode is implicitly indicated from the first casting mode, the second casting mode is unicast.

Referring to FIG. 44, in some designs, the first casting mode is broadcast. In some designs, the SLPP message comprises a session identifier for the SLPP session. In some designs, the SLPP message further comprises an indication of the second casting mode or the second casting mode is implicitly indicated from the first casting mode, the second casting mode is broadcast.

Referring to FIG. 44, in some designs, SLPP may support at least the following generic transaction modes:
Unicast transaction,
Group Transaction with Group Replies,
Group Transaction with Unicast Replies, and
Broadcast Transaction.

In the detailed description above it can be seen that different features are grouped together in examples. This manner of disclosure may not be understood as an intention that the example clauses have more features than are explicitly mentioned in each clause. Rather, the various aspects of the disclosure may include fewer than all features of an individual example clause disclosed. Therefore, the following clauses may hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating an initiator user equipment (UE), comprising: transmitting a first request to create a sidelink positioning protocol (SLPP) session to each recipient UE among a set of one or more recipient UEs; receiving first responses from the set of one or more recipient UEs that each indicate an acceptance or rejection of the SLPP session by the recipient UE; determining a group of one or more UEs for participation in the SLPP session from among recipient UEs from which a respective first response that indicates the acceptance of the SLPP session is received; transmitting a second request to start the SLPP session to the group of one or more UEs; and receiving second responses from the group of one or more UEs that each acknowledge the second request.

Clause 2. The method of clause 1, wherein the first request is transmitted via unicast, groupcast, or broadcast, or wherein the first responses are received via unicast, groupcast, broadcast, or a combination thereof, or wherein the second request is transmitted via unicast, groupcast, or broadcast, or wherein the second responses are received via unicast, groupcast, broadcast, or a combination thereof, or any combination thereof.

Clause 3. The method of any of clauses 1 to 2, wherein the first request comprises a session identifier associated with the SLPP session.

Clause 4. The method of any of clauses 1 to 3, wherein the first request comprises an L2 group identifier associated with the SLPP session.

Clause 5. The method of any of clauses 1 to 4, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Clause 6. The method of clause 5, further comprising: transmitting a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Clause 7. The method of clause 6, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Clause 8. The method of any of clauses 1 to 7, wherein the second request comprises L2 and L3 identifiers associated with the SLPP session, a UE identifier associated with the initiator UE, and a UE identifier associated with each UE in the group of one or more UEs.

Clause 9. The method of any of clauses 1 to 8, further comprising: obtaining a set of sidelink positioning reference signal (SL-PRS) measurements associated with the SLPP session; and determining a position estimate for the initiator UE, one or more UEs in the group of one or more UEs, or a combination thereof, based on the set of SL-PRS measurements.

Clause 10. The method of clause 9, wherein one or more position estimates for the one or more UEs are determined and transmitted to the one or more UEs.

Clause 11. A method of operating a recipient user equipment (UE), comprising: receiving a first request to create a sidelink positioning protocol (SLPP) session from an initiator UE; and transmitting a first response to the initiator UE indicates an acceptance or rejection of the SLPP session by the recipient UE.

Clause 12. The method of clause 11, wherein the first response indicates the acceptance of the SLPP session by the recipient UE.

Clause 13. The method of clause 12, further comprising: receiving a second request to start the SLPP session from the initiator UE; and transmitting a second response that acknowledges the second request.

Clause 14. The method of clause 13, wherein the second request is received via unicast, groupcast, or broadcast, or wherein the second response is transmitted via unicast, groupcast, or broadcast, or any combination thereof.

Clause 15. The method of any of clauses 13 to 14, wherein the second request comprises L2 and L3 identifiers associated with the SLPP session, a UE identifier associated with the initiator UE, and a UE identifier associated with each UE in a group of one or more UEs associated with the SLPP session.

Clause 16. The method of any of clauses 12 to 15, further comprising: receiving a third request from the initiator UE to modify the SLPP session that indicates whether the recipient UE will be included or excluded in the modified SLPP session.

Clause 17. The method of clause 16, transmitting a third response to the initiator UE indicates an acceptance or rejection or acknowledgment of the modified SLPP session by the recipient UE.

Clause 18. The method of any of clauses 12 to 17, further comprising: transmitting sidelink positioning reference signal (SL-PRS) measurements associated with the SLPP session to the initiator UE.

Clause 19. The method of any of clauses 12 to 18, further comprising: receiving a position estimate of the recipient UE from the initiator UE.

Clause 20. The method of any of clauses 11 to 19, wherein the first request is received via unicast, groupcast, or broadcast, or wherein the first response is transmitted via unicast, groupcast, or broadcast, or any combination thereof.

Clause 21. The method of any of clauses 11 to 20, wherein the first request comprises a session identifier associated with the SLPP session.

Clause 22. The method of clause 21, wherein the first request comprises a set of group identifiers associated with the SLPP session.

Clause 23. A method of operating a user equipment (UE), comprising: determining a first casting mode associated with a sidelink positioning protocol (SLPP) message associated with a SLPP session; selectively determining a second casting mode associated with any SLPP response message to the SLPP message based on whether the SLPP message is configured to trigger a response; and transmitting the SLPP message to a set of one or more UEs in accordance with the first casting mode, wherein the SLPP message comprises an indication of the first casting mode or both the first casting mode and the second casting mode.

Clause 24. The method of clause 23, wherein the first casting mode is unicast, groupcast, or broadcast, and wherein the second casting mode is unicast, groupcast, or broadcast.

Clause 25. The method of any of clauses 23 to 24, wherein the first casting mode is unicast, and wherein the set of one or more UEs comprises a single target UE.

Clause 26. The method of clause 25, wherein the SLPP message comprises a session identifier for the SLPP session, a first set of identifiers associated with the UE, a second set of identifiers associated with the target UE.

Clause 27. The method of any of clauses 25 to 26, wherein the selective determination determines the second casting mode is unicast, and wherein the SLPP message further comprises an indication of the second casting mode or the second casting mode is implicitly indicated from the first casting mode, further comprising: receiving a response to the SLPP message from the target UE via unicast.

Clause 28. The method of any of clauses 23 to 27, wherein the first casting mode is groupcast, and wherein the set of one or more UEs comprises a group of one or more UEs.

Clause 29. The method of clause 28, wherein the SLPP message comprises a session identifier for the SLPP session, and a set of group identifiers associated with the SLPP session.

Clause 30. The method of any of clauses 28 to 29, wherein the selective determination determines the second casting mode is groupcast, and wherein the SLPP message further comprises an indication of the second casting mode or the second casting mode is implicitly indicated from the first casting mode, further comprising: receiving a response to the SLPP message from at least one UE in the group of one or more UEs via groupcast.

Clause 31. The method of any of clauses 28 to 30, wherein the selective determination determines the second casting mode is unicast, and wherein the SLPP message further comprises an indication of the second casting mode, further comprising: receiving a response to the SLPP message from at least one UE in the group of one or more UEs via unicast.

Clause 32. The method of any of clauses 23 to 31, wherein the first casting mode is broadcast.

Clause 33. The method of clause 32, wherein the SLPP message comprises a session identifier for the SLPP session.

Clause 34. The method of any of clauses 32 to 33, wherein the selective determination determines the second casting mode is broadcast, and wherein the SLPP message further comprises an indication of the second casting mode or the second casting mode is implicitly indicated from the first casting mode, further comprising: receiving a response to the SLPP message from at least one UE in the set of one or more UEs via broadcast.

Clause 35. A method of operating a user equipment (UE), comprising: receiving a sidelink positioning protocol (SLPP) message associated with a SLPP session, wherein the SLPP message is received in accordance with a first casting mode and comprises an indication of the first casting mode or both the first casting mode and a second casting mode associated with any SLPP response message to the SLPP message; and determining whether to respond to the SLPP message in accordance with the second casting mode based on whether the SLPP message is configured to trigger a response.

Clause 36. The method of clause 35, wherein the first casting mode is unicast, groupcast, or broadcast, and wherein the second casting mode is unicast, groupcast, or broadcast.

Clause 37. The method of any of clauses 35 to 36, wherein the first casting mode is unicast.

Clause 38. The method of clause 37, wherein the SLPP message comprises a session identifier for the SLPP session, a first set of identifiers associated with another UE, a second set of identifiers associated with the UE.

Clause 39. The method of any of clauses 37 to 38, wherein the SLPP message further comprises an indication of the second casting mode or the second casting mode is implicitly indicated from the first casting mode, wherein the second casting mode is unicast, and wherein the determination is to respond to the SLPP message via unicast.

Clause 40. The method of any of clauses 35 to 39, wherein the first casting mode is groupcast.

Clause 41. The method of clause 40, wherein the SLPP message comprises a session identifier for the SLPP session, and a set of group identifiers associated with the SLPP session.

Clause 42. The method of any of clauses 40 to 41, wherein the SLPP message further comprises an indication of the second casting mode or the second casting mode is implicitly indicated from the first casting mode, wherein the second casting mode is groupcast, and wherein the determination is to respond to the SLPP message via groupcast.

Clause 43. The method of any of clauses 40 to 42, wherein the SLPP message further comprises an indication of the second casting mode or the second casting mode is implicitly indicated from the first casting mode, wherein the second casting mode is unicast, and wherein the determination is to respond to the SLPP message via unicast.

Clause 44. The method of any of clauses 35 to 43, wherein the first casting mode is broadcast.

Clause 45. The method of clause 44, wherein the SLPP message comprises a session identifier for the SLPP session.

Clause 46. The method of any of clauses 44 to 45, wherein the SLPP message further comprises an indication of the second casting mode or the second casting mode is implicitly indicated from the first casting mode, wherein the second casting mode is broadcast, and wherein the determination is to respond to the SLPP message via broadcast.

Clause 47. An initiator user equipment (UE), comprising: a memory; and at least one processor communicatively coupled to the memory, the at least one processor configured to: transmit a first request to create a sidelink positioning protocol (SLPP) session to each recipient UE among a set of one or more recipient UEs; receive first responses from the set of one or more recipient UEs that each indicate an acceptance or rejection of the SLPP session by the recipient UE; determine a group of one or more UEs for participation in the SLPP session from among recipient UEs from which a respective first response that indicates the acceptance of the SLPP session is received; transmit a second request to start the SLPP session to the group of one or more UEs; and receive second responses from the group of one or more UEs that each acknowledge the second request.

Clause 48. The initiator UE of clause 47, wherein the first request is transmitted via unicast, groupcast, or broadcast, or wherein the first responses are received via unicast, groupcast, broadcast, or a combination thereof, or wherein the second request is transmitted via unicast, groupcast, or broadcast, or wherein the second responses are received via unicast, groupcast, broadcast, or a combination thereof, or any combination thereof.

Clause 49. The initiator UE of any of clauses 47 to 48, wherein the first request comprises a session identifier associated with the SLPP session.

Clause 50. The initiator UE of any of clauses 47 to 49, wherein the first request comprises an L2 group identifier associated with the SLPP session.

Clause 51. The initiator UE of any of clauses 47 to 50, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Clause 52. The initiator UE of clause 51, wherein the at least one processor is further configured to: transmit a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Clause 53. The initiator UE of clause 52, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Clause 54. The initiator UE of any of clauses 47 to 53, wherein the second request comprises L2 and L3 identifiers associated with the SLPP session, a UE identifier associated with the initiator UE, and a UE identifier associated with each UE in the group of one or more UEs.

Clause 55. The initiator UE of any of clauses 47 to 54, wherein the at least one processor is further configured to: obtain a set of sidelink positioning reference signal (SL-PRS) measurements associated with the SLPP session; and determine a position estimate for the initiator UE, one or more UEs in the group of one or more UEs, or a combination thereof, based on the set of SL-PRS measurements.

Clause 56. The initiator UE of clause 55, wherein one or more position estimates for the one or more UEs are determined and transmitted to the one or more UEs.

Clause 57. A recipient user equipment (UE), comprising: a memory; and at least one processor communicatively coupled to the memory, the at least one processor configured to: receive a first request to create a sidelink positioning protocol (SLPP) session from an initiator UE; and transmit a first response to the initiator UE indicates an acceptance or rejection of the SLPP session by the recipient UE.

Clause 58. The recipient UE of clause 57, wherein the first response indicates the acceptance of the SLPP session by the recipient UE.

Clause 59. The recipient UE of clause 58, wherein the at least one processor is further configured to: receive a second request to start the SLPP session from the initiator UE; and transmit a second response that acknowledges the second request.

Clause 60. The recipient UE of clause 59, wherein the second request is received via unicast, groupcast, or broadcast, or wherein the second response is transmitted via unicast, groupcast, or broadcast, or any combination thereof.

Clause 61. The recipient UE of any of clauses 59 to 60, wherein the second request comprises L2 and L3 identifiers associated with the SLPP session, a UE identifier associated with the initiator UE, and a UE identifier associated with each UE in a group of one or more UEs associated with the SLPP session.

Clause 62. The recipient UE of any of clauses 58 to 61, wherein the at least one processor is further configured to: receive a third request from the initiator UE to modify the SLPP session that indicates whether the recipient UE will be included or excluded in the modified SLPP session.

Clause 63. The recipient UE of clause 62, transmit a third response to the initiator UE indicates an acceptance or rejection or acknowledgment of the modified SLPP session by the recipient UE.

Clause 64. The recipient UE of any of clauses 58 to 63, wherein the at least one processor is further configured to: transmit sidelink positioning reference signal (SL-PRS) measurements associated with the SLPP session to the initiator UE.

Clause 65. The recipient UE of any of clauses 58 to 64, wherein the at least one processor is further configured to: receive a position estimate of the recipient UE from the initiator UE.

Clause 66. The recipient UE of any of clauses 57 to 65, wherein the first request is received via unicast, groupcast, or broadcast, or wherein the first response is transmitted via unicast, groupcast, or broadcast, or any combination thereof.

Clause 67. The recipient UE of any of clauses 57 to 66, wherein the first request comprises a session identifier associated with the SLPP session.

Clause 68. The recipient UE of clause 67, wherein the first request comprises a set of group identifiers associated with the SLPP session.

Clause 69. A user equipment (UE), comprising: a memory; and at least one processor communicatively coupled to the memory, the at least one processor configured to: determine a first casting mode associated with a sidelink positioning protocol (SLPP) message associated with a SLPP session; selectively determine a second casting mode associated with any SLPP response message to the SLPP message based on whether the SLPP message is configured to trigger a response; and transmit the SLPP message to a set of one or more UEs in accordance with the first casting mode, wherein the SLPP message comprises an indication of the first casting mode or both the first casting mode and the second casting mode.

Clause 70. The UE of clause 69, wherein the first casting mode is unicast, groupcast, or broadcast, and wherein the second casting mode is unicast, groupcast, or broadcast.

Clause 71. The UE of any of clauses 69 to 70, wherein the first casting mode is unicast, and wherein the set of one or more UEs comprises a single target UE.

Clause 72. The UE of clause 71, wherein the SLPP message comprises a session identifier for the SLPP session, a first set of identifiers associated with the UE, a second set of identifiers associated with the target UE.

Clause 73. The UE of any of clauses 71 to 72, wherein the selective determination determines the second casting mode is unicast, and wherein the SLPP message further comprises an indication of the second casting mode or the second casting mode is implicitly indicated from the first casting mode, further comprising: receive a response to the SLPP message from the target UE via unicast.

Clause 74. The UE of any of clauses 69 to 73, wherein the first casting mode is groupcast, and wherein the set of one or more UEs comprises a group of one or more UEs.

Clause 75. The UE of clause 74, wherein the SLPP message comprises a session identifier for the SLPP session, and a set of group identifiers associated with the SLPP session.

Clause 76. The UE of any of clauses 74 to 75, wherein the selective determination determines the second casting mode is groupcast, and wherein the SLPP message further comprises an indication of the second casting mode or the second casting mode is implicitly indicated from the first casting mode, further comprising: receive a response to the SLPP message from at least one UE in the group of one or more UEs via groupcast.

Clause 77. The UE of any of clauses 74 to 76, wherein the selective determination determines the second casting mode is unicast, and wherein the SLPP message further comprises an indication of the second casting mode, further comprising: receive a response to the SLPP message from at least one UE in the group of one or more UEs via unicast.

Clause 78. The UE of any of clauses 69 to 77, wherein the first casting mode is broadcast.

Clause 79. The UE of clause 78, wherein the SLPP message comprises a session identifier for the SLPP session.

Clause 80. The UE of any of clauses 78 to 79, wherein the selective determination determines the second casting mode is broadcast, and wherein the SLPP message further comprises an indication of the second casting mode or the second casting mode is implicitly indicated from the first casting mode, further comprising: receive a response to the SLPP message from at least one UE in the set of one or more UEs via broadcast.

Clause 81. A user equipment (UE), comprising: a memory; and at least one processor communicatively coupled to the memory, the at least one processor configured to: receive a sidelink positioning protocol (SLPP) message associated with a SLPP session, wherein the SLPP message is received in accordance with a first casting mode and comprises an indication of the first casting mode or both the first casting mode and a second casting mode associated with any SLPP response message to the SLPP message; and determine whether to respond to the SLPP message in accordance with the second casting mode based on whether the SLPP message is configured to trigger a response.

Clause 82. The UE of clause 81, wherein the first casting mode is unicast, groupcast, or broadcast, and wherein the second casting mode is unicast, groupcast, or broadcast.

Clause 83. The UE of any of clauses 81 to 82, wherein the first casting mode is unicast.

Clause 84. The UE of clause 83, wherein the SLPP message comprises a session identifier for the SLPP session, a first set of identifiers associated with another UE, a second set of identifiers associated with the UE.

Clause 85. The UE of any of clauses 83 to 84, wherein the SLPP message further comprises an indication of the second casting mode or the second casting mode is implicitly indicated from the first casting mode, wherein the second casting mode is unicast, and wherein the determination is to respond to the SLPP message via unicast.

Clause 86. The UE of any of clauses 81 to 85, wherein the first casting mode is groupcast.

Clause 87. The UE of clause 86, wherein the SLPP message comprises a session identifier for the SLPP session, and a set of group identifiers associated with the SLPP session.

Clause 88. The UE of any of clauses 86 to 87, wherein the SLPP message further comprises an indication of the second casting mode or the second casting mode is implicitly indicated from the first casting mode, wherein the second casting mode is groupcast, and wherein the determination is to respond to the SLPP message via groupcast.

Clause 89. The UE of any of clauses 86 to 88, wherein the SLPP message further comprises an indication of the second casting mode or the second casting mode is implicitly indicated from the first casting mode, wherein the second casting mode is unicast, and wherein the determination is to respond to the SLPP message via unicast.

Clause 90. The UE of any of clauses 81 to 89, wherein the first casting mode is broadcast.

Clause 91. The UE of clause 90, wherein the SLPP message comprises a session identifier for the SLPP session.

Clause 92. The UE of any of clauses 90 to 91, wherein the SLPP message further comprises an indication of the second casting mode or the second casting mode is implicitly indicated from the first casting mode, wherein the second casting mode is broadcast, and wherein the determination is to respond to the SLPP message via broadcast.

Clause 93. An initiator user equipment (UE), comprising: means for transmitting a first request to create a sidelink positioning protocol (SLPP) session to each recipient UE among a set of one or more recipient UEs; means for receiving first responses from the set of one or more recipient UEs that each indicate an acceptance or rejection of the SLPP session by the recipient UE; means for determining a group of one or more UEs for participation in the SLPP session from among recipient UEs from which a respective first response that indicates the acceptance of the SLPP session is received; means for transmitting a second request to start the SLPP session to the group of one or more UEs; and means for receiving second responses from the group of one or more UEs that each acknowledge the second request.

Clause 94. The initiator UE of clause 93, wherein the first request is transmitted via unicast, groupcast, or broadcast, or wherein the first responses are received via unicast, groupcast, broadcast, or a combination thereof, or wherein the second request is transmitted via unicast, groupcast, or broadcast, or wherein the second responses are received via unicast, groupcast, broadcast, or a combination thereof, or any combination thereof.

Clause 95. The initiator UE of any of clauses 93 to 94, wherein the first request comprises a session identifier associated with the SLPP session.

Clause 96. The initiator UE of any of clauses 93 to 95, wherein the first request comprises an L2 group identifier associated with the SLPP session.

Clause 97. The initiator UE of any of clauses 93 to 96, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Clause 98. The initiator UE of clause 97, further comprising: means for transmitting a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Clause 99. The initiator UE of clause 98, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Clause 100. The initiator UE of any of clauses 93 to 99, wherein the second request comprises L2 and L3 identifiers associated with the SLPP session, a UE identifier associated with the initiator UE, and a UE identifier associated with each UE in the group of one or more UEs.

Clause 101. The initiator UE of any of clauses 93 to 100, further comprising: means for obtaining a set of sidelink positioning reference signal (SL-PRS) measurements associated with the SLPP session; and means for determining a position estimate for the initiator UE, one or more UEs in the group of one or more UEs, or a combination thereof, based on the set of SL-PRS measurements.

Clause 102. The initiator UE of clause 101, wherein one or more position estimates for the one or more UEs are determined and transmitted to the one or more UEs.

Clause 103. A recipient user equipment (UE), comprising: means for receiving a first request to create a sidelink positioning protocol (SLPP) session from an initiator UE; and means for transmitting a first response to the initiator UE indicates an acceptance or rejection of the SLPP session by the recipient UE.

Clause 104. The recipient UE of clause 103, wherein the first response indicates the acceptance of the SLPP session by the recipient UE.

Clause 105. The recipient UE of clause 104, further comprising: means for receiving a second request to start the SLPP session from the initiator UE; and means for transmitting a second response that acknowledges the second request.

Clause 106. The recipient UE of clause 105, wherein the second request is received via unicast, groupcast, or broadcast, or wherein the second response is transmitted via unicast, groupcast, or broadcast, or any combination thereof.

Clause 107. The recipient UE of any of clauses 105 to 106, wherein the second request comprises L2 and L3 identifiers associated with the SLPP session, a UE identifier associated with the initiator UE, and a UE identifier associated with each UE in a group of one or more UEs associated with the SLPP session.

Clause 108. The recipient UE of any of clauses 104 to 107, further comprising: means for receiving a third request from the initiator UE to modify the SLPP session that indicates whether the recipient UE will be included or excluded in the modified SLPP session.

Clause 109. The recipient UE of clause 108, means for transmitting a third response to the initiator UE indicates an acceptance or rejection or acknowledgment of the modified SLPP session by the recipient UE.

Clause 110. The recipient UE of any of clauses 104 to 109, further comprising: means for transmitting sidelink positioning reference signal (SL-PRS) measurements associated with the SLPP session to the initiator UE.

Clause 111. The recipient UE of any of clauses 104 to 110, further comprising: means for receiving a position estimate of the recipient UE from the initiator UE.

Clause 112. The recipient UE of any of clauses 103 to 111, wherein the first request is received via unicast, groupcast, or broadcast, or wherein the first response is transmitted via unicast, groupcast, or broadcast, or any combination thereof.

Clause 113. The recipient UE of any of clauses 103 to 112, wherein the first request comprises a session identifier associated with the SLPP session.

Clause 114. The recipient UE of clause 113, wherein the first request comprises a set of group identifiers associated with the SLPP session.

Clause 115. A user equipment (UE), comprising: means for determining a first casting mode associated with a sidelink positioning protocol (SLPP) message associated with a SLPP session; means for selectively determining a second casting mode associated with any SLPP response message to the SLPP message based on whether the SLPP message is configured to trigger a response; and means for transmitting the SLPP message to a set of one or more UEs in accordance with the first casting mode, wherein the SLPP message comprises an indication of the first casting mode or both the first casting mode and the second casting mode.

Clause 116. The UE of clause 115, wherein the first casting mode is unicast, groupcast, or broadcast, and wherein the second casting mode is unicast, groupcast, or broadcast.

Clause 117. The UE of any of clauses 115 to 116, wherein the first casting mode is unicast, and wherein the set of one or more UEs comprises a single target UE.

Clause 118. The UE of clause 117, wherein the SLPP message comprises a session identifier for the SLPP session, a first set of identifiers associated with the UE, a second set of identifiers associated with the target UE.

Clause 119. The UE of any of clauses 117 to 118, wherein the selective determination determines the second casting mode is unicast, and wherein the SLPP message further comprises an indication of the second casting mode or the second casting mode is implicitly indicated from the first casting mode, further comprising: means for receiving a response to the SLPP message from the target UE via unicast.

Clause 120. The UE of any of clauses 115 to 119, wherein the first casting mode is groupcast, and wherein the set of one or more UEs comprises a group of one or more UEs.

Clause 121. The UE of clause 120, wherein the SLPP message comprises a session identifier for the SLPP session, and a set of group identifiers associated with the SLPP session.

Clause 122. The UE of any of clauses 120 to 121, wherein the selective determination determines the second casting mode is groupcast, and wherein the SLPP message further comprises an indication of the second casting mode or the second casting mode is implicitly indicated from the first casting mode, further comprising: means for receiving a response to the SLPP message from at least one UE in the group of one or more UEs via groupcast.

Clause 123. The UE of any of clauses 120 to 122, wherein the selective determination determines the second casting mode is unicast, and wherein the SLPP message further comprises an indication of the second casting mode, further comprising: means for receiving a response to the SLPP message from at least one UE in the group of one or more UEs via unicast.

Clause 124. The UE of any of clauses 115 to 123, wherein the first casting mode is broadcast.

Clause 125. The UE of clause 124, wherein the SLPP message comprises a session identifier for the SLPP session.

Clause 126. The UE of any of clauses 124 to 125, wherein the selective determination determines the second casting mode is broadcast, and wherein the SLPP message further comprises an indication of the second casting mode or the second casting mode is implicitly indicated from the first casting mode, further comprising: means for receiving a response to the SLPP message from at least one UE in the set of one or more UEs via broadcast.

Clause 127. A user equipment (UE), comprising: means for receiving a sidelink positioning protocol (SLPP) message associated with a SLPP session, wherein the SLPP message is received in accordance with a first casting mode and comprises an indication of the first casting mode or both the first casting mode and a second casting mode associated with any SLPP response message to the SLPP message; and means for determining whether to respond to the SLPP message in accordance with the second casting mode based on whether the SLPP message is configured to trigger a response.

Clause 128. The UE of clause 127, wherein the first casting mode is unicast, groupcast, or broadcast, and wherein the second casting mode is unicast, groupcast, or broadcast.

Clause 129. The UE of any of clauses 127 to 128, wherein the first casting mode is unicast.

Clause 130. The UE of clause 129, wherein the SLPP message comprises a session identifier for the SLPP session, a first set of identifiers associated with another UE, a second set of identifiers associated with the UE.

Clause 131. The UE of any of clauses 129 to 130, wherein the SLPP message further comprises an indication of the second casting mode or the second casting mode is implicitly indicated from the first casting mode, wherein the second casting mode is unicast, and wherein the determination is to respond to the SLPP message via unicast.

Clause 132. The UE of any of clauses 127 to 131, wherein the first casting mode is groupcast.

Clause 133. The UE of clause 132, wherein the SLPP message comprises a session identifier for the SLPP session, and a set of group identifiers associated with the SLPP session.

Clause 134. The UE of any of clauses 132 to 133, wherein the SLPP message further comprises an indication of the second casting mode or the second casting mode is implicitly indicated from the first casting mode, wherein the second casting mode is groupcast, and wherein the determination is to respond to the SLPP message via groupcast.

Clause 135. The UE of any of clauses 132 to 134, wherein the SLPP message further comprises an indication of the second casting mode or the second casting mode is implicitly indicated from the first casting mode, wherein the second casting mode is unicast, and wherein the determination is to respond to the SLPP message via unicast.

Clause 136. The UE of any of clauses 127 to 135, wherein the first casting mode is broadcast.

Clause 137. The UE of clause 136, wherein the SLPP message comprises a session identifier for the SLPP session.

Clause 138. The UE of any of clauses 136 to 137, wherein the SLPP message further comprises an indication of the second casting mode or the second casting mode is implicitly indicated from the first casting mode, wherein the second casting mode is broadcast, and wherein the determination is to respond to the SLPP message via broadcast.

Clause 139. A non-transitory computer-readable medium storing computer-executable instructions that, when executed by an initiator user equipment (UE), cause the initiator UE to: transmit a first request to create a sidelink positioning protocol (SLPP) session to each recipient UE among a set of one or more recipient UEs; receive first responses from the set of one or more recipient UEs that each indicate an acceptance or rejection of the SLPP session by the recipient UE; determine a group of one or more UEs for participation in the SLPP session from among recipient UEs from which a respective first response that indicates the acceptance of the SLPP session is received; transmit a second request to start the SLPP session to the group of one or more UEs; and receive second responses from the group of one or more UEs that each acknowledge the second request.

Clause 140. The non-transitory computer-readable medium of clause 139, wherein the first request is transmitted via unicast, groupcast, or broadcast, or wherein the first responses are received via unicast, groupcast, broadcast, or a combination thereof, or wherein the second request is transmitted via unicast, groupcast, or broadcast, or wherein the second responses are received via unicast, groupcast, broadcast, or a combination thereof, or any combination thereof.

Clause 141. The non-transitory computer-readable medium of any of clauses 139 to 140, wherein the first request comprises a session identifier associated with the SLPP session.

Clause 142. The non-transitory computer-readable medium of any of clauses 139 to 141, wherein the first request comprises an L2 group identifier associated with the SLPP session.

Clause 143. The non-transitory computer-readable medium of any of clauses 139 to 142, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Clause 144. The non-transitory computer-readable medium of clause 143, further comprising computer-executable instructions that, when executed by the initiator UE, cause the initiator UE to: transmit a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Clause 145. The non-transitory computer-readable medium of clause 144, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Clause 146. The non-transitory computer-readable medium of any of clauses 139 to 145, wherein the second request comprises L2 and L3 identifiers associated with the SLPP session, a UE identifier associated with the initiator UE, and a UE identifier associated with each UE in the group of one or more UEs.

Clause 147. The non-transitory computer-readable medium of any of clauses 139 to 146, further comprising computer-executable instructions that, when executed by the initiator UE, cause the initiator UE to: obtain a set of sidelink positioning reference signal (SL-PRS) measurements associated with the SLPP session; and determine a position estimate for the initiator UE, one or more UEs in the group of one or more UEs, or a combination thereof, based on the set of SL-PRS measurements.

Clause 148. The non-transitory computer-readable medium of clause 147, wherein one or more position estimates for the one or more UEs are determined and transmitted to the one or more UEs.

Clause 149. A non-transitory computer-readable medium storing computer-executable instructions that, when executed by a recipient user equipment (UE), cause the recipient UE to: receive a first request to create a sidelink positioning protocol (SLPP) session from an initiator UE; and transmit a first response to the initiator UE indicates an acceptance or rejection of the SLPP session by the recipient UE.

Clause 150. The non-transitory computer-readable medium of clause 149, wherein the first response indicates the acceptance of the SLPP session by the recipient UE.

Clause 151. The non-transitory computer-readable medium of clause 150, further comprising computer-executable instructions that, when executed by the recipient UE, cause the recipient UE to: receive a second request to start the SLPP session from the initiator UE; and transmit a second response that acknowledges the second request.

Clause 152. The non-transitory computer-readable medium of clause 151, wherein the second request is received via unicast, groupcast, or broadcast, or wherein the second response is transmitted via unicast, groupcast, or broadcast, or any combination thereof.

Clause 153. The non-transitory computer-readable medium of any of clauses 151 to 152, wherein the second request comprises L2 and L3 identifiers associated with the SLPP session, a UE identifier associated with the initiator UE, and a UE identifier associated with each UE in a group of one or more UEs associated with the SLPP session.

Clause 154. The non-transitory computer-readable medium of any of clauses 150 to 153, further comprising computer-executable instructions that, when executed by the recipient UE, cause the recipient UE to: receive a third request from the initiator UE to modify the SLPP session that indicates whether the recipient UE will be included or excluded in the modified SLPP session.

Clause 155. The non-transitory computer-readable medium of clause 154, transmit a third response to the initiator UE indicates an acceptance or rejection or acknowledgment of the modified SLPP session by the recipient UE.

Clause 156. The non-transitory computer-readable medium of any of clauses 150 to 155, further comprising computer-executable instructions that, when executed by the recipient UE, cause the recipient UE to: transmit sidelink positioning reference signal (SL-PRS) measurements associated with the SLPP session to the initiator UE.

Clause 157. The non-transitory computer-readable medium of any of clauses 150 to 156, further comprising computer-executable instructions that, when executed by the recipient UE, cause the recipient UE to: receive a position estimate of the recipient UE from the initiator UE.

Clause 158. The non-transitory computer-readable medium of any of clauses 149 to 157, wherein the first request is received via unicast, groupcast, or broadcast, or wherein the first response is transmitted via unicast, groupcast, or broadcast, or any combination thereof.

Clause 159. The non-transitory computer-readable medium of any of clauses 149 to 158, wherein the first request comprises a session identifier associated with the SLPP session.

Clause 160. The non-transitory computer-readable medium of clause 159, wherein the first request comprises a set of group identifiers associated with the SLPP session.

Clause 161. A non-transitory computer-readable medium storing computer-executable instructions that, when executed by a user equipment (UE), cause the UE to: determine a first casting mode associated with a sidelink positioning protocol (SLPP) message associated with a SLPP session; selectively determine a second casting mode associated with any SLPP response message to the SLPP message based on whether the SLPP message is configured to trigger a response; and transmit the SLPP message to a set of one or more UEs in accordance with the first casting mode, wherein the SLPP message comprises an indication of the first casting mode or both the first casting mode and the second casting mode.

Clause 162. The non-transitory computer-readable medium of clause 161, wherein the first casting mode is unicast, groupcast, or broadcast, and wherein the second casting mode is unicast, groupcast, or broadcast.

Clause 163. The non-transitory computer-readable medium of any of clauses 161 to 162, wherein the first casting mode is unicast, and wherein the set of one or more UEs comprises a single target UE.

Clause 164. The non-transitory computer-readable medium of clause 163, wherein the SLPP message comprises a session identifier for the SLPP session, a first set of identifiers associated with the UE, a second set of identifiers associated with the target UE.

Clause 165. The non-transitory computer-readable medium of any of clauses 163 to 164, wherein the selective determination determines the second casting mode is unicast, and wherein the SLPP message further comprises an indication of the second casting mode or the second casting mode is implicitly indicated from the first casting mode, further comprising: receive a response to the SLPP message from the target UE via unicast.

Clause 166. The non-transitory computer-readable medium of any of clauses 161 to 165, wherein the first casting mode is groupcast, and wherein the set of one or more UEs comprises a group of one or more UEs.

Clause 167. The non-transitory computer-readable medium of clause 166, wherein the SLPP message comprises a session identifier for the SLPP session, and a set of group identifiers associated with the SLPP session.

Clause 168. The non-transitory computer-readable medium of any of clauses 166 to 167, wherein the selective determination determines the second casting mode is groupcast, and wherein the SLPP message further comprises an indication of the second casting mode or the second casting mode is implicitly indicated from the first casting mode, further comprising: receive a response to the SLPP message from at least one UE in the group of one or more UEs via groupcast.

Clause 169. The non-transitory computer-readable medium of any of clauses 166 to 168, wherein the selective determination determines the second casting mode is unicast, and wherein the SLPP message further comprises an indication of the second casting mode, further comprising: receive a response to the SLPP message from at least one UE in the group of one or more UEs via unicast.

Clause 170. The non-transitory computer-readable medium of any of clauses 161 to 169, wherein the first casting mode is broadcast.

Clause 171. The non-transitory computer-readable medium of clause 170, wherein the SLPP message comprises a session identifier for the SLPP session.

Clause 172. The non-transitory computer-readable medium of any of clauses 170 to 171, wherein the selective determination determines the second casting mode is broadcast, and wherein the SLPP message further comprises an indication of the second casting mode or the second casting mode is implicitly indicated from the first casting mode, further comprising: receive a response to the SLPP message from at least one UE in the set of one or more UEs via broadcast.

Clause 173. A non-transitory computer-readable medium storing computer-executable instructions that, when executed by a user equipment (UE), cause the UE to: receive a sidelink positioning protocol (SLPP) message associated with a SLPP session, wherein the SLPP message is received in accordance with a first casting mode and comprises an indication of the first casting mode or both the first casting mode and a second casting mode associated with any SLPP response message to the SLPP message; and determine whether to respond to the SLPP message in accordance with the second casting mode based on whether the SLPP message is configured to trigger a response.

Clause 174. The non-transitory computer-readable medium of clause 173, wherein the first casting mode is unicast, groupcast, or broadcast, and wherein the second casting mode is unicast, groupcast, or broadcast.

Clause 175. The non-transitory computer-readable medium of any of clauses 173 to 174, wherein the first casting mode is unicast.

Clause 176. The non-transitory computer-readable medium of clause 175, wherein the SLPP message comprises a session identifier for the SLPP session, a first set of identifiers associated with another UE, a second set of identifiers associated with the UE.

Clause 177. The non-transitory computer-readable medium of any of clauses 175 to 176, wherein the SLPP message further comprises an indication of the second casting mode or the second casting mode is implicitly indicated from the first casting mode, wherein the second casting mode is unicast, and wherein the determination is to respond to the SLPP message via unicast.

Clause 178. The non-transitory computer-readable medium of any of clauses 173 to 177, wherein the first casting mode is groupcast.

Clause 179. The non-transitory computer-readable medium of clause 178, wherein the SLPP message comprises a session identifier for the SLPP session, and a set of group identifiers associated with the SLPP session.

Clause 180. The non-transitory computer-readable medium of any of clauses 178 to 179, wherein the SLPP message further comprises an indication of the second casting mode or the second casting mode is implicitly indicated from the first casting mode, wherein the second casting mode is groupcast, and wherein the determination is to respond to the SLPP message via groupcast.

Clause 181. The non-transitory computer-readable medium of any of clauses 178 to 180, wherein the SLPP message further comprises an indication of the second casting mode or the second casting mode is implicitly indicated from the first casting mode, wherein the second casting mode is unicast, and wherein the determination is to respond to the SLPP message via unicast.

Clause 182. The non-transitory computer-readable medium of any of clauses 173 to 181, wherein the first casting mode is broadcast.

Clause 183. The non-transitory computer-readable medium of clause 182, wherein the SLPP message comprises a session identifier for the SLPP session.

Clause 184. The non-transitory computer-readable medium of any of clauses 182 to 183, wherein the SLPP message further comprises an indication of the second casting mode or the second casting mode is implicitly indicated from the first casting mode, wherein the second casting mode is broadcast, and wherein the determination is to respond to the SLPP message via broadcast.

Implementation examples are described in the following numbered Additional Clauses:

Additional Clause 1. A method of operating an initiator user equipment (UE), comprising: transmitting a first request to create a sidelink positioning protocol (SLPP) session to each recipient UE among a set of one or more recipient UEs; receiving a first response from each recipient UE of the set of one or more recipient UEs, wherein each first response indicates an acceptance or rejection of the SLPP session by the respective recipient UE; determining a group of one or more UEs for participation in the SLPP session from among recipient UEs from which a respective first response that indicates the acceptance of the SLPP session is received; transmitting a second request to start the SLPP session to the group of one or more UEs; and receiving a second response from each UE of the group of one or more UEs, wherein each second response acknowledges the second request.

Additional Clause 2. The method of Additional Clause 1, wherein the first request is transmitted via unicast, groupcast, or broadcast, or wherein each first response is received via unicast, groupcast, broadcast, or a combination thereof, or wherein the second request is transmitted via unicast, groupcast, or broadcast, or wherein each second response is received via unicast, groupcast, broadcast, or a combination thereof, or any combination thereof.

Additional Clause 3. The method of any of Additional Clauses 1 to 2, wherein the first request comprises a session identifier associated with the SLPP session.

Additional Clause 4. The method of any of Additional Clauses 1 to 3, wherein the first request comprises a Layer-2 (L2) group identifier associated with the SLPP session.

Additional Clause 5. The method of any of Additional Clauses 1 to 4, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Additional Clause 6. The method of any of Additional Clauses 1 to 5, further comprising: transmitting a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Additional Clause 7. The method of Additional Clause 6, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Additional Clause 8. The method of any of Additional Clauses 1 to 7, wherein the second request comprises Layer-2 (L2) and application layer identifiers associated with the SLPP session, a UE identifier associated with the initiator UE, and a UE identifier associated with each UE in the group of one or more UEs.

Additional Clause 9. The method of any of Additional Clauses 1 to 8, further comprising: obtaining a set of sidelink positioning reference signal (SL-PRS) measurements associated with the SLPP session; and determining a position estimate for the initiator UE, one or more UEs in the group of one or more UEs, or a combination thereof, based on the set of SL-PRS measurements.

Additional Clause 10. The method of Additional Clause 9, wherein one or more position estimates for the one or more UEs are determined and transmitted to the one or more UEs.

Additional Clause 11. A method of operating a recipient user equipment (UE), comprising: receiving a first request to create a sidelink positioning protocol (SLPP) session from an initiator UE; and transmitting a first response to the initiator UE indicates an acceptance or rejection of the SLPP session by the recipient UE.

Additional Clause 12. The method of Additional Clause 11, wherein the first response indicates the acceptance of the SLPP session by the recipient UE.

Additional Clause 13. The method of Additional Clause 12, further comprising: receiving a second request to start the SLPP session from the initiator UE; and transmitting a second response that acknowledges the second request.

Additional Clause 14. The method of Additional Clause 13, wherein the second request is received via unicast, groupcast, or broadcast, or wherein the second response is transmitted via unicast, groupcast, or broadcast, or any combination thereof.

Additional Clause 15. The method of any of Additional Clauses 13 to 14, wherein the second request comprises Layer-2 (L2) and application layer identifiers associated with the SLPP session, a UE identifier associated with the initiator UE, and a UE identifier associated with each UE in a group of one or more UEs associated with the SLPP session.

Additional Clause 16. The method of any of Additional Clauses 12 to 15, further comprising: receiving a third request from the initiator UE to modify the SLPP session, the third request indicating whether the recipient UE will be included or excluded in the modified SLPP session.

Additional Clause 17. The method of Additional Clause 16, transmitting a third response to the initiator UE, the third response indicating an acceptance or rejection or acknowledgment of the modified SLPP session by the recipient UE.

Additional Clause 18. The method of any of Additional Clauses 12 to 17, further comprising: transmitting sidelink positioning reference signal (SL-PRS) measurements associated with the SLPP session to the initiator UE.

Additional Clause 19. The method of any of Additional Clauses 12 to 18, further comprising: receiving a position estimate of the recipient UE from the initiator UE.

Additional Clause 20. The method of any of Additional Clauses 11 to 19, wherein the first request is received via unicast, groupcast, or broadcast, or wherein the first response is transmitted via unicast, groupcast, or broadcast, or any combination thereof.

Additional Clause 21. The method of any of Additional Clauses 11 to 20, wherein the first request comprises a session identifier associated with the SLPP session.

Additional Clause 22. The method of Additional Clause 21, wherein the first request comprises a set of group identifiers associated with the SLPP session.

Additional Clause 23. A method of operating a user equipment (UE), comprising: determining a first casting mode associated with a sidelink positioning protocol (SLPP) message associated with a SLPP session; determining a second casting mode associated with one or more SLPP response messages to the SLPP message; and transmitting the SLPP message to a set of one or more UEs in accordance with the first casting mode, wherein the SLPP message comprises an indication of both the first casting mode and the second casting mode.

Additional Clause 24. The method of Additional Clause 23, wherein the first casting mode is unicast, groupcast, or broadcast, and wherein the second casting mode is unicast, groupcast, or broadcast.

Additional Clause 25. The method of any of Additional Clauses 23 to 24, wherein the first casting mode is unicast, and wherein the set of one or more UEs comprises a single target UE.

Additional Clause 26. The method of Additional Clause 25, wherein the SLPP message comprises a session identifier for the SLPP session, a first set of identifiers associated with the UE, a second set of identifiers associated with the target UE.

Additional Clause 27. The method of any of Additional Clauses 25 to 26, wherein the second casting mode is unicast, and wherein the SLPP message comprises an indication of the second casting mode or the second casting mode is implicitly indicated from the first casting mode, further comprising: receiving a response to the SLPP message from the target UE via unicast.

Additional Clause 28. The method of any of Additional Clauses 23 to 27, wherein the first casting mode is groupcast, and wherein the set of one or more UEs comprises a group of one or more UEs.

Additional Clause 29. The method of Additional Clause 28, wherein the SLPP message comprises a session identifier for the SLPP session, and a set of group identifiers associated with the SLPP session.

Additional Clause 30. The method of any of Additional Clauses 28 to 29, wherein the second casting mode is groupcast, and wherein the SLPP message comprises an indication of the second casting mode or the second casting mode is implicitly indicated from the first casting mode, further comprising: receiving a response to the SLPP message from at least one UE in the group of one or more UEs via groupcast.

Additional Clause 31. The method of any of Additional Clauses 28 to 30, wherein the second casting mode is unicast, and wherein the SLPP message comprises an indication of the second casting mode, further comprising: receiving a response to the SLPP message from at least one UE in the group of one or more UEs via unicast.

Additional Clause 32. The method of any of Additional Clauses 23 to 31, wherein the first casting mode is broadcast.

Additional Clause 33. The method of Additional Clause 32, wherein the SLPP message comprises a session identifier for the SLPP session.

Additional Clause 34. The method of any of Additional Clauses 32 to 33, wherein the second casting mode is broadcast, and wherein the SLPP message comprises an indication of the second casting mode or the second casting mode is implicitly indicated from the first casting mode, further comprising: receiving a response to the SLPP message from at least one UE in the set of one or more UEs via broadcast.

Additional Clause 35. A method of operating a user equipment (UE), comprising: receiving a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and transmitting a SLPP response message in response to the SLPP message in accordance with the second casting mode.

Additional Clause 36. The method of Additional Clause 35, wherein the first casting mode is unicast, groupcast, or broadcast, and wherein the second casting mode is unicast, groupcast, or broadcast.

Additional Clause 37. The method of any of Additional Clauses 35 to 36, wherein the first casting mode is unicast.

Additional Clause 38. The method of Additional Clause 37, wherein the SLPP message comprises a session identifier for the SLPP session, a first set of identifiers associated with another UE, a second set of identifiers associated with the UE.

Additional Clause 39. The method of any of Additional Clauses 37 to 38, wherein the SLPP message comprises an indication of the second casting mode or the second casting mode is implicitly indicated from the first casting mode, wherein the second casting mode is unicast.

Additional Clause 40. The method of any of Additional Clauses 35 to 39, wherein the first casting mode is groupcast.

Additional Clause 41. The method of Additional Clause 40, wherein the SLPP message comprises a session identifier for the SLPP session, and a set of group identifiers associated with the SLPP session.

Additional Clause 42. The method of any of Additional Clauses 40 to 41, wherein the SLPP message comprises an indication of the second casting mode or the second casting mode is implicitly indicated from the first casting mode, wherein the second casting mode is groupcast.

Additional Clause 43. The method of any of Additional Clauses 40 to 42, wherein the SLPP message comprises an indication of the second casting mode or the second casting mode is implicitly indicated from the first casting mode, wherein the second casting mode is unicast.

Additional Clause 44. The method of any of Additional Clauses 35 to 43, wherein the first casting mode is broadcast.

Additional Clause 45. The method of Additional Clause 44, wherein the SLPP message comprises a session identifier for the SLPP session.

Additional Clause 46. The method of any of Additional Clauses 44 to 45, wherein the SLPP message comprises an indication of the second casting mode or the second casting mode is implicitly indicated from the first casting mode, wherein the second casting mode is broadcast.

Additional Clause 47. An initiator user equipment (UE), comprising: one or more memories; one or more transceivers; and one or more processors communicatively coupled to the one or more memories and the one or more transceivers, the one or more processors, either alone or in combination, configured to: transmit, via the one or more transceivers, a first request to create a sidelink positioning protocol (SLPP) session to each recipient UE among a set of one or more recipient UEs; receive, via the one or more transceivers, a first response from each recipient UE of the set of one or more recipient UEs, wherein each first response indicates an acceptance or rejection of the SLPP session by the respective recipient UE; determine a group of one or more UEs for participation in the SLPP session from among recipient UEs from which a respective first response that indicates the acceptance of the SLPP session is received; transmit, via the one or more transceivers, a second request to start the SLPP session to the group of one or more UEs; and receive, via the one or more transceivers, a second response from each UE of the group of one or more UEs, wherein each second response acknowledges the second request.

Additional Clause 48. The initiator UE of Additional Clause 47, wherein the first request is transmitted via unicast, groupcast, or broadcast, or wherein each first response is received via unicast, groupcast, broadcast, or a combination thereof, or wherein the second request is transmitted via unicast, groupcast, or broadcast, or wherein each second response is received via unicast, groupcast, broadcast, or a combination thereof, or any combination thereof.

Additional Clause 49. The initiator UE of any of Additional Clauses 47 to 48, wherein the first request comprises a session identifier associated with the SLPP session.

Additional Clause 50. The initiator UE of any of Additional Clauses 47 to 49, wherein the first request comprises a Layer-2 (L2) group identifier associated with the SLPP session.

Additional Clause 51. The initiator UE of any of Additional Clauses 47 to 50, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Additional Clause 52. The initiator UE of any of Additional Clauses 47 to 51, wherein the one or more processors, either alone or in combination, are further configured to: transmit, via the one or more transceivers, a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Additional Clause 53. The initiator UE of Additional Clause 52, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Additional Clause 54. The initiator UE of any of Additional Clauses 47 to 53, wherein the second request comprises Layer-2 (L2) and application layer identifiers associated with the SLPP session, a UE identifier associated with the initiator UE, and a UE identifier associated with each UE in the group of one or more UEs.

Additional Clause 55. The initiator UE of any of Additional Clauses 47 to 54, wherein the one or more processors, either alone or in combination, are further configured to: obtain a set of sidelink positioning reference signal (SL-PRS) measurements associated with the SLPP session; and determine a position estimate for the initiator UE, one or more UEs in the group of one or more UEs, or a combination thereof, based on the set of SL-PRS measurements.

Additional Clause 56. The initiator UE of Additional Clause 55, wherein one or more position estimates for the one or more UEs are determined and transmitted to the one or more UEs.

Additional Clause 57. A user equipment (UE), comprising: one or more memories; one or more transceivers; and one or more processors communicatively coupled to the one or more memories and the one or more transceivers, the one or more processors, either alone or in combination, configured to: receive, via the one or more transceivers, a first request to create a sidelink positioning protocol (SLPP) session from an initiator UE; and transmit, via the one or more transceivers, a first response to the initiator UE indicates an acceptance or rejection of the SLPP session by the recipient UE.

Additional Clause 58. The UE of Additional Clause 57, wherein the first response indicates the acceptance of the SLPP session by the recipient UE.

Additional Clause 59. The UE of Additional Clause 58, wherein the one or more processors, either alone or in combination, are further configured to: receive, via the one or more transceivers, a second request to start the SLPP session from the initiator UE; and transmit, via the one or more transceivers, a second response that acknowledges the second request.

Additional Clause 60. The UE of Additional Clause 59, wherein the second request is received via unicast, groupcast, or broadcast, or wherein the second response is transmitted via unicast, groupcast, or broadcast, or any combination thereof.

Additional Clause 61. The UE of any of Additional Clauses 59 to 60, wherein the second request comprises Layer-2 (L2) and application layer identifiers associated with the SLPP session, a UE identifier associated with the initiator UE, and a UE identifier associated with each UE in a group of one or more UEs associated with the SLPP session.

Additional Clause 62. The UE of any of Additional Clauses 58 to 61, wherein the one or more processors, either alone or in combination, are further configured to: receive, via the one or more transceivers, a third request from the initiator UE to modify the SLPP session, the third request indicating whether the recipient UE will be included or excluded in the modified SLPP session.

Additional Clause 63. The UE of Additional Clause 62, transmit, via the one or more transceivers, a third response to the initiator UE, the third response indicating an acceptance or rejection or acknowledgment of the modified SLPP session by the recipient UE.

Additional Clause 64. The UE of any of Additional Clauses 58 to 63, wherein the one or more processors, either alone or in combination, are further configured to: transmit, via the one or more transceivers, sidelink positioning reference signal (SL-PRS) measurements associated with the SLPP session to the initiator UE.

Additional Clause 65. The UE of any of Additional Clauses 58 to 64, wherein the one or more processors, either alone or in combination, are further configured to: receive, via the one or more transceivers, a position estimate of the recipient UE from the initiator UE.

Additional Clause 66. The UE of any of Additional Clauses 57 to 65, wherein the first request is received via unicast, groupcast, or broadcast, or wherein the first response is transmitted via unicast, groupcast, or broadcast, or any combination thereof.

Additional Clause 67. The UE of any of Additional Clauses 57 to 66, wherein the first request comprises a session identifier associated with the SLPP session.

Additional Clause 68. The UE of Additional Clause 67, wherein the first request comprises a set of group identifiers associated with the SLPP session.

Additional Clause 69. A user equipment (UE), comprising: one or more memories; one or more transceivers; and one or more processors communicatively coupled to the one or more memories and the one or more transceivers, the one or more processors, either alone or in combination, configured to: determine a first casting mode associated with a sidelink positioning protocol (SLPP) message associated with a SLPP session; determine a second casting mode associated with one or more SLPP response messages to the SLPP message; and transmit, via the one or more transceivers, the SLPP message to a set of one or more UEs in accordance with the first casting mode, wherein the SLPP message comprises an indication of both the first casting mode and the second casting mode.

Additional Clause 70. The UE of Additional Clause 69, wherein the first casting mode is unicast, groupcast, or broadcast, and wherein the second casting mode is unicast, groupcast, or broadcast.

Additional Clause 71. The UE of any of Additional Clauses 69 to 70, wherein the first casting mode is unicast, and wherein the set of one or more UEs comprises a single target UE.

Additional Clause 72. The UE of Additional Clause 71, wherein the SLPP message comprises a session identifier for the SLPP session, a first set of identifiers associated with the UE, a second set of identifiers associated with the target UE.

Additional Clause 73. The UE of any of Additional Clauses 71 to 72, wherein the second casting mode is unicast, and wherein the SLPP message comprises an indication of the second casting mode or the second casting mode is implicitly indicated from the first casting mode, further comprising: receive, via the one or more transceivers, a response to the SLPP message from the target UE via unicast.

Additional Clause 74. The UE of any of Additional Clauses 69 to 73, wherein the first casting mode is groupcast, and wherein the set of one or more UEs comprises a group of one or more UEs.

Additional Clause 75. The UE of Additional Clause 74, wherein the SLPP message comprises a session identifier for the SLPP session, and a set of group identifiers associated with the SLPP session.

Additional Clause 76. The UE of any of Additional Clauses 74 to 75, wherein the second casting mode is groupcast, and wherein the SLPP message comprises an indication of the second casting mode or the second casting mode is implicitly indicated from the first casting mode, further comprising: receive, via the one or more transceivers, a response to the SLPP message from at least one UE in the group of one or more UEs via groupcast.

Additional Clause 77. The UE of any of Additional Clauses 74 to 76, wherein the second casting mode is unicast, and wherein the SLPP message comprises an indication of the second casting mode, further comprising: receive, via the one or more transceivers, a response to the SLPP message from at least one UE in the group of one or more UEs via unicast.

Additional Clause 78. The UE of any of Additional Clauses 69 to 77, wherein the first casting mode is broadcast.

Additional Clause 79. The UE of Additional Clause 78, wherein the SLPP message comprises a session identifier for the SLPP session.

Additional Clause 80. The UE of any of Additional Clauses 78 to 79, wherein the second casting mode is broadcast, and wherein the SLPP message comprises an indication of the second casting mode or the second casting mode is implicitly indicated from the first casting mode, further comprising: receive, via the one or more transceivers, a response to the SLPP message from at least one UE in the set of one or more UEs via broadcast.

Additional Clause 81. A user equipment (UE), comprising: one or more memories; one or more transceivers; and one or more processors communicatively coupled to the one or more memories and the one or more transceivers, the one or more processors, either alone or in combination, configured to: receive, via the one or more transceivers, a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and transmit, via the one or more transceivers, a SLPP response message in response to the SLPP message in accordance with the second casting mode.

Additional Clause 82. The UE of Additional Clause 81, wherein the first casting mode is unicast, groupcast, or broadcast, and wherein the second casting mode is unicast, groupcast, or broadcast.

Additional Clause 83. The UE of any of Additional Clauses 81 to 82, wherein the first casting mode is unicast.

Additional Clause 84. The UE of Additional Clause 83, wherein the SLPP message comprises a session identifier for the SLPP session, a first set of identifiers associated with another UE, a second set of identifiers associated with the UE.

Additional Clause 85. The UE of any of Additional Clauses 83 to 84, wherein the SLPP message comprises an indication of the second casting mode or the second casting mode is implicitly indicated from the first casting mode, wherein the second casting mode is unicast.

Additional Clause 86. The UE of any of Additional Clauses 81 to 85, wherein the first casting mode is groupcast.

Additional Clause 87. The UE of Additional Clause 86, wherein the SLPP message comprises a session identifier for the SLPP session, and a set of group identifiers associated with the SLPP session.

Additional Clause 88. The UE of any of Additional Clauses 86 to 87, wherein the SLPP message comprises an indication of the second casting mode or the second casting mode is implicitly indicated from the first casting mode, wherein the second casting mode is groupcast.

Additional Clause 89. The UE of any of Additional Clauses 86 to 88, wherein the SLPP message comprises an indication of the second casting mode or the second casting mode is implicitly indicated from the first casting mode, wherein the second casting mode is unicast.

Additional Clause 90. The UE of any of Additional Clauses 81 to 89, wherein the first casting mode is broadcast.

Additional Clause 91. The UE of Additional Clause 90, wherein the SLPP message comprises a session identifier for the SLPP session.

Additional Clause 92. The UE of any of Additional Clauses 90 to 91, wherein the SLPP message comprises an indication of the second casting mode or the second casting mode is implicitly indicated from the first casting mode, wherein the second casting mode is broadcast.

Additional Clause 93. An initiator user equipment (UE), comprising: means for transmitting a first request to create a sidelink positioning protocol (SLPP) session to each recipient UE among a set of one or more recipient UEs; means for receiving a first response from each recipient UE of the set of one or more recipient UEs, wherein each first response indicates an acceptance or rejection of the SLPP session by the respective recipient UE; means for determining a group of one or more UEs for participation in the SLPP session from among recipient UEs from which a respective first response that indicates the acceptance of the SLPP session is received; means for transmitting a second request to start the SLPP session to the group of one or more UEs; and means for receiving a second response from each UE of the group of one or more UEs, wherein each second response acknowledges the second request.

Additional Clause 94. The initiator UE of Additional Clause 93, wherein the first request is transmitted via unicast, groupcast, or broadcast, or wherein each first response is received via unicast, groupcast, broadcast, or a combination thereof, or wherein the second request is transmitted via unicast, groupcast, or broadcast, or wherein each second response is received via unicast, groupcast, broadcast, or a combination thereof, or any combination thereof.

Additional Clause 95. The initiator UE of any of Additional Clauses 93 to 94, wherein the first request comprises a session identifier associated with the SLPP session.

Additional Clause 96. The initiator UE of any of Additional Clauses 93 to 95, wherein the first request comprises a Layer-2 (L2) group identifier associated with the SLPP session.

Additional Clause 97. The initiator UE of any of Additional Clauses 93 to 96, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Additional Clause 98. The initiator UE of any of Additional Clauses 93 to 97, further comprising: means for transmitting a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Additional Clause 99. The initiator UE of Additional Clause 98, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Additional Clause 100. The initiator UE of any of Additional Clauses 93 to 99, wherein the second request comprises Layer-2 (L2) and application layer identifiers associated with the SLPP session, a UE identifier associated with the initiator UE, and a UE identifier associated with each UE in the group of one or more UEs.

Additional Clause 101. The initiator UE of any of Additional Clauses 93 to 100, further comprising: means for obtaining a set of sidelink positioning reference signal (SL-PRS) measurements associated with the SLPP session; and means for determining a position estimate for the initiator UE, one or more UEs in the group of one or more UEs, or a combination thereof, based on the set of SL-PRS measurements.

Additional Clause 102. The initiator UE of Additional Clause 101, wherein one or more position estimates for the one or more UEs are determined and transmitted to the one or more UEs.

Additional Clause 103. A user equipment (UE), comprising: means for receiving a first request to create a sidelink positioning protocol (SLPP) session from an initiator UE; and means for transmitting a first response to the initiator UE indicates an acceptance or rejection of the SLPP session by the recipient UE.

Additional Clause 104. The UE of Additional Clause 103, wherein the first response indicates the acceptance of the SLPP session by the recipient UE.

Additional Clause 105. The UE of Additional Clause 104, further comprising: means for receiving a second request to start the SLPP session from the initiator UE; and means for transmitting a second response that acknowledges the second request.

Additional Clause 106. The UE of Additional Clause 105, wherein the second request is received via unicast, groupcast, or broadcast, or wherein the second response is transmitted via unicast, groupcast, or broadcast, or any combination thereof.

Additional Clause 107. The UE of any of Additional Clauses 105 to 106, wherein the second request comprises Layer-2 (L2) and application layer identifiers associated with the SLPP session, a UE identifier associated with the initiator UE, and a UE identifier associated with each UE in a group of one or more UEs associated with the SLPP session.

Additional Clause 108. The UE of any of Additional Clauses 104 to 107, further comprising: means for receiving a third request from the initiator UE to modify the SLPP session, the third request indicating whether the recipient UE will be included or excluded in the modified SLPP session.

Additional Clause 109. The UE of Additional Clause 108, means for transmitting a third response to the initiator UE, the third response indicating an acceptance or rejection or acknowledgment of the modified SLPP session by the recipient UE.

Additional Clause 110. The UE of any of Additional Clauses 104 to 109, further comprising: means for transmitting sidelink positioning reference signal (SL-PRS) measurements associated with the SLPP session to the initiator UE.

Additional Clause 111. The UE of any of Additional Clauses 104 to 110, further comprising: means for receiving a position estimate of the recipient UE from the initiator UE.

Additional Clause 112. The UE of any of Additional Clauses 103 to 111, wherein the first request is received via unicast, groupcast, or broadcast, or wherein the first response is transmitted via unicast, groupcast, or broadcast, or any combination thereof.

Additional Clause 113. The UE of any of Additional Clauses 103 to 112, wherein the first request comprises a session identifier associated with the SLPP session.

Additional Clause 114. The UE of Additional Clause 113, wherein the first request comprises a set of group identifiers associated with the SLPP session.

Additional Clause 115. A user equipment (UE), comprising: means for determining a first casting mode associated with a sidelink positioning protocol (SLPP) message associated with a SLPP session; means for determining a second casting mode associated with one or more SLPP response messages to the SLPP message; and means for transmitting the SLPP message to a set of one or more UEs in accordance with the first casting mode, wherein the SLPP message comprises an indication of both the first casting mode and the second casting mode.

Additional Clause 116. The UE of Additional Clause 115, wherein the first casting mode is unicast, groupcast, or broadcast, and wherein the second casting mode is unicast, groupcast, or broadcast.

Additional Clause 117. The UE of any of Additional Clauses 115 to 116, wherein the first casting mode is unicast, and wherein the set of one or more UEs comprises a single target UE.

Additional Clause 118. The UE of Additional Clause 117, wherein the SLPP message comprises a session identifier for the SLPP session, a first set of identifiers associated with the UE, a second set of identifiers associated with the target UE.

Additional Clause 119. The UE of any of Additional Clauses 117 to 118, wherein the second casting mode is unicast, and wherein the SLPP message comprises an indication of the second casting mode or the second casting mode is implicitly indicated from the first casting mode, further comprising: means for receiving a response to the SLPP message from the target UE via unicast.

Additional Clause 120. The UE of any of Additional Clauses 115 to 119, wherein the first casting mode is groupcast, and wherein the set of one or more UEs comprises a group of one or more UEs.

Additional Clause 121. The UE of Additional Clause 120, wherein the SLPP message comprises a session identifier for the SLPP session, and a set of group identifiers associated with the SLPP session.

Additional Clause 122. The UE of any of Additional Clauses 120 to 121, wherein the second casting mode is groupcast, and wherein the SLPP message comprises an indication of the second casting mode or the second casting mode is implicitly indicated from the first casting mode, further comprising: means for receiving a response to the SLPP message from at least one UE in the group of one or more UEs via groupcast.

Additional Clause 123. The UE of any of Additional Clauses 120 to 122, wherein the second casting mode is unicast, and wherein the SLPP message comprises an indication of the second casting mode, further comprising: means for receiving a response to the SLPP message from at least one UE in the group of one or more UEs via unicast.

Additional Clause 124. The UE of any of Additional Clauses 115 to 123, wherein the first casting mode is broadcast.

Additional Clause 125. The UE of Additional Clause 124, wherein the SLPP message comprises a session identifier for the SLPP session.

Additional Clause 126. The UE of any of Additional Clauses 124 to 125, wherein the second casting mode is broadcast, and wherein the SLPP message comprises an indication of the second casting mode or the second casting mode is implicitly indicated from the first casting mode, further comprising: means for receiving a response to the SLPP message from at least one UE in the set of one or more UEs via broadcast.

Additional Clause 127. A user equipment (UE), comprising: means for receiving a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and means for transmitting a SLPP response message in response to the SLPP message in accordance with the second casting mode.

Additional Clause 128. The UE of Additional Clause 127, wherein the first casting mode is unicast, groupcast, or broadcast, and wherein the second casting mode is unicast, groupcast, or broadcast.

Additional Clause 129. The UE of any of Additional Clauses 127 to 128, wherein the first casting mode is unicast.

Additional Clause 130. The UE of Additional Clause 129, wherein the SLPP message comprises a session identifier for the SLPP session, a first set of identifiers associated with another UE, a second set of identifiers associated with the UE.

Additional Clause 131. The UE of any of Additional Clauses 129 to 130, wherein the SLPP message comprises an indication of the second casting mode or the second casting mode is implicitly indicated from the first casting mode, wherein the second casting mode is unicast.

Additional Clause 132. The UE of any of Additional Clauses 127 to 131, wherein the first casting mode is groupcast.

Additional Clause 133. The UE of Additional Clause 132, wherein the SLPP message comprises a session identifier for the SLPP session, and a set of group identifiers associated with the SLPP session.

Additional Clause 134. The UE of any of Additional Clauses 132 to 133, wherein the SLPP message comprises an indication of the second casting mode or the second casting mode is implicitly indicated from the first casting mode, wherein the second casting mode is groupcast.

Additional Clause 135. The UE of any of Additional Clauses 132 to 134, wherein the SLPP message comprises an indication of the second casting mode or the second casting mode is implicitly indicated from the first casting mode, wherein the second casting mode is unicast.

Additional Clause 136. The UE of any of Additional Clauses 127 to 135, wherein the first casting mode is broadcast.

Additional Clause 137. The UE of Additional Clause 136, wherein the SLPP message comprises a session identifier for the SLPP session.

Additional Clause 138. The UE of any of Additional Clauses 136 to 137, wherein the SLPP message comprises an indication of the second casting mode or the second casting mode is implicitly indicated from the first casting mode, wherein the second casting mode is broadcast.

Additional Clause 139. A non-transitory computer-readable medium storing computer-executable instructions that, when executed by an initiator user equipment (UE), cause the initiator UE to: transmit a first request to create a sidelink positioning protocol (SLPP) session to each recipient UE among a set of one or more recipient UEs; receive a first response from each recipient UE of the set of one or more recipient UEs, wherein each first response indicates an acceptance or rejection of the SLPP session by the respective recipient UE; determine a group of one or more UEs for participation in the SLPP session from among recipient UEs from which a respective first response that indicates the acceptance of the SLPP session is received; transmit a second request to start the SLPP session to the group of one or more UEs; and receive a second response from each UE of the group of one or more UEs, wherein each second response acknowledges the second request.

Additional Clause 140. The non-transitory computer-readable medium of Additional Clause 139, wherein the first request is transmitted via unicast, groupcast, or broadcast, or wherein each first response is received via unicast, groupcast, broadcast, or a combination thereof, or wherein the second request is transmitted via unicast, groupcast, or broadcast, or wherein each second response is received via unicast, groupcast, broadcast, or a combination thereof, or any combination thereof.

Additional Clause 141. The non-transitory computer-readable medium of any of Additional Clauses 139 to 140, wherein the first request comprises a session identifier associated with the SLPP session.

Additional Clause 142. The non-transitory computer-readable medium of any of Additional Clauses 139 to 141, wherein the first request comprises a Layer-2 (L2) group identifier associated with the SLPP session.

Additional Clause 143. The non-transitory computer-readable medium of any of Additional Clauses 139 to 142, wherein the group of one or more UEs includes each recipient UE that indicates the acceptance of the SLPP session via a respective first response, or wherein the group of one or more UEs omits one or more recipient UEs that indicate the rejection of the SLPP session via one or more respective first responses.

Additional Clause 144. The non-transitory computer-readable medium of any of Additional Clauses 139 to 143, further comprising computer-executable instructions that, when executed by the initiator UE, cause the initiator UE to: transmit a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

Additional Clause 145. The non-transitory computer-readable medium of Additional Clause 144, wherein the modified group of one or more UEs includes each recipient UE that indicates the acceptance of the modified SLPP session via a respective third response, or wherein the modified group of one or more UEs omits one or more recipient UEs that indicate the rejection of the modified SLPP session via one or more respective third responses.

Additional Clause 146. The non-transitory computer-readable medium of any of Additional Clauses 139 to 145, wherein the second request comprises Layer-2 (L2) and application layer identifiers associated with the SLPP session, a UE identifier associated with the initiator UE, and a UE identifier associated with each UE in the group of one or more UEs.

Additional Clause 147. The non-transitory computer-readable medium of any of Additional Clauses 139 to 146, further comprising computer-executable instructions that, when executed by the initiator UE, cause the initiator UE to: obtain a set of sidelink positioning reference signal (SL-PRS) measurements associated with the SLPP session; and determine a position estimate for the initiator UE, one or more UEs in the group of one or more UEs, or a combination thereof, based on the set of SL-PRS measurements.

Additional Clause 148. The non-transitory computer-readable medium of Additional Clause 147, wherein one or more position estimates for the one or more UEs are determined and transmitted to the one or more UEs.

Additional Clause 149. A non-transitory computer-readable medium storing computer-executable instructions that, when executed by a user equipment (UE), cause the UE to: receive a first request to create a sidelink positioning protocol (SLPP) session from an initiator UE; and transmit a first response to the initiator UE indicates an acceptance or rejection of the SLPP session by the recipient UE.

Additional Clause 150. The non-transitory computer-readable medium of Additional Clause 149, wherein the first response indicates the acceptance of the SLPP session by the recipient UE.

Additional Clause 151. The non-transitory computer-readable medium of Additional Clause 150, further comprising computer-executable instructions that, when executed by the UE, cause the UE to: receive a second request to start the SLPP session from the initiator UE; and transmit a second response that acknowledges the second request.

Additional Clause 152. The non-transitory computer-readable medium of Additional Clause 151, wherein the second request is received via unicast, groupcast, or broadcast, or wherein the second response is transmitted via unicast, groupcast, or broadcast, or any combination thereof.

Additional Clause 153. The non-transitory computer-readable medium of any of Additional Clauses 151 to 152, wherein the second request comprises Layer-2 (L2) and application layer identifiers associated with the SLPP session, a UE identifier associated with the initiator UE, and a UE identifier associated with each UE in a group of one or more UEs associated with the SLPP session.

Additional Clause 154. The non-transitory computer-readable medium of any of Additional Clauses 150 to 153, further comprising computer-executable instructions that, when executed by the UE, cause the UE to: receive a third request from the initiator UE to modify the SLPP session, the third request indicating whether the recipient UE will be included or excluded in the modified SLPP session.

Additional Clause 155. The non-transitory computer-readable medium of Additional Clause 154, transmit a third response to the initiator UE, the third response indicating an acceptance or rejection or acknowledgment of the modified SLPP session by the recipient UE.

Additional Clause 156. The non-transitory computer-readable medium of any of Additional Clauses 150 to 155, further comprising computer-executable instructions that, when executed by the UE, cause the UE to: transmit sidelink positioning reference signal (SL-PRS) measurements associated with the SLPP session to the initiator UE.

Additional Clause 157. The non-transitory computer-readable medium of any of Additional Clauses 150 to 156, further comprising computer-executable instructions that, when executed by the UE, cause the UE to: receive a position estimate of the recipient UE from the initiator UE.

Additional Clause 158. The non-transitory computer-readable medium of any of Additional Clauses 149 to 157, wherein the first request is received via unicast, groupcast, or broadcast, or wherein the first response is transmitted via unicast, groupcast, or broadcast, or any combination thereof.

Additional Clause 159. The non-transitory computer-readable medium of any of Additional Clauses 149 to 158, wherein the first request comprises a session identifier associated with the SLPP session.

Additional Clause 160. The non-transitory computer-readable medium of Additional Clause 159, wherein the first request comprises a set of group identifiers associated with the SLPP session.

Additional Clause 161. A non-transitory computer-readable medium storing computer-executable instructions that, when executed by a user equipment (UE), cause the UE to: determine a first casting mode associated with a sidelink positioning protocol (SLPP) message associated with a SLPP session; determine a second casting mode associated with one or more SLPP response messages to the SLPP message; and transmit the SLPP message to a set of one or more UEs in accordance with the first casting mode, wherein the SLPP message comprises an indication of both the first casting mode and the second casting mode.

Additional Clause 162. The non-transitory computer-readable medium of Additional Clause 161, wherein the first casting mode is unicast, groupcast, or broadcast, and wherein the second casting mode is unicast, groupcast, or broadcast.

Additional Clause 163. The non-transitory computer-readable medium of any of Additional Clauses 161 to 162, wherein the first casting mode is unicast, and wherein the set of one or more UEs comprises a single target UE.

Additional Clause 164. The non-transitory computer-readable medium of Additional Clause 163, wherein the SLPP message comprises a session identifier for the SLPP session, a first set of identifiers associated with the UE, a second set of identifiers associated with the target UE.

Additional Clause 165. The non-transitory computer-readable medium of any of Additional Clauses 163 to 164, wherein the second casting mode is unicast, and wherein the SLPP message comprises an indication of the second casting mode or the second casting mode is implicitly indicated from the first casting mode, further comprising: receive a response to the SLPP message from the target UE via unicast.

Additional Clause 166. The non-transitory computer-readable medium of any of Additional Clauses 161 to 165, wherein the first casting mode is groupcast, and wherein the set of one or more UEs comprises a group of one or more UEs.

Additional Clause 167. The non-transitory computer-readable medium of Additional Clause 166, wherein the SLPP message comprises a session identifier for the SLPP session, and a set of group identifiers associated with the SLPP session.

Additional Clause 168. The non-transitory computer-readable medium of any of Additional Clauses 166 to 167, wherein the second casting mode is groupcast, and wherein the SLPP message comprises an indication of the second casting mode or the second casting mode is implicitly indicated from the first casting mode, further comprising: receive a response to the SLPP message from at least one UE in the group of one or more UEs via groupcast.

Additional Clause 169. The non-transitory computer-readable medium of any of Additional Clauses 166 to 168, wherein the second casting mode is unicast, and wherein the SLPP message comprises an indication of the second casting mode, further comprising: receive a response to the SLPP message from at least one UE in the group of one or more UEs via unicast.

Additional Clause 170. The non-transitory computer-readable medium of any of Additional Clauses 161 to 169, wherein the first casting mode is broadcast.

Additional Clause 171. The non-transitory computer-readable medium of Additional Clause 170, wherein the SLPP message comprises a session identifier for the SLPP session.

Additional Clause 172. The non-transitory computer-readable medium of any of Additional Clauses 170 to 171, wherein the second casting mode is broadcast, and wherein the SLPP message comprises an indication of the second casting mode or the second casting mode is implicitly indicated from the first casting mode, further comprising: receive a response to the SLPP message from at least one UE in the set of one or more UEs via broadcast.

Additional Clause 173. A non-transitory computer-readable medium storing computer-executable instructions that, when executed by a user equipment (UE), cause the UE to: receive a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and transmit a SLPP response message in response to the SLPP message in accordance with the second casting mode.

Additional Clause 174. The non-transitory computer-readable medium of Additional Clause 173, wherein the first casting mode is unicast, groupcast, or broadcast, and wherein the second casting mode is unicast, groupcast, or broadcast.

Additional Clause 175. The non-transitory computer-readable medium of any of Additional Clauses 173 to 174, wherein the first casting mode is unicast.

Additional Clause 176. The non-transitory computer-readable medium of Additional Clause 175, wherein the SLPP message comprises a session identifier for the SLPP session, a first set of identifiers associated with another UE, a second set of identifiers associated with the UE.

Additional Clause 177. The non-transitory computer-readable medium of any of Additional Clauses 175 to 176, wherein the SLPP message comprises an indication of the second casting mode or the second casting mode is implicitly indicated from the first casting mode, wherein the second casting mode is unicast.

Additional Clause 178. The non-transitory computer-readable medium of any of Additional Clauses 173 to 177, wherein the first casting mode is groupcast.

Additional Clause 179. The non-transitory computer-readable medium of Additional Clause 178, wherein the SLPP message comprises a session identifier for the SLPP session, and a set of group identifiers associated with the SLPP session.

Additional Clause 180. The non-transitory computer-readable medium of any of Additional Clauses 178 to 179, wherein the SLPP message comprises an indication of the second casting mode or the second casting mode is implicitly indicated from the first casting mode, wherein the second casting mode is groupcast.

Additional Clause 181. The non-transitory computer-readable medium of any of Additional Clauses 178 to 180, wherein the SLPP message comprises an indication of the second casting mode or the second casting mode is implicitly indicated from the first casting mode, wherein the second casting mode is unicast.

Additional Clause 182. The non-transitory computer-readable medium of any of Additional Clauses 173 to 181, wherein the first casting mode is broadcast.

Additional Clause 183. The non-transitory computer-readable medium of Additional Clause 182, wherein the SLPP message comprises a session identifier for the SLPP session.

Additional Clause 184. The non-transitory computer-readable medium of any of Additional Clauses 182 to 183, wherein the SLPP message comprises an indication of the second casting mode or the second casting mode is implicitly indicated from the first casting mode, wherein the second casting mode is broadcast.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions may not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), crasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer-readable media.

While the foregoing disclosure shows illustrative aspects of the disclosure, it may be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of operating an initiator user equipment (UE), comprising:
transmitting a first request to create a sidelink positioning protocol (SLPP) session to each recipient UE among a set of one or more recipient UEs;
receiving a first response from each recipient UE of the set of one or more recipient UEs, wherein each first response indicates an acceptance or rejection of the SLPP session by the respective recipient UE;
determining a group of one or more UEs for participation in the SLPP session from among recipient UEs from which a respective first response that indicates the acceptance of the SLPP session is received;
transmitting a second request to start the SLPP session to the group of one or more UEs; and
receiving a second response from each UE of the group of one or more UEs, wherein each second response acknowledges the second request.

2. The method of claim 1,
wherein the first request is transmitted via unicast, groupcast, or broadcast, or
wherein each first response is received via unicast, groupcast, broadcast, or a combination thereof, or
wherein the second request is transmitted via unicast, groupcast, or broadcast, or
wherein each second response is received via unicast, groupcast, broadcast, or a combination thereof, or
any combination thereof.

3. The method of claim 1, wherein the first request comprises a session identifier associated with the SLPP session.

4. The method of claim 1, wherein the first request comprises a Layer-2 (L2) group identifier associated with the SLPP session.

5. The method of claim 1,
wherein the group of one or more UEs includes each recipient UE that indicates the acceptance of the SLPP session via a respective first response, or
wherein the group of one or more UEs omits one or more recipient UEs that indicate the rejection of the SLPP session via one or more respective first responses.

6. The method of claim 1, further comprising:
transmitting a third request to modify the SLPP session to the group of one or more UEs and to any new recipient UE to be added to the group of one or more UEs which indicates whether the respective recipient UE will be included or excluded in the modified SLPP session associated with a modified group of one or more UEs.

7. The method of claim 6,
wherein the modified group of one or more UEs includes each recipient UE that indicates the acceptance of the modified SLPP session via a respective third response, or
wherein the modified group of one or more UEs omits one or more recipient UEs that indicate the rejection of the modified SLPP session via one or more respective third responses.

8. The method of claim 1, wherein the second request comprises Layer-2 (L2) and application layer identifiers associated with the SLPP session, a UE identifier associated with the initiator UE, and a UE identifier associated with each UE in the group of one or more UEs.

9. The method of claim 1, further comprising:
obtaining a set of sidelink positioning reference signal (SL-PRS) measurements associated with the SLPP session; and
determining a position estimate for the initiator UE, one or more UEs in the group of one or more UEs, or a combination thereof, based on the set of SL-PRS measurements.

10. The method of claim 9, wherein one or more position estimates for the one or more UEs are determined and transmitted to the one or more UEs.

11. A method of operating a recipient user equipment (UE), comprising:
receiving a first request to create a sidelink positioning protocol (SLPP) session from an initiator UE; and
transmitting a first response to the initiator UE indicates an acceptance or rejection of the SLPP session by the recipient UE.

12. The method of claim 11, wherein the first response indicates the acceptance of the SLPP session by the recipient UE.

13. The method of claim 12, further comprising:
receiving a second request to start the SLPP session from the initiator UE; and
transmitting a second response that acknowledges the second request.

14. The method of claim 13,
wherein the second request is received via unicast, groupcast, or broadcast, or
wherein the second response is transmitted via unicast, groupcast, or broadcast, or any combination thereof.

15. The method of claim 13, wherein the second request comprises Layer-2 (L2) and application layer identifiers associated with the SLPP session, a UE identifier associated with the initiator UE, and a UE identifier associated with each UE in a group of one or more UEs associated with the SLPP session.

16. The method of claim 12, further comprising:
receiving a third request from the initiator UE to modify the SLPP session, the third request indicating whether the recipient UE will be included or excluded in the modified SLPP session.

17. The method of claim 16,
transmitting a third response to the initiator UE, the third response indicating an acceptance or rejection or acknowledgment of the modified SLPP session by the recipient UE.

18. The method of claim 12, further comprising:
transmitting sidelink positioning reference signal (SL-PRS) measurements associated with the SLPP session to the initiator UE.

19. The method of claim 12, further comprising:
receiving a position estimate of the recipient UE from the initiator UE.

20. The method of claim 11,
wherein the first request is received via unicast, groupcast, or broadcast, or
wherein the first response is transmitted via unicast, groupcast, or broadcast, or any combination thereof.

21. The method of claim 11, wherein the first request comprises a session identifier associated with the SLPP session.

22. The method of claim 21, wherein the first request comprises a set of group identifiers associated with the SLPP session.

23. A method of operating a user equipment (UE), comprising:
determining a first casting mode associated with a sidelink positioning protocol (SLPP) message associated with a SLPP session;
determining a second casting mode associated with one or more SLPP response messages to the SLPP message; and
transmitting the SLPP message to a set of one or more UEs in accordance with the first casting mode,
wherein the SLPP message comprises an indication of both the first casting mode and the second casting mode.

24. The method of claim 23,
wherein the first casting mode is unicast, groupcast, or broadcast, and
wherein the second casting mode is unicast, groupcast, or broadcast.

25. The method of claim 23,
wherein the first casting mode is unicast, and
wherein the set of one or more UEs comprises a single target UE.

26. The method of claim 23,
wherein the first casting mode is groupcast, and
wherein the set of one or more UEs comprises a group of one or more UEs.

27. The method of claim 23, wherein the first casting mode is broadcast.

28. A method of operating a user equipment (UE), comprising:
receiving a sidelink positioning protocol (SLPP) message associated with a SLPP session, wherein the SLPP message is received in accordance with a first casting mode and comprises an indication of both the first casting mode and a second casting mode associated with one or more SLPP response messages to the SLPP message; and
transmitting a SLPP response message in response to the SLPP message in accordance with the second casting mode.

29. The method of claim 28,
wherein the first casting mode is unicast, groupcast, or broadcast, and
wherein the second casting mode is unicast, groupcast, or broadcast.

30. The method of claim 28,
wherein the first casting mode is broadcast, and
wherein the SLPP message comprises a session identifier for the SLPP session, or
wherein the SLPP message comprises an indication of the second casting mode or the second casting mode is implicitly indicated from the first casting mode, and the second casting mode is broadcast.
